(19) United States
(12) Patent Application Publication
(10) Pub. No.: US 2013/0141903 A1
(43) Pub. Date: Jun. 6, 2013

(54) LED LIGHTING APPARATUS

(71) Applicant: MATRIX RAILWAY INC, Babylon, NY (US)

(72) Inventors: Nelson RIVAS, East Meadow, NY (US); Joseph ABDALE, North Babylon, NY (US)

(73) Assignee: MATRIX RAILWAY INC, Babylon, NY (US)

(21) Appl. No.: 13/673,425

(22) Filed: Nov. 9, 2012

Related U.S. Application Data
(63) Continuation of application No. PCT/US2011/036565, filed on May 14, 2011.
Application No. PCT/US2011/036565 is a continuation-in-part of application No. 12/839,382, filed on Jul. 19, 2010.
Application No. 12/839,382 is a continuation-in-part of application No. 11/462,921, filed on Aug. 7, 2006, now Pat. No. 7,759,876.
Application No. 11/462,921 is a continuation of application No. 10/668,905, filed on Sep. 23, 2003, now Pat. No. 7,114,834.
(60) Provisional application No. 61/345,066, filed on May 14, 2010.
(60) Provisional application No. 61/351,834, filed on Jun. 4, 2010.

(51) Int. Cl. F21V 13/04; F21V 29/00; F21V 7/00

(52) U.S. Cl. CPC F21V 13/04; F21V 7/00; F21V 29/20
USPC 362/218; 362/235; 362/223

(57) ABSTRACT

A light system comprising an elongated housing; at least one LED light disposed inside of the housing. There can also be at least one lens disposed adjacent to the LED light, In addition, there can also be at least one reflector disposed in the housing, wherein the reflector has a first reflector section disposed adjacent to the LED light and a second reflector section coupled to the first section, and disposed at a distal end opposite the LED light. The first reflector section being substantially round in shape and said second reflector section being substantially round in shape.

### CROSS REFERENCE TO RELATED APPLICATIONS

This application is a continuation application of PCT/US2011/036565 filed on May 14, 2011. That international application claims priority from provisional application Ser. No. 61/345,066 filed on May 14, 2010, and provisional application 61/351,834 filed on Jun. 4, 2010 and this application is a continuation in part application of U.S. application Ser. No. 12/839,382 filed on Jul. 19, 2011, wherein the '382 application claims priority under 35 U.S.C. 119e from provisional application Ser. No. 61/345,066 filed on May 14, 2010, and provisional application Ser. No. 61/351,834 filed on Jun. 4, 2010, in addition U.S. patent application Ser. No. 12/839,382 is a continuation in part of U.S. patent application Ser. No. 11/462,921 filed on Aug. 7, 2006, and which is now U.S. Pat. No. 7,759,876 and which is a continuation of U.S. Pat. No. 10/668,905 filed on Sep. 23, 2003 now U.S. Pat. No. 7,114,834, which is a non provisional application which claims priority under 35 U.S.C. 119e from U.S. provisional application Ser. No. 60/412,692 filed on Sep. 23, 2002, the disclosures of all of these applications being hereby incorporated by reference in their entirety.

### BACKGROUND OF THE INVENTION

The invention relates to an LED light that is disposed within a housing having a reflector disposed therein. Multiple different embodiments all disclose LED lights in combination with reflectors.

### SUMMARY OF THE INVENTION

The invention relates to a lighting device comprising a housing, a plurality of LED lights coupled in an array inside of the housing, and a reflective protrusion or simply a reflector coupled inside the cylindrical prismatic housing wherein the reflective protrusion is for reflecting light from the LED lights out of the cylindrical prismatic housing.

One of the benefits of at least one embodiment of the invention is to provide the appearance of an even, omni-directional light source extending in a 360 degree manner to create uniform light distribution about a room. Lighting with Fluorescent light bulbs provides a substantially even glow in an omnidirectional manner so that there are no unlit areas (or dead spots) around the outside cylindrical area were light bulb emits light. The fluorescent light radially emits light at 360 degrees about its cylindrical radius. Therefore, at least one design is designed to approach a uniform, omnidirectional lighting source, wherein by using LED lights, this is accomplished in a more efficient manner than with ordinary incandescent bulbs.

The housing can comprise a first end; a second end; and a cover coupling the first end to said second end. The cover is translucent. In one embodiment, a first LED array is coupled to a first end of the housing and a second LED array is coupled to a second end of the housing.

The housing can be formed in many shapes. For example, the housing can be substantially tubular shaped or formed with a circular cross section such as bowl shaped or formed with a substantially oval cross section. In addition, the protrusion can be formed in many different shapes as well. For example, the protrusion can be dome shaped, pyramidal shaped or spherical. There can also be a stand-alone reflector in the form of a sphere or semi-spherical design. Furthermore, the protrusion can be formed with rounded or angled sides.

To further increase the reflectiveness and the scattering of light the translucent cover comprises a plurality of prismatic lenses which can be in a sheet that assist in scattering the light as it is emitted by the LED lights. To prevent the housing or the circuitry relating to the LED lights from overheating, the LED light array is coupled to a heat sink In many cases, this heat sink is disposed in an end region of the housing. The circuitry relating to this LED light array can include a power source such as a connection to an AC or DC input. If the connection is to an AC input, the device can also include an AC/DC converter coupled to the power source for receiving an input from the AC power source. In this way, the LED array receives a consistent flow of DC current that will not result in the degradation or burning out of LED lights. In addition, each of the LED lights in each of the LED arrays is coupled to an adjacent LED light in both series and in parallel, so that if one LED light burns out, the adjacent LED lights do not burn out. To prevent this LED array from burning out, there is also a current regulator for controlling a current running through this LED array. The current regulator can, for example regulate that only the current required by the LED passes through the array. This current regulator allows the device to connect to many different power sources with different input voltages. The circuitry relating to the LED light array uses a constant current design which is highly efficient and results in very minor heat losses.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention. In the drawings, wherein similar reference characters denote similar elements throughout the several views:

FIG. 1A is a side cross-sectional view of a first embodiment

FIG. 1B is a side cross sectional view of the view in FIG. 1A taken along line I-I;

FIG. 1C is a side view of the device which includes a prismatic film disposed on tube;

FIG. ID is a perspective view of the device shown in FIG. 1C; FIG. IE is a side view of the device shown in FIG. 1D;

FIG. 2A is a perspective view of a second embodiment of the invention; FIG. 2B is a perspective view of the view of FIG. 2A with a cover removed;

FIG. 2C is a side view through the housing with the cover shown in dashed lines;

FIG. 3A is a side view of the third embodiment of the invention;

FIG. 3B is a detailed view of an end section shown in FIG. 3A;

FIG. 3C is a perspective view of an end section as shown in FIG. 3 A;

FIG. 3D is a bottom-side perspective view of the embodiment shown in FIG. 3A;

FIG. 4A is a side view of the embodiment shown in FIG. 2A;

FIG. 4B is a side view of another embodiment of the invention;

FIG. 5A is an end view of an end piece shown in FIG. 1A;

FIG. 5B is a side view of the end piece shown in FIG. 5A;

FIG. 5C is a perspective view of the end piece shown in FIG. 5A;

FIG. 6A is a side view of another embodiment of the invention;

FIG. 6B is a perspective view of the embodiment shown in FIG. 6A with the cover removed;

FIG. 6C is a side view of the embodiment shown in FIG. 6B;

FIG. 6D is a perspective view of the embodiment shown in FIG. 6A with the cover on;

FIG. 7A is a perspective view of another embodiment of the invention with a cover removed; FIG. 7B is a top view of the embodiment shown in FIG. 7A; FIG. 7C is a side transparent view of the device shown in FIG. 7A;

FIG. 8A is a perspective view of another embodiment of the invention; FIG. 8B is a top view of the embodiment shown in FIG. 8A;

FIG. 8C is a side transparent view of the embodiment shown in FIG. 8A;

FIG. 9A is a perspective view of another embodiment of the invention;

FIG. 9B is a top view of the view shown in FIG. 9A;

FIG. 9C is a side cross-sectional view of the embodiment shown in FIG. 9A taken through section A-A;

FIG. 9D is a side cross-sectional view of another embodiment of the invention; FIG. 9E is a perspective view of the device shown in FIG. 9D;

FIG. 10A is a perspective view of another embodiment of the device; FIG. 10B is a side view of the device shown in FIG. 10A;

FIG. 11 A is a perspective view of a new reflector;

FIG. 11B is a perspective view of the reflector of FIG. 11 A inserted into a tube;

FIG. 11C is an end view of the device in FIG. 11B;

FIG. 11D is a side view of the device shown in FIG. 11C;

FIG. 12A is an end view of one of the endcaps;

FIG. 12B is a perspective view of the endcaps shown in FIG. 12A;

FIG. 12C is a cross-sectional view through line XII-XII of the endcaps shown in FIG. 12A;

FIG. 12D is a cross sectional view of the device with the endcaps removed showing the collimating effect of the lens;

FIG. 13 A is a top view of the device inserted into a lighting housing for mounting in a ceiling;

FIG. 13B is a perspective view of the device shown in FIG. 13 A;

FIG. 14A is a side view of the device shown in 14A with a section of the cover removed;

FIG. 14B is a close-up view of one of the prisms in a prism sheet;

FIG. 15 is a side view with a center section of the tube removed for viewing a reflector;

FIG. 16 is a schematic diagram of a circuit for use with the device;

FIG. 17 A is a perspective view of the device showing a uniform light distribution pattern;

FIG. 17B is a side view of the device showing a uniform light distribution pattern;

FIG. 17C is a side view of the device rotated 90.degree. showing a uniform light distribution pattern;

FIG. 18 A is a perspective view of another embodiment;

FIG. 18B is a side transparent view of the embodiment shown in FIG. 18A;

FIG. 18C is a side view of the reflector material;

FIG. 19 is a side cross-sectional view of a first embodiment of a light system;

FIG. 20A is a top perspective view of a reflector for use in a light system;

FIG. 20B is a top view of the reflector shown in FIG. 20A;

FIG. 20C is a cross-sectional view of the reflector shown in FIGS. 20A and 20B; taken along the line A-A in FIG. 20D;

FIG. 20D is an end view of the reflector;

FIG. 21 A is a top view of a second light system;

FIG. 21B is a center view of a dual reflector taken within Detail D of FIG. 21A;

FIG. 21C is a side end view of the light shown in FIG. 21 A;

FIG. 21 D is a close up view of Detail E of FIG. 21 C;

FIG. 22A is a top view of a light with a heat sink for use with the light system of FIG. 20A;

FIG. 22B is a perspective view of the light/heat sink as shown in FIG. 22A;

FIG. 22C is an exploded perspective view of the light/heat sink shown in FIG. 22A and FIG. 22B;

FIG. 22D is an end view of the light/heat sink;

FIG. 22E is a side cross-sectional view of the light taken along the line A-A in FIG. 22D;

FIG. 23 is a top perspective exploded view of another embodiment of a light system; FIG. 24A is a side view of a light/heat sink shown in FIG. 25A;

FIG. 24B is a side view of a light/heat sink shown in FIG. 25A;

FIG. 24C is a side view of a connection between a light and a reflector shown in FIG. 25A;

FIG. 24D is a side view of a reflector shown in FIG. 25B taken along the line H-H;

FIG. 24E is an end view of a heat sink/circuit board taken along section J-J of FIG. 25C;

FIG. 24F is an end view of the heat sink and reflector taken along the line I-I of FIG. 25B;

FIG. 24G is a side view of the light system taken along the line L-L;

FIG. 25A is a side cross-sectional view of a light system taken along the line B-B;

FIG. 25B shows a top view of this light system;

FIG. 25C shows another side view;

FIG. 25D shows a top cross-sectional view through line K-K;

FIG. 26A is a top transparent view of another lighting system;

FIG. 26B is a view of the lighting system of FIG. 26A taken across section B-B;

FIG. 26C is a cross-sectional view taken along another section;

FIG. 26D is a side transparent view of the device shown in FIG. 26A;

FIG. 26E is a side cross-sectional view taken along section line A-A shown in FIG. 26A;

FIG. 27A is a top view of a lens and heat sink combination shown in FIG. 26A;

FIG. 27B is an end view of this light/heat sink combination; FIG. 27C is a perspective view of this light/heat sink combination;

FIG. 27D is a view of the lens taken along section line B-B shown in FIG. 27B;

FIG. 27E is a side cross-sectional view taken along section line A-a shown in FIG. 27A;

FIG. 28 A is a top view of another type of light/heat sink combination shown in FIG. 26A;

FIG. 28B is a side cross-sectional view of the light/heat sink combination shown in FIG. 28A taken along section line A-A;

FIG. 28C is a perspective view of the light/heat sink combination shown in FIG. 28A;

FIG. 28D is an end view of the light/heat sink combination with the light removed; FIG. 28E is a cross-sectional view of the heat pipe;

FIG. 29A is a top view of a reflector which is configured to be used with the design of FIG. 26A;

FIG. 29B is a cross-sectional view of the reflector taken along section line A-A shown in FIG. 29C;

FIG. 29C is an end view of the reflector of FIG. 29A; FIG. 29D is a perspective view of the reflector of FIG. 29A;

FIG. 29E is another embodiment of a reflector having a differently shaped second reflector section than the reflector shown in FIG. 29A; FIG. 30 A is a back perspective view of a lens;

FIG. 30B is a front perspective view of the lens of FIG. 30A and also of FIG. 26A;

FIG. 30C is a side cross-sectional view of the lens taken along section line A-A of FIG. 30D;

FIG. 30D is an end view of the lens of FIG. 30A;

FIG. 31A is a bottom view of the lens/heat sink combination using reflector and heat sink and light;

FIG. 31B is an end cross-sectional view taken along line C-C shown in FIG. 31A;

FIG. 31C is a view of this lens/light/heat sink/and reflector combination shown in FIGS. 31A and 31E taken at detail E of FIG. 31E;

FIG. 31D is a view of the light/heat sink combination taken at detail B of FIG. 31E;

FIG. 31E is a perspective view of the light/reflector/lens/heat sink combination of FIG. 31 A with some of the reflectors removed;

FIG. 32A is a side cross-sectional view of a light system;

FIG. 32B is a side cross-sectional view taken of Detail B shown in FIG. 32A;

FIG. 32C is a perspective exploded view of the light system of FIG. 32A;

FIG. 32D is a view of the light/heat sink/reflector combination shown in FIG. 32C;

FIG. 33A is a perspective view of a reflector system for use with a light system;

FIG. 33B is a top view of the reflector shown in FIG. 33A;

FIG. 33C is a side view of the reflector shown in FIG. 33A;

FIG. 33D is an end view of the reflector shown in FIG. 33A;

FIG. 34A is a top perspective view of a light system with a translucent cover removed;

FIG. 34B is a perspective view of the light system with the cover on;

FIG. 34C is an end view of the light shown in FIG. 34B;

FIG. 34D is a side view of the light shown in FIG. 34D;

FIG. 35 is a top perspective view of another embodiment of the light system;

FIG. 36A is a top view of another embodiment;

FIG. 36B is a view taken along the line A-A; FIG. 37A is a top transparent view of another embodiment of a light system;

FIG. 37B is a side transparent view of another embodiment;

FIG. 37C is a side cross-sectional view taken along the line A-A;

FIG. 37D is a perspective view of this design;

FIG. 38A is a top transparent view of another embodiment;

FIG. 38B is a side transparent view of the design of FIG. 38A;

FIG. 38C is a top perspective view of the design shown in FIG. 38A;

FIG. 38D is a bottom perspective view of the design shown in FIG. 38A;

FIG. 39A is a top view of another embodiment;

FIG. 39B is a top perspective view of the design shown in FIG. 38A;

FIG. 39C is a side transparent view of the device shown in FIG. 39A;

FIG. 39D is a side cross-sectional view taken along line A-A of FIG. 39C;

FIG. 39E is a detail B close up view shown in FIG. 39D;

FIG. 40A is a top view of another design;

FIG. 40B is a top perspective view of this design shown in FIG. 40 A;

FIG. 40C is a side transparent view of the design shown in FIG. 40 A;

FIG. 40D shows a side cross-sectional view taken along line A-A of FIG. 40C;

FIG. 40E is a detail B section taken from FIG. 40D;

FIG. 41A is a side transparent view of the light design shown in FIG. 40A;

FIG. 41B is a side cross-sectional view taken along line A-A of FIG. 41 A;

FIG. 42A is a top view of the heat sink/light combination shown in FIG. 41A;

FIG. 42B is a detail B taken from FIG. 42A;

FIG. 42C is a side perspective view of the heat sink/light combination of FIG. 42A;

FIG. 42D is a view of this light/heat sink combination being combined with a reflector;

FIG. 42E is a perspective view of a light/heat sink combination shown in FIG. 42C;

FIG. 43A is a side view of another embodiment;

FIG. 43B is an end view of the embodiment shown in FIG. 43A;

FIG. 43C is a perspective view of the embodiment shown in FIG. 43A;

FIG. 44A is a front transparent view of another design;

FIG. 44B is a side transparent view of the design of FIG. 44A;

FIG. 44C is a perspective view of the design shown in FIG. 44A;

FIG. 45A is a front view of another design;

FIG. 45B is a perspective view of the design shown in FIG. 45A;

FIG. 46 A is a top perspective transparent view of another design;

FIG. 46B is a top perspective view of the design of FIG. 46A;

FIG. 47A is a perspective view of another design; FIG. 47B is a side transparent view of the view of FIG. 47A;

FIG. 47C is a side transparent view of the design of FIG. 47A taken from another view as shown in FIG. 47B;

FIG. 47D is a side cross-sectional view taken along line B-B of FIG. 47B;

FIG. 47E is a side cross-sectional view taken along line A-A of FIR. 47C;

FIG. 48A is a side cross-sectional view of another design taken along line B-B of FIG. 48D;

FIG. 48B is an exploded view of components of this design; FIG. 48C is a perspective view of this design with a section of the heat sink being exposed;

FIG. 48D is a side view of the design; FIG. 48E is a side close up view of section C shown in FIG. 48A;

FIG. 49A is a side transparent view of another embodiment;

FIG. 49B is a side perspective view of the embodiment shown in FIG. 49A;

FIG. 49C is a side transparent view of the design shown in FIG. 49 A;

FIG. 49D is a side cross-sectional view taken along line B-B shown in FIG. 49A;

FIG. 49E is a side-cross-sectional view of the device taken along section line A-A of FIG. 49C;

FIG. 50 A is a perspective view of a first pattern of light beams;

FIG. 50b is a second view of this pattern of light beams taken along line A-A in FIG. 50C

FIG. 50C is an end view of this design which can be in the form of the design of FIGS. 29A, 26D and 19;

FIG. 51 A is a perspective view of another view of another set of light beams;

FIG. 51B is a cross sectional view taken along line A-A of FIG. 51C;

FIG. 51C is an end view;

FIG. 52A is another view of another light pattern;

FIG. 52B is a close up view of the light pattern;

FIG. 52C is an end view;

FIG. 53A is a perspective view of the light pattern;

FIG. 53B is a side view of this light pattern of FIG. 53A;

FIG. 53C is an end view;

FIG. 54A is a front perspective exploded view of another embodiment of the invention;

FIG. 54B is a sectional view of the embodiment shown in FIG. 54A;

FIG. 55A is a front perspective exploded view of another embodiment which is similar to the embodiment of FIG. 54A;

FIG. 55B is a sectional view of the embodiment shown in FIG. 55A;

FIG. 56A is a perspective, exploded view of another embodiment;

FIG. 56B is a side cross-sectional view of another embodiment;

FIG. 56C is a perspective sectional view of a portion of the device shown in FIG. 56A;

FIG. 56D is a back perspective view of the assembled device FIG. 57 A is a front view of a lens used in any one of the above embodiments;

FIG. 57B is a side cross-sectional view of the lens of FIG. 57A taken along section A-A;

FIG. 57C is an exploded perspective view of the lens with an associated circuit board;

FIG. 57D is a back view of the lens;

FIG. 57E is a side cross-sectional, sectional view of the lens, LED interface taken in section B;

FIG. 57F is a side cross-sectional view of the device taken along section C-C FIG. 58A is a back perspective view of the housing shown in FIG. 56A;

FIG. 58B is a front perspective view of the housing shown in FIG. 58A;

FIG. 58C is a sectional view of the housing shown in section B of FIG. 58B; FIG. 58D is a sectional view of the housing taken at section B in FIG. 58 A;

FIG. 59A is a perspective view of a heat sink;

FIG. 59B is a side view of the heat sink;

FIG. 59C is a top view of the heat sink; and

FIG. 59D is a back view of the heat sink

### DETAILED DESCRIPTION

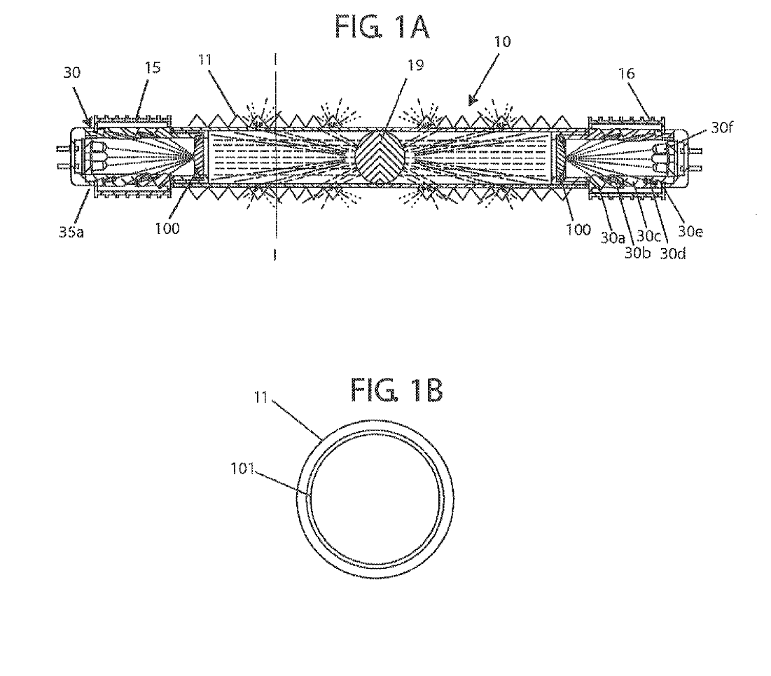

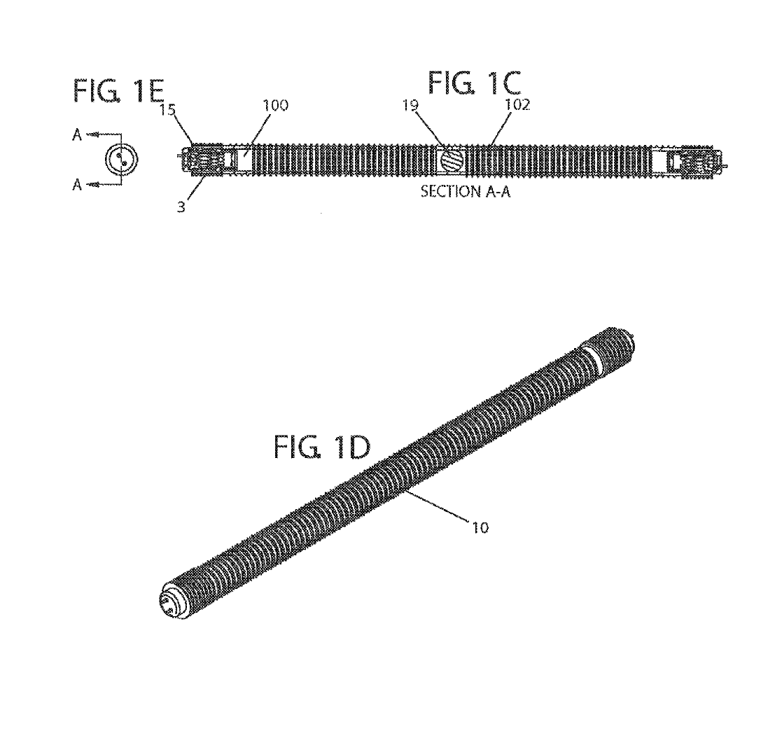

Turning now in detail to the drawings, FIG. 1A is a side cross-sectional view of a first embodiment of the invention. This view shows from an outside perspective, a design similar to that of a phosphorescent or florescent tubular bulb. With this device 10 there is a housing formed from a translucent-prismatic lens 11 and end caps 15 and 16 attached at each end. Inside of cover or tube 11, is a reflective sphere 19, which is used to reflect light from LED lights 30 which are embedded into a lighting housing 35 in end caps 15 and 16. LED lights 30 are arrayed in lighting housing 35 so that they shine a light onto a common point on collimator lens 100. For example, there are a plurality of different LED arrays disposed at precise angles with a first array in the form of array 30a comprising a plurality of lights arranged around a rim of lighting housing 35. This first set of LED lights in array 30a are set at a first angle to shine on a central region of lens 100. A second set of LED lights in array 30b are arrayed around the rim of lighting housing 35 and are set at a different angle than that of first array 30a. LED lights in arrays 30a, 30b and 30c are all set in lighting housing 35 at different angles than the respective remaining arrays. In this way, the LED lights from these different arrays all shine on a central region of lens 100 wherein this light is then collimated by collimating lens 100. LED array 30f is in the form of a backplate which houses a series of lights disposed at a precise angle around this back plate. These LEDs are directed radially inward to a central region on lens 100. In this way, there is little light lost due to reflection because all of the lights are directed towards a central region of collimating lens 100. The reflective sphere 19 has a round or substantially round shape. This reflector 19 has a shape taken from the group comprising or consisting of: rounded, spherical, semi-spherical, dome shaped, or a shape having at least one portion that is, or is at least substantially rounded, dome shaped or spherical shaped.

To achieve this result of little light loss, LED lights 30 are positioned at different angles in an aluminum housing that also serves as heat sink to create a common point for convergence of the light. The heat collected by the aluminum housing is absorbed by a non-conducting insulating pad 30h and transferred to a secondary heat sink 30i which dissipates heat to the surroundings. Lens 100 is a collimating lens, which is disposed in tube 11 and is used to focus the light so that it creates a common light pattern with virtually no loss of light. For example, if two or more beams are shined on a common object, the two or more beams could flow in the same path out of phase so that the result would be an amplification of total light for each beam added without much loss. However, if two or more beams are shined on an object and flowing along the same path and in phase, then there is no additional gain of light from this feature.

Thus, lens 100 is disposed inside of cover 11 so to act as a collimator so that it can be used to collimate the light emanating from LED lights 30 so that the different rays of light do not flow along a substantially same path. LED lights 30 can be of any color but would preferably be used to give the appearance of white light.

FIG. 1B is a cross-sectional view of the tube 11 taken along line I-I. In this view there is shown a copy of the tube 11 with a prismatic film 101 inserted therein. Prismatic Film 101 is in the form of a semi-transparent, translucent film which is designed to reflect, and refract the light to provide the effect of a uniformly distributed light pattern. Prismatic film 101 can be in the form of a prismatic film that refracts light to create a consistent flow of light out of film 101.

FIG. 1C is a side view of the device 10 which includes a prismatic film or texture 102 disposed on an outside of tube 11. With this design there is spherical reflector 19 coupled therein wherein a central region of this prismatic film 102 is shown removed for the purpose of showing spherical reflector 19. Endcaps 15 and 16 are coupled to tube 11 wherein these endcaps show lens 100 and a plurality of LED arrays extending around in rings. Each LED array includes LED lights 30 which are angled at lens 100 at the same angle with the angles of the LED lights differing between the different LED arrays. For example, in the first LED array 30A, the LED lights are pointed at lens 100 at a 39.degree. angle. In the second LED array 30B, the LED lights are pointed at lens 100 at a 24.degree, angle. In the third LED array 30C the LED lights are pointed at lens 100 at a 15.degree, angle.

These lights then shine in a radial inward pattern pointed at a center region on lens 100. FIG. ID shows a full perspective view of this embodiment, while FIG. IE shows as side view of the embodiment in FIG. ID.

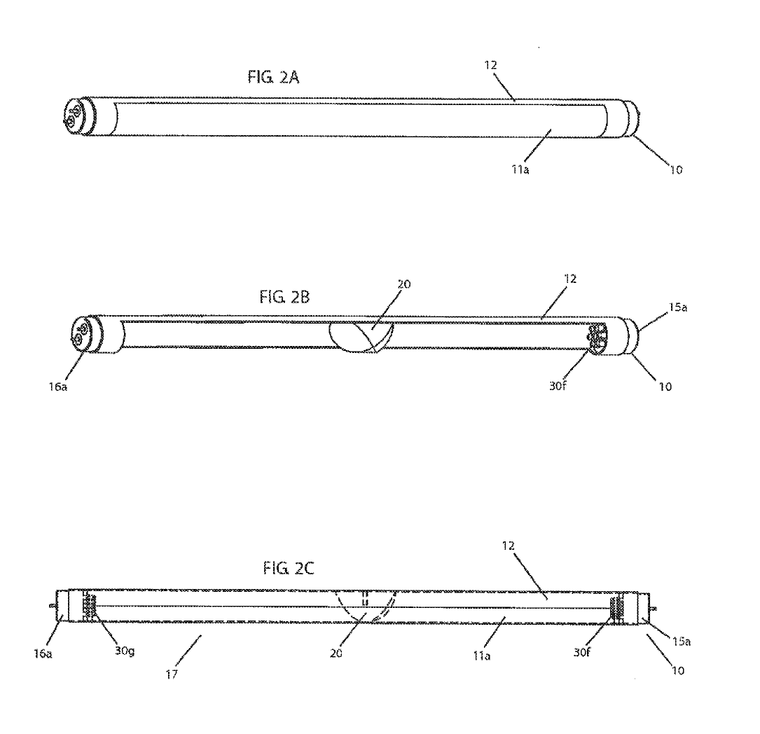

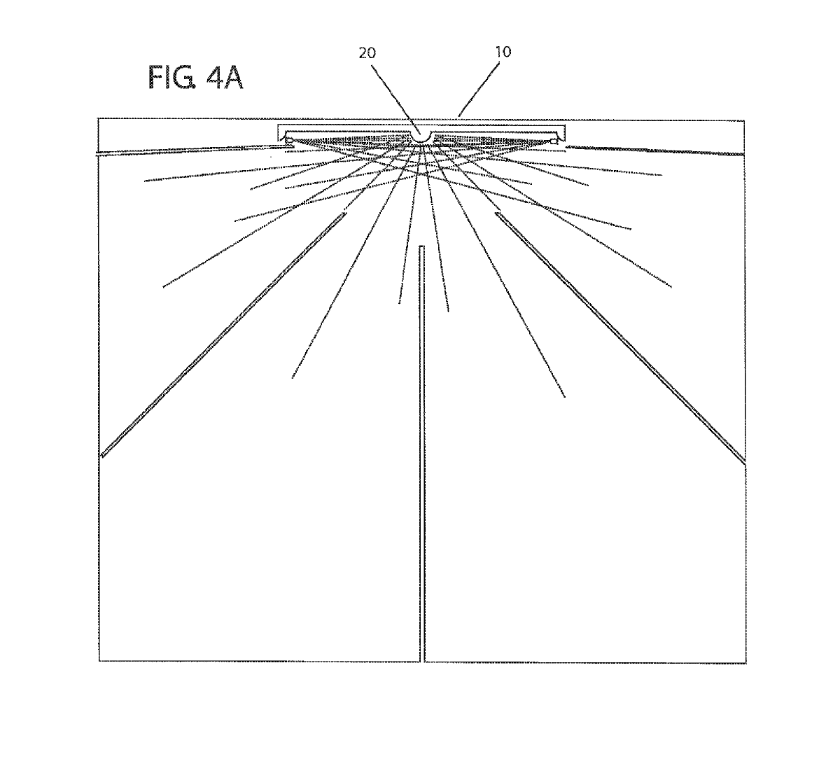

FIG. 2A is a light whose source of light originates from the left end and the right end. This light is then shone onto the center reflector. The light distribution pattern generated is illustrated in FIG. 4a.

FIG. 2A is a side perspective view of the embodiment of this design wherein this view shows cover 11a which is coupled to a housing base section 12. Cover 11a can be tubular or semi-tubular and can attach to base section 12. FIG. 2B is a perspective view of the view of FIG. 2A with cover 11a removed. In this view, there are two ends 15a and 16a coupled together via base section 12. Base section 12 is formed with a semi-circular cross-section with a reflective inner face to reflect light out of the housing through prismatic translucent cover 11a.

A reflective protrusion 20 which has a mirror surface 20 is coupled to base section 12 and is in the form of a substantially dome shaped element. There is also a first LED array 30g coupled to first endcap 15a so that first LED array 30g shines light from LED lights into the housing so that it is reflected from the inner face of base section 12 and protrusion 20.

In addition, FIG. 2C is a side view through the housing with the cover shown in dashed lines, in this view, a second LED array 30f is shown coupled to second end 16a so that light from this LED array can be shined or shone through the housing and out of the housing so that it can illuminate a room.

Essentially in this design, light emanates from LED arrays 30f and 30g and reflects off of reflective dome 20. This reflected light then emanates out of the prismatic cover 11a. In addition, light which emanates from LED arrays 30f and 30g also passes through cover 11a to light a room without reflecting off of reflector 20. This reflector has a shape taken from the group comprising or consisting of: rounded, spherical, semi-spherical, dome shaped, or a shape having at least one portion that is, or is at least substantially rounded, dome shaped or spherical shaped.

For example, this light could either pass directly from the associated LED array through cover 11 or it could reflect off of reflective support or base section 12 which has a highly reflective interior surface.

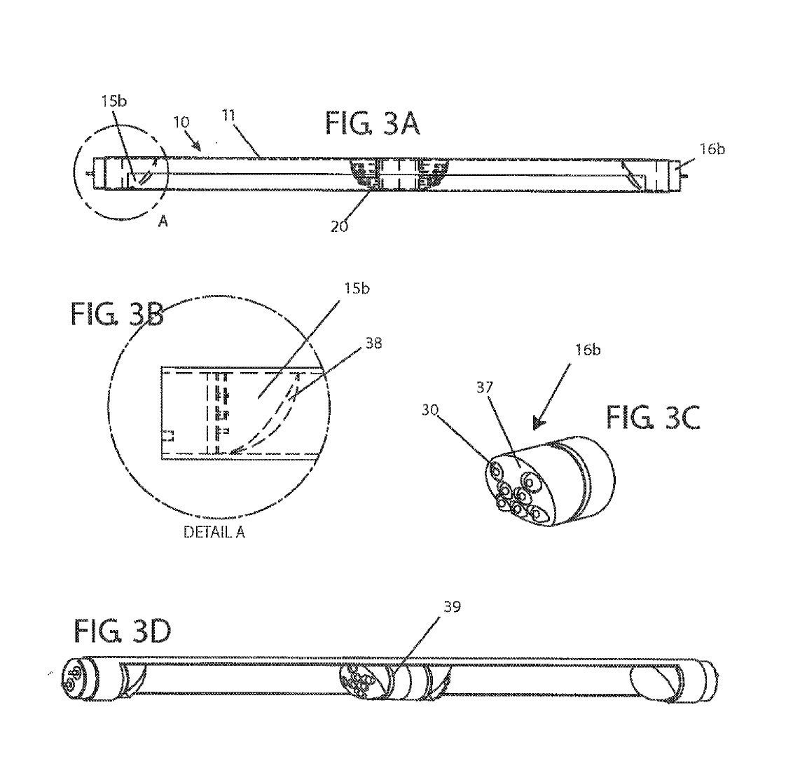

FIG. 3A is a light whose source of light originates at the center light. This light is then shone onto the right and left reflectors. The light distribution pattern generated is illustrated on FIG. 4b.

In this case, there are different style end pieces 15b, and 16b which can be of different shapes for example having a sloped front surface 37 and 38 (See FIGS. 3B and 3C) which form a reflector for reflecting light that is sent. As shown in FIG. 3D, there are also unique intermediate lighting housings 39 having a sloped front section and a plurality of LED lights coupled therein.

FIGS. 4 A and 4B show two different types of designs for two different types of reflective protrusions. For example, FIG. 4a shows device 10 having a reflective protrusion 20. Reflective protrusion 20 is formed as semi-spherical as shown in FIGS. 2B 2C. FIG. 4B shows a device 13 having a reflective protrusion 21 which is oblong in shape wherein this reflector 21 has a substantially mirrored surface and is used to reflect light from this surface.

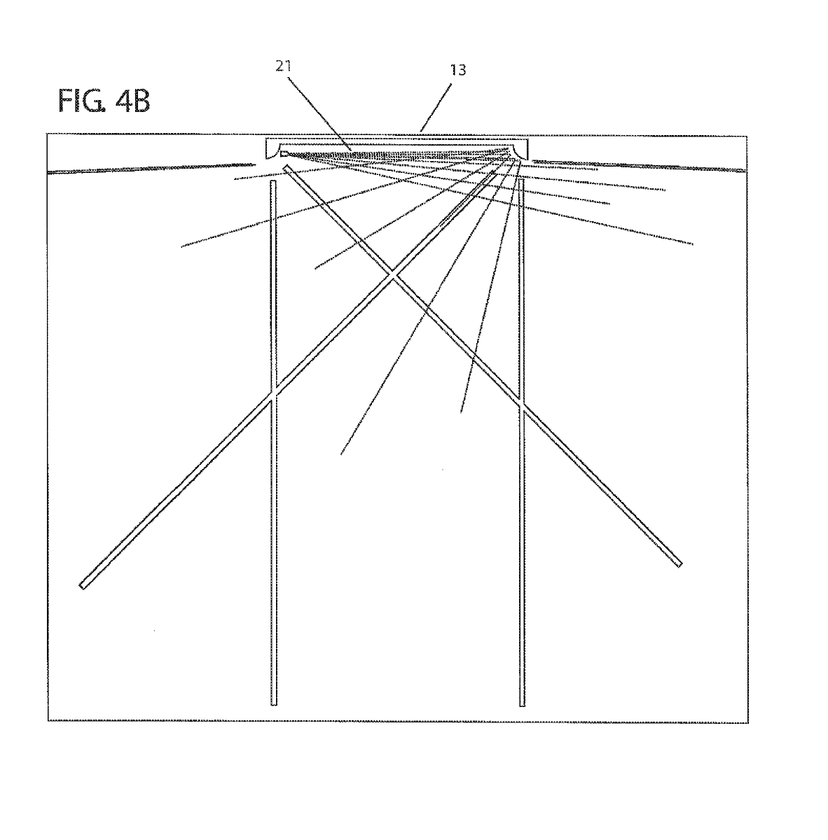

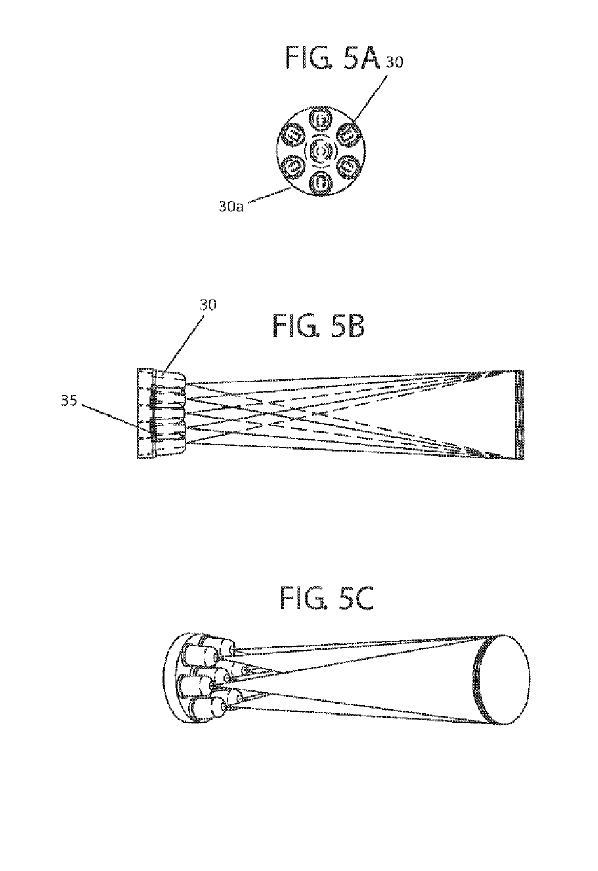

FIGS. 5A, 5B and 5C disclose at different viewing angles an LED array 30f and 30g, which includes LED lights 30 coupled therein. This LED array 30f and 30g includes a spacer which aligns an LED cluster into a single point or region and brings all the light coming from each LED into a central region so that maximum light output is realized at the focal point where all the light comes together.

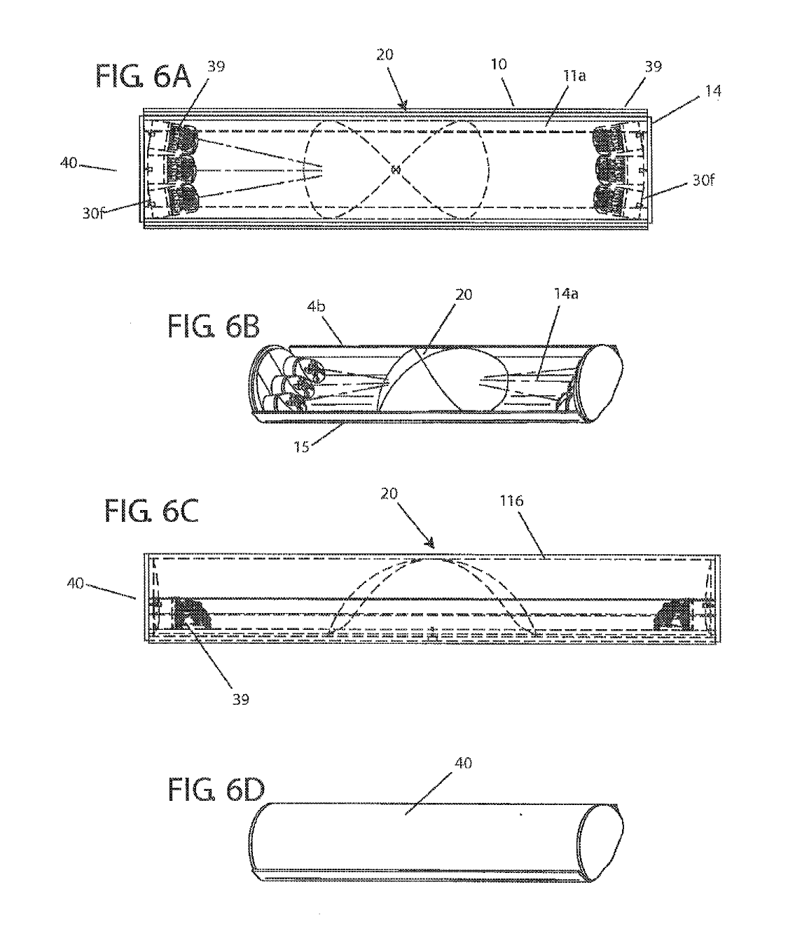

FIGS. 6 A, 6B, 6C and 6D involve another embodiment of the design 40, wherein in this design, there is a new type base section 14 which includes a central reflecting protrusion 20, but base section 14 is not tubular in shape as in base section 12 in FIG. 2 A. Instead, this base section 14 has a semi-oval cross-section wherein there is a flattened, or slightly rounded base plate 14a and rounded sides 14b which can be used to receive a correspondingly shaped cover 1 ib. Protrusion 20 is coupled to base plate 14a and also two sides 14b to provide a continuous reflective surface for reflecting light emanating from the coupled in LED arrays 39 which are patterned after endcaps 15a and 15b shown in FIGS. 3A, 3B and 3C. This set of LED arrays create a different version of the overall uniform light distribution pattern.

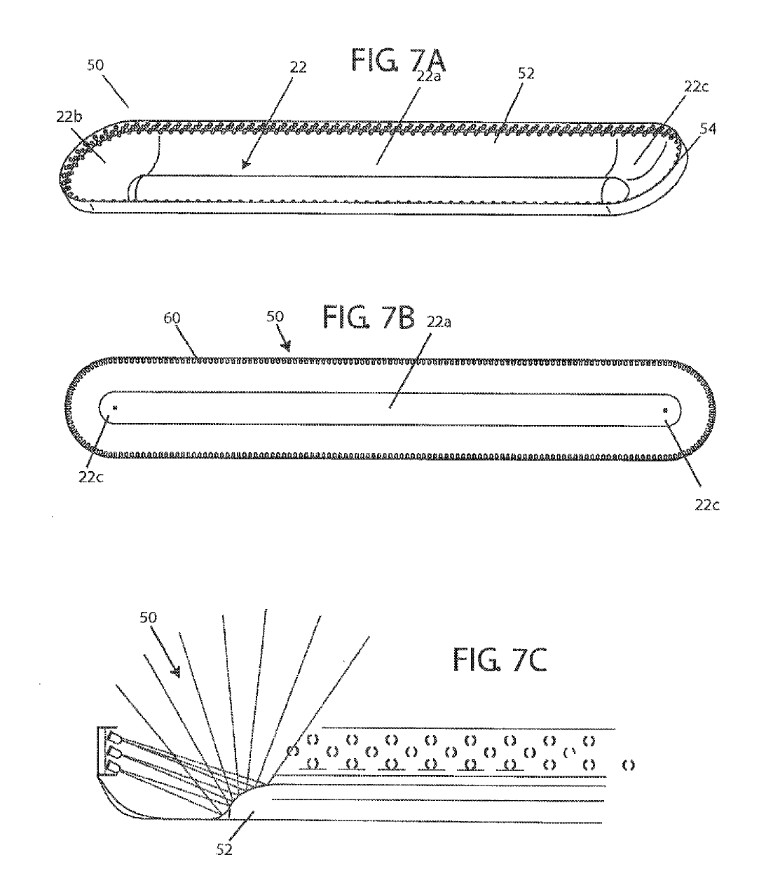

FIGS. 7A, 7B and 7C disclose another design, which involves a base section 50 having a reflective base plate 52, and a set of side walls 54. Base section 52 is concave in shape and forms a bowl or recess as shown in FIG. 7C. Reflective protrusion 22 extends out from base section 52 and is shaped in an oblong manner so that it has an oblong semi-cylindrical body 22a and rounded end caps 22b and 22c. LED lights 30 are coupled into side walls 54 and form a new LED array 60 wherein these LED lights point to reflective protrusion 22 so that once light shines on this protrusion 22, it is reflected out from base section 50. In this case, an interior region of base section 50 including side walls 54, base plate 52 and protrusion 22 are all made from a reflective surface such as a mirror reflector, however reflective protrusion 22 may be made from a different reflective material than the remaining interior reflective material on base section 50. Reflective protrusion has a shape taken from the group comprising or consisting of: rounded, spherical, semi-spherical, dome shaped, or a shape having at least one portion that is, or is at least substantially rounded, dome shaped or spherical shaped.

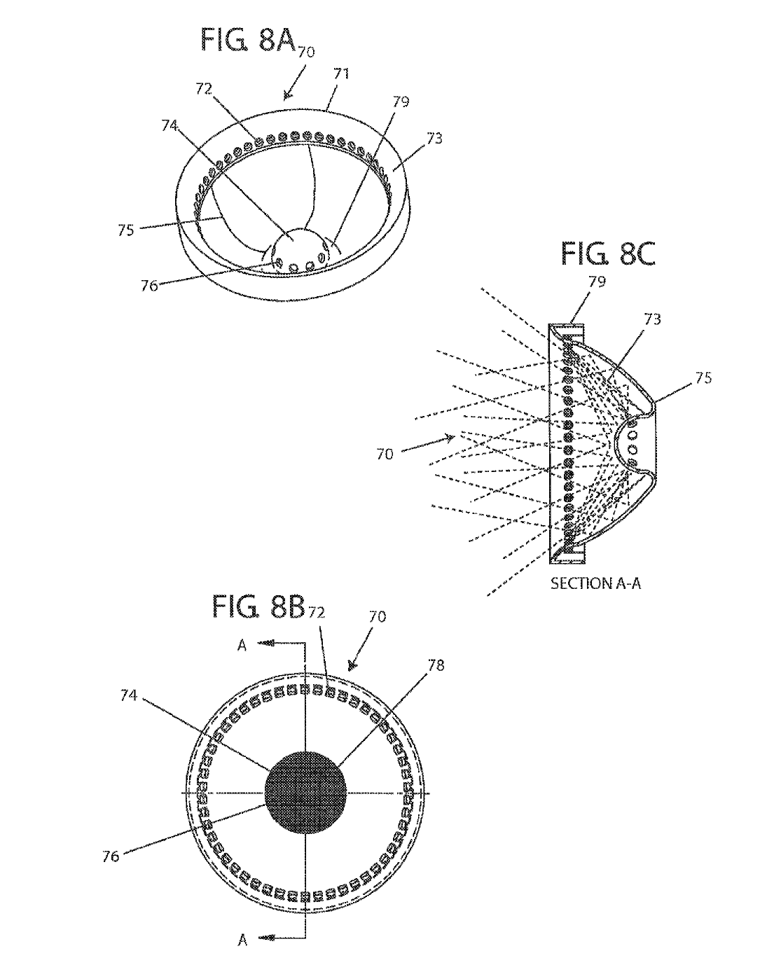

FIGS. 8A, 8B and 8C disclose another embodiment of the invention 70 wherein this embodiment includes a base section 71 which is shaped as a bowl having a rounded top. Inside base section 71 are side walls 73 with a plurality of holes 72 for receiving LED lights. These side walls dip down to form a deep bowl shaped product. In addition, there is a reflective protrusion 74 shaped as a dome which is coupled to a bottom end 75. Reflective dome shaped protrusion has a series of holes 76 which allow LED lights to fit through. Thus, these LED lights can fit through both holes 72 in side walls 73, and holes 76 in dome 74. Reflective dome 74 also includes a pre-dome section 78 which provides a transition area between bottom section 75 and dome section 74.

FIG. 8B shows a top view of this same embodiment showing that holes 72 and holes 76 are spaced opposite each other so that they can be used to light the surrounding reflective surface of base section 71. Base section 71 is reflective and can be made from a mirror finish material. In one embodiment however, reflective dome 74 can be made from a mirror finish material while the remaining reflective material can be made from a different material. FIG. 8C also discloses a side cross sectional view of this embodiment which shows that base section 71 also contains an outer wall 79 forming an outer peripheral rim cover for any LED lights that are coupled in. Base section forms a first reflective section while reflective dome 74 forms a second reflective section.

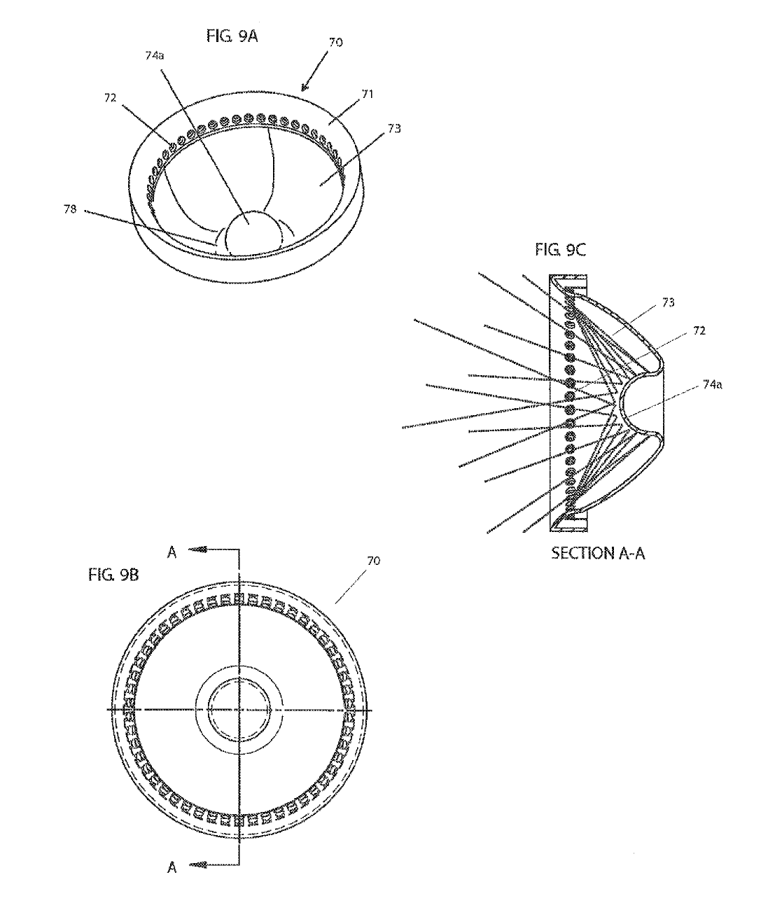

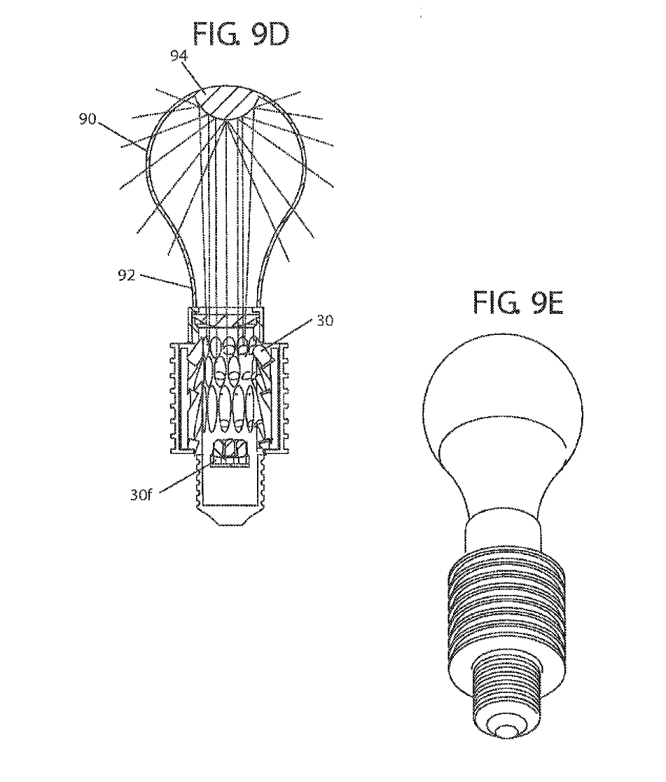

FIGS. 9A, 9B and 9C show a similar design as described above, however this design does not include holes 76 so that a new dome 74a is formed wherein this dome 74a is formed as an entirely reflective dome. FIG. 9D shows a cross-sectional view of another embodiment of the device 90. In this view there is a base cap 91 which includes LED array 30f which sends light into a substantially translucent light housing 92 shaped substantially like a light bulb. This light housing has a reflective protrusion 94 which is shaped as a dome made from material having a reflective material finish which then reflects light out into a room to create the effect of a substantially uniform light source in all directions. In addition a prismatic film such as prismatic film 101 or 102 shown in FIG. 1B or 1C may be incorporated into housing 92 to increase the illuminating effect of LED lights 30. FIG. 9E shows a perspective view of this device as well.

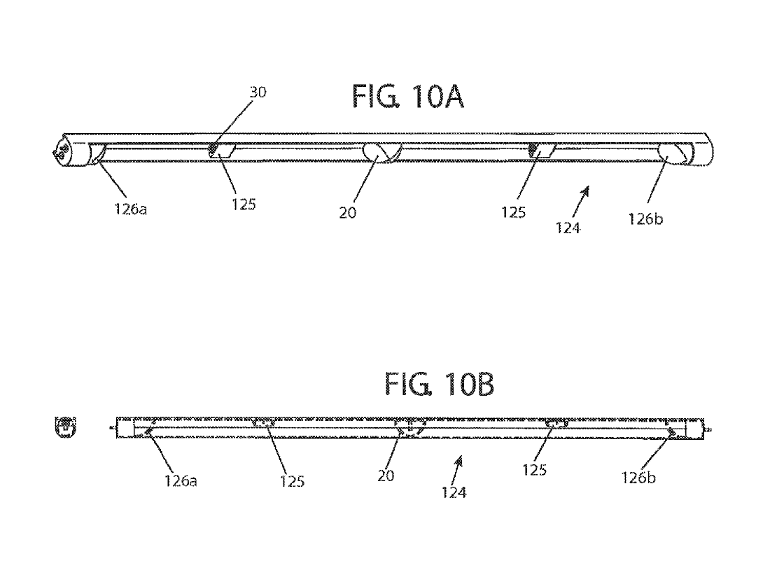

FIGS. 10A and 10B show another embodiment of the invention 124 which includes an additional intermediate LED station 125 which includes LED lights 30 coupled therein as well as a surrounding reflective housing. With this design, LED light points out in two directions from LED stations 125. In a first direction, light emanates from station 125 towards reflector 20. In the second direction, light emanates out from stations 125 and on to side reflectors 126a and 126b which are formed as slanted, rounded reflectors which reflect light down into a room.

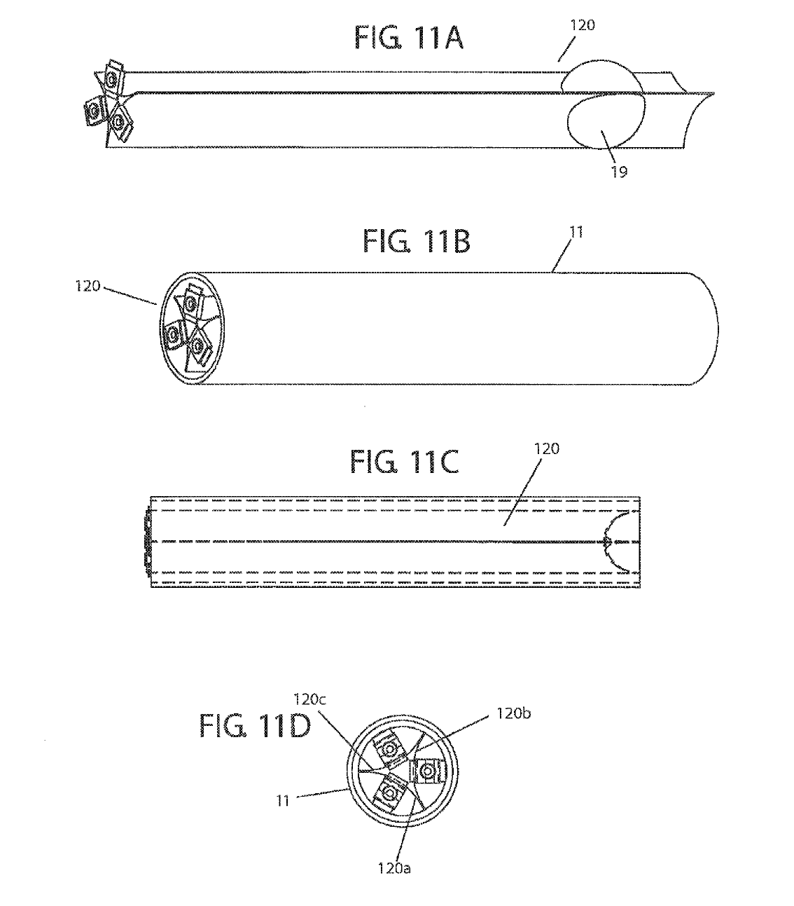

FIGS. 11 A, 11B, 11C and 1 ID show another type of reflector 120 that can be inserted into tube 11. Reflector 120 can be formed as three concave reflectors 120a, 120b, and 120c that can have a mirror or substantially mirror type finish that allows light to be reflected out from tube 11. This reflector 120 is designed to intersect a spherical reflector 19 in a central region as shown in FIG. 11 A with an opposite set of reflectors 120 intersecting spherical reflector 120 on an opposite side.

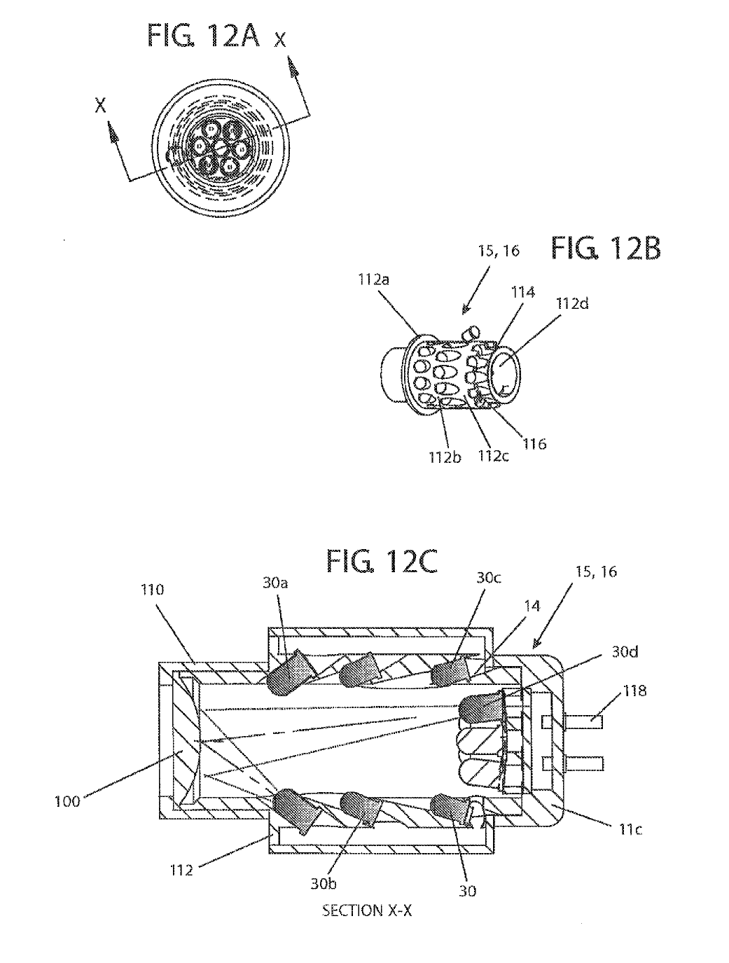

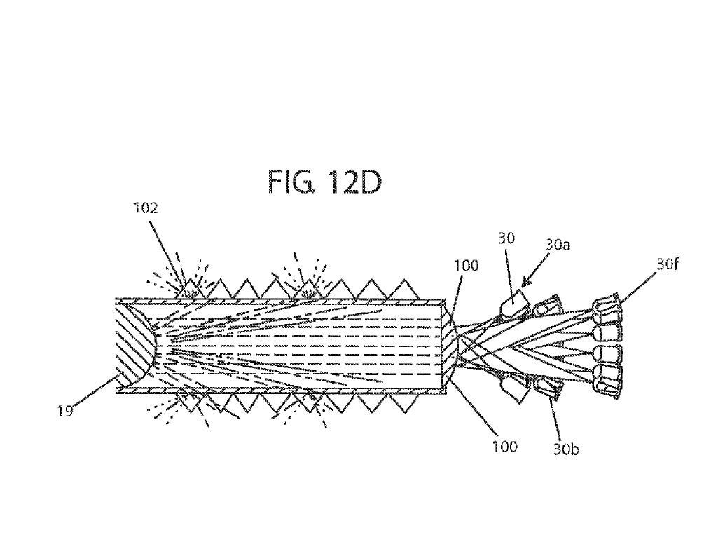

FIGS. 12A, 12B and 12C disclose three different views of endcaps 15, and 16. FIG. 12A is an end view of endcaps 15 and 16, FIG. 12B is a perspective view, while FIG. 12C is a cross-sectional view through line XII-XII. These endcaps are formed as substantially cylindrical endcaps having a first cylindrical connecting section 110, a flange or heat sink 112a coupled to connecting section 110 and a back support section 114 coupled to flange 112a. Connecting section 110 is sized to fit into a tube or housing wherein connecting section 110 has a circular cross section. Flange or heat sink 112a extends radially out from connecting section 110 and is used to dissipate heat away from the LED lights coupled into back support section 114.

Back support section 114 has a plurality of holes 116 which are adapted to receive a plurality of LED lights 30 forming arrays 30a, 30b, 30c, and 30f which extend in and shine in at an angle. Disposed between these holes are additional optional flanges represented by dashed lines 112b, 112c and 112d wherein these flanges also act as heat sinks. In addition, connecting section 110 is also adapted to receive a lens 100 (See also FIG. 1 A), wherein lens 100 focuses and allows light to extend out from endcaps 15 and 16. Extending out from back support section 114 is a back electrical connection 116 containing prongs 118 for connection to an electrical light socket such as a light socket for fluorescent bulbs.

FIG. 12D shows a side cross-sectional view of the device wherein the light housing has been removed and this view reveals LED arrays 30a, 30b, and 30f all showing light being sent in from LED lights 30 into a central region of lens 100 wherein this light is then collimated and then sent as a steady stream to reflector 19.

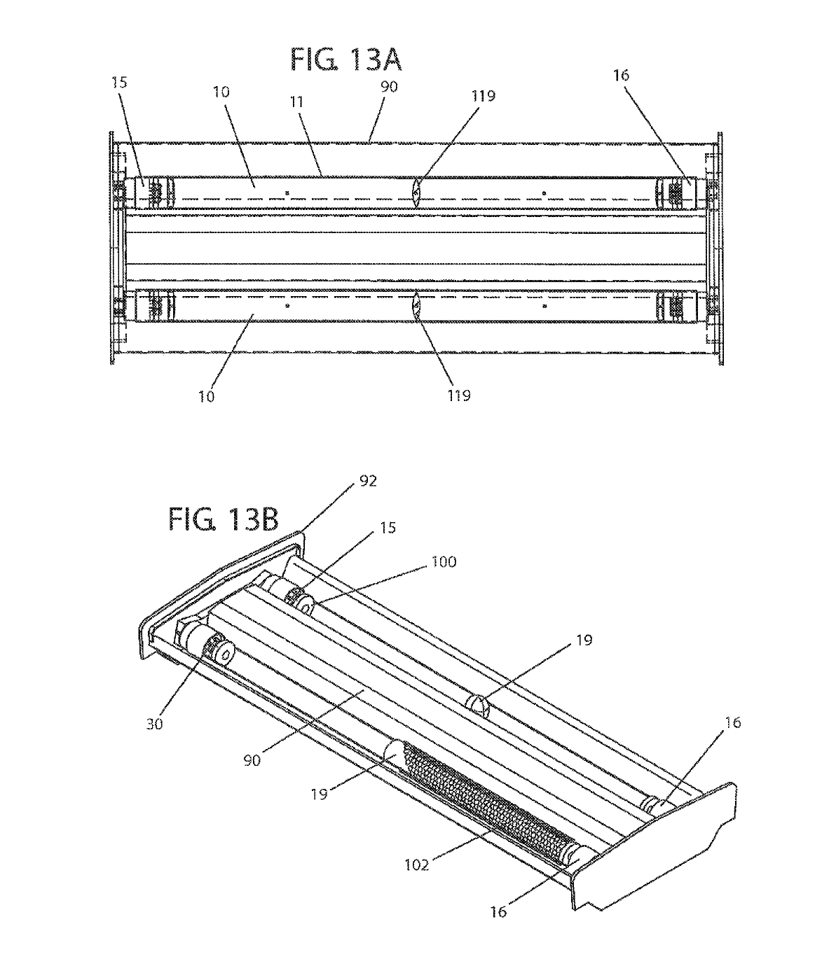

FIG. 13A shows a plan view of two of the devices 10 coupled into a lighting housing 90 which can be similar to a florescent lighting housing. In this view, device 10 has end caps 15, and 16 which are coupled into tube 11 and shine light on a substantially oval shaped reflector 119, which is disposed in a central section of tube 11. FIG. 13B shows a perspective view of a substantially similar design to that shown in FIG. 13 A, however, this design includes spherical reflector 19 shown in FIG. 1A. In this design, lighting housing 90 includes end plates 92 as well. In one of these devices 10, there is no cover or tube 11 which has been removed to reveal spherical reflector 19. In the other device there is at least a partial view of a cover or tube 11b, which includes a prismatic covering 102 which is used to reflect, and refract light to amplify the appearance of light. In addition, in this view, lenses 100 are also shown disposed adjacent to LED lights 30.

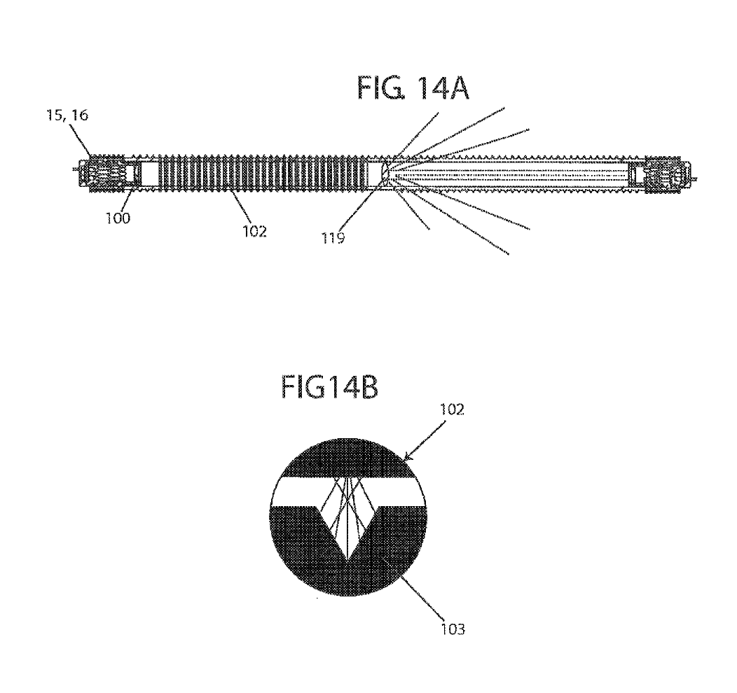

FIG. 14A shows a closer view of this prismatic lens covering 102, which is used to deflect light. For example, FIG. 14B shows an even closer view of prismatic lens system 102 wherein this prismatic lens system includes a plurality of extensions 103 spikes, or pyramidal shaped tetrahedrons, which provide unique features in reflecting light.

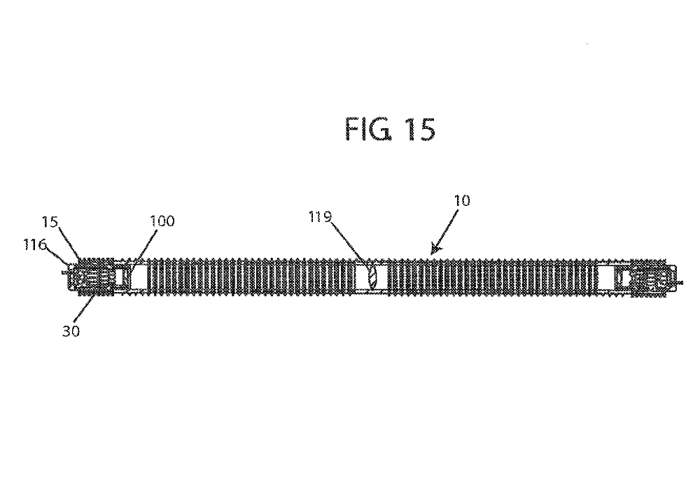

FIG. 15 shows that prismatic lens system 102 extends substantially across tube 11 from endcap 15 to encap 16, over reflector 119 and adjacent to lens 100. The prismatic lens system 102 does not need to extend all the way to cover lens 100 because lens 100 acts as a collimator of light which focuses light emanating from LED lights 30 across tube 11 so that light extends through the tube to reflector 119.

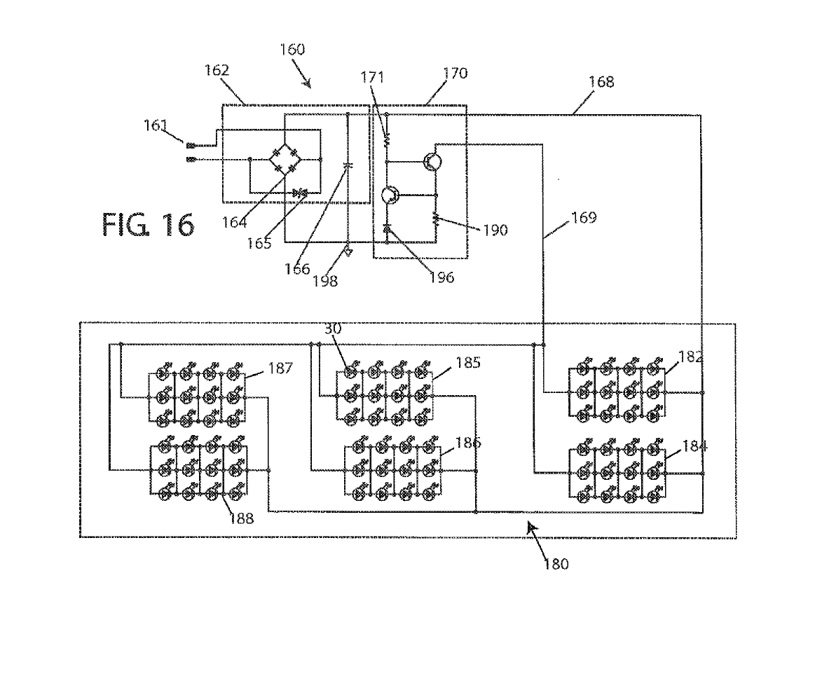

FIG. 16 shows a schematic electronic circuit diagram for the electronic circuitry for controlling power which is used to light the LED lights. This circuit 160 can be disposed in end section 116 in either endcap 15 or endcap 16. Circuit 160 can include a power input connector 161 which can be in the form of prongs 118 extending out from back end section 116 (See FIG. 12C).

The circuit can also include an AC/DC converter 162, a current regulator 170 and an LED load section 180 including a plurality of LED arrays. The power, which in all likelihood is AC power, can then feed into AC/DC converter 162, which converts the AC current into DC current. In an alternative embodiment, this AC/DC converter can be in the form of a DC/DC converter as well. In either case, there is a bridge rectifier 164 to convert the current from AC to DC and at least one capacitor 166 to smooth out the waves to provide a reasonably steady current. To protect bridge rectifier 164 there is a surge protector 165 coupled in parallel with bridge rectifier 164 to provide protection against sudden surges in power. This power flows down a circuit line 168 and feeds into current regulator 170.

Current regulator 170 is designed to regulate the current flowing through the circuit so that LED lights 30 are not blown. In a preferred embodiment the current is regulated to be approximately 20 ma. Current regulator 170 can be used to regulate the current so that there is always a consistent amount of current flowing through the circuit. This current regulator cannot provide an absolutely consistent current but rather provides a relatively narrow current range for current flowing through the circuit. This current regulator receives current flowing through circuit 160 and includes two transistors. The bridge rectifier 164 provides a DC input. Capacitor 166 provides smoothing of the DC input. Zener diode or surge protector 165 provides input surge protection for the electronics. The proper operating voltage range is established through voltage dropping resistor 171 (R1) and transistor 172 (Q1). Transistor 174 (Q2) regulates the current through resistor 190 (R2) and provides the required current to operate an LED array with the specific selected LED's operating current requirements. This regulated current then flows down line 168 into LED arrays 182, 184, 185, 186, 187 and 188 for powering LED lights 30.

LED load section 180, which includes LED arrays 182, 184, 185, 186, 187, 188. Each of the LED arrays are coupled both in series and in parallel so that if one LED array is blown or destroyed the remaining LED arrays can receive power. In addition, each of the LED lights in each LED array is coupled in both series and parallel so that if one individual LED light is blown the remaining LED lights in each individual array can still shine.

With this design, the device can be coupled to a plurality of different power units, which can each have different voltage inputs. For example, power units having voltages in the order of 12V, 24V, 37V, 48V, 76V, 95V or 120V can be used to power this device because the current is always regulated by current regulator 170.

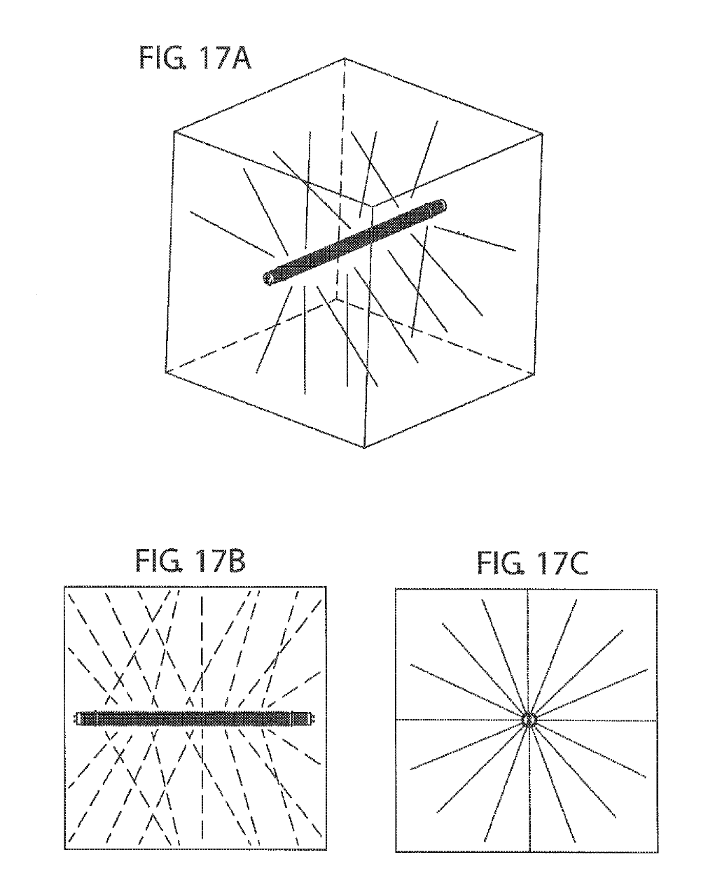

With this design, device 10 having a reflector 19 or 20 and a set of LED arrays coupled into endcaps 15 or 16 can be used to create an omnidirectional light which creates a uniform light distribution pattern flowing from LED lights as shown in FIGS. 17A, 17B and 17C. This design with the circuit above is then adaptable to different power inputs such as those on cars trains or in houses to provide a lighting design that is inexpensive to operate.

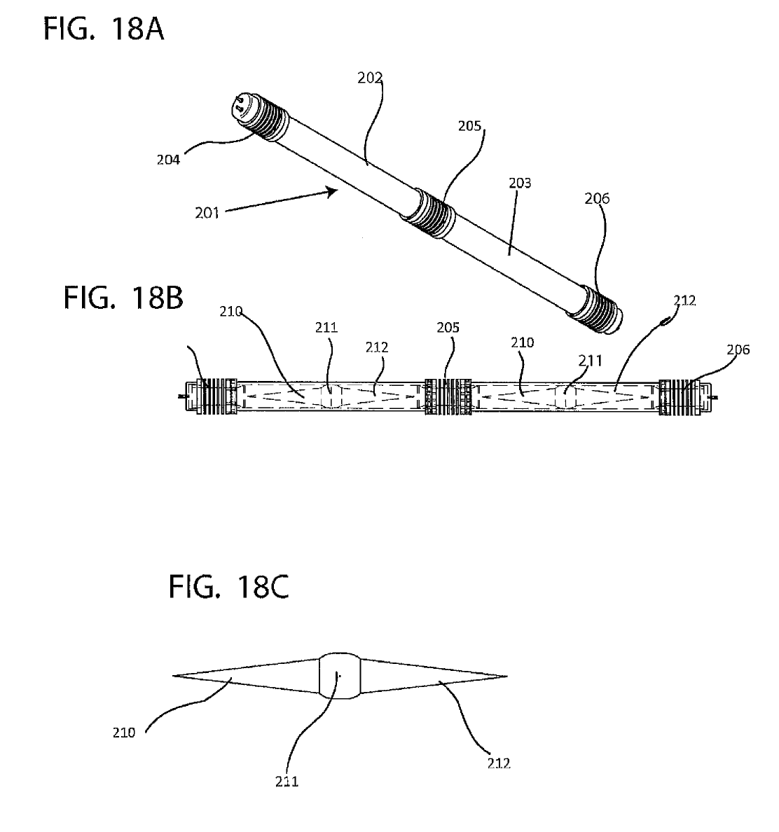

FIG. 18A shows a perspective view of another embodiment which discloses a two part bulb 201 having a first part 202, and a second part 203. First bulb 202 is bound by heat sinks 204 and 205 while second bulb 203 is bound by bulbs 205 and 206.

FIG. 18B shows a side view which shows two bulbs 202 and 203 wherein inside of each of these bulbs is a first reflector 210, a middle reflector 211 and another reflector 212. Each of these reflectors are bound by a heat sink 204 and 205, wherein disposed inside of each of these heat sinks is a light (not shown). FIG. 18C shows these reflectors 210, 211, and 212 in greater detail. Reflectors 210 and 212 are substantially conical or partially conical in shape, while reflector 211 is substantially or partially spherical in shape. First reflector 210 forms a first reflective section having a shape taken from the group comprising or consisting of: substantially conical, sectional conical, frusto-conical, or rounded, or at least has a portion that is, or is at least substantially conical, sectional conical, frusto-conical, or rounded. Reflector 211 forms a second reflective section having a shape taken from the group comprising or consisting of: rounded, spherical, semi-spherical, dome shaped, or a shape having at least one portion that is, or is at least substantially rounded, dome shaped or spherical shaped. The second reflective section has at least a portion which has a steeper slope compared to the first reflective section taken along a longitudinal axis of the reflector.

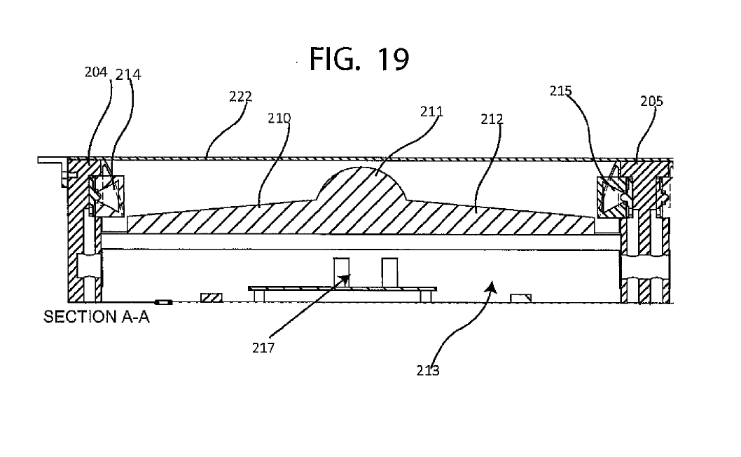

FIG. 19 shows a side cross-sectional view of a portion of the reflector shown in FIG. 18B. In this view, there is shown reflectors 210, 211, and 212 which are bound at each end by heat sinks 204 and 205, wherein coupled to each of these heat sinks 204 and 205 are respective lights 214, and 215. These lights can be in the form of any sufficient lights but in at least one embodiment are LED lights. To prevent these LED lights from overheating, heat sinks 204 and 205 are provided. Heat sinks 204 and 205 can be made from any suitable material but in this case are made from either aluminum, copper or some form of metallic substance such as an aluminum or copper alloy having a sufficient heat conductivity to prevent the associated lights 214 and 215 from overheating. These lights, and reflectors are all housed inside of housing 213.

In addition, these lights and reflectors are bounded or covered by a translucent and even transparent cover 222. In this case cover 222 can be translucent and/or transparent, with the definitions for translucent and transparent provided above applying herein.

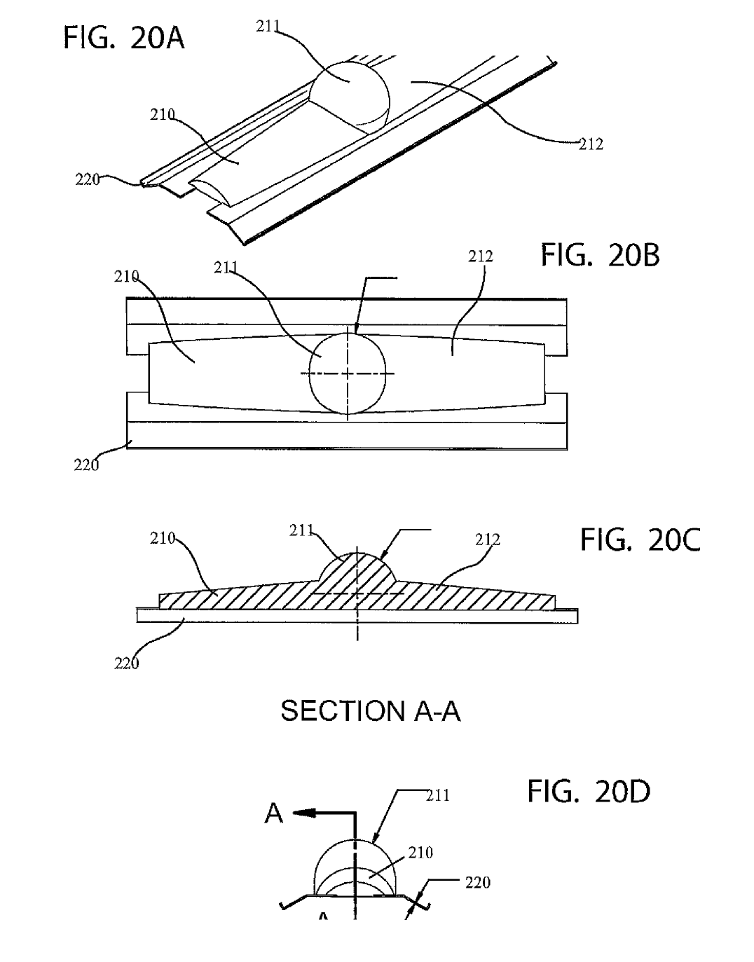

FIG. 20A shows a side perspective view of the reflector which is embedded in a support structure 220. Support structure 220 allows reflector 210, 211 and 212 to be coupled to an adjacent support structure.

The shapes of reflectors 210, 211 and 212 are shown in the previous drawings, but are also disclosed in FIGS. 20A, 20B, 20C and 20D which show a partially conically shaped reflector such as reflector 210 leading into a partially or substantially spherically shaped reflector. The substantially conically shaped reflector such as reflector 210 and 211 creates a more shallow angle of intersection for the light into the substantially spherically shaped reflector 211. This keeps the light from being absorbed or retained inside of the housing, instead, the light is dispersed from this housing to the surrounding area. There is also a side panel 220 which is used to secure the reflector inside of a housing such as inside of housing 213.

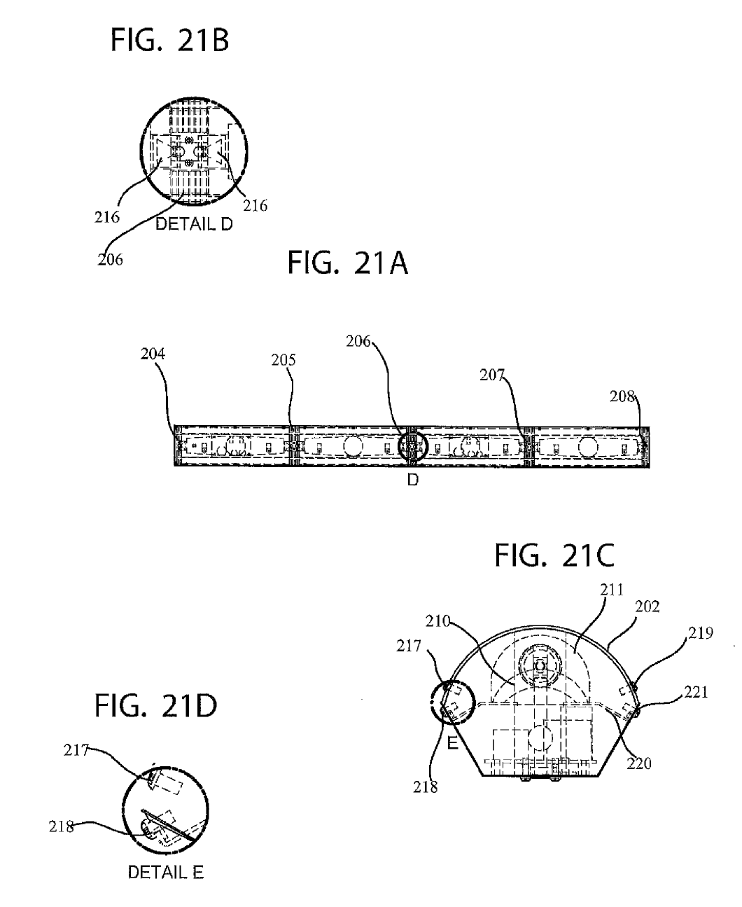

FIG. 21A shows a top plan view of another embodiment which shows a bulb comprising four continuous reflectors positioned end to end, wherein these four continuous reflectors are bound by heat sinks 204, 205, 206, 207 and 208. FIG. 21B shows heat sink 206 taken from detail D shown in FIG. 21 A wherein heat sink 206 includes two different lights 216a and 216b disposed opposite each other. FIG. 21 C shows another detail which shows two different lights 217 and 218 wherein these two different lights are positioned at different angles relative to lights 216a, and 216b and are positioned to point at an angle transverse to the angle presented by end lights 216a and 216b. For example these two lights 217 and 218 are essentially side lights which are coupled to side panel 220 and which are angled point such that the focal point of these lights intersect on the reflector such as reflectors 210 and 211.

There are also two additional side reflectors 219 and 221 wherein these side reflectors are also coupled to side panel 220 and are positioned to have their focal points intersect at the reflectors.

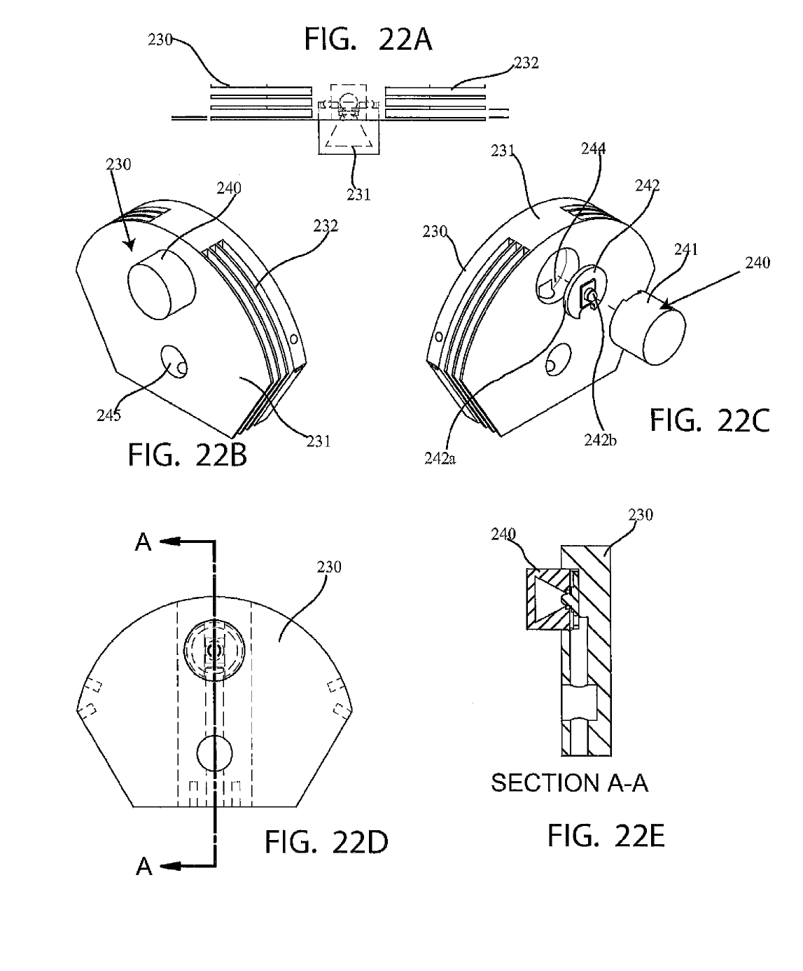

FIGS. 22A-22E show differing views of the heat sinks which in this embodiment is shown as reference numeral 230, however these heat sinks 230 are substantially the same or the same as heat sinks 204, 205, 206, 207, and 208 shown in FIGS. 21A.

In this case heat sink 230 includes a body section 231, and fins 232. In addition, there is a lens 240 which is coupled to body section 231 as shown in FIG. 22B. There is also a screw hole 245 which is used to couple the heat sink to a housing or to another adjacent heat sink There is a light 240 which includes a lens 241, and a LED light 242 which includes a circuit board 242a, and a light such as a LED light section 242b. Both circuit board 242a and light section 242b are covered by a lens cover 241, wherein this entire device is inserted into hole or housing 244. FIG. 22D shows this heat sink 230 which has a bisecting line A-A wherein the cross-sectional view is shown in greater detail in FIG. 22E, which shows body 230 and light 240.

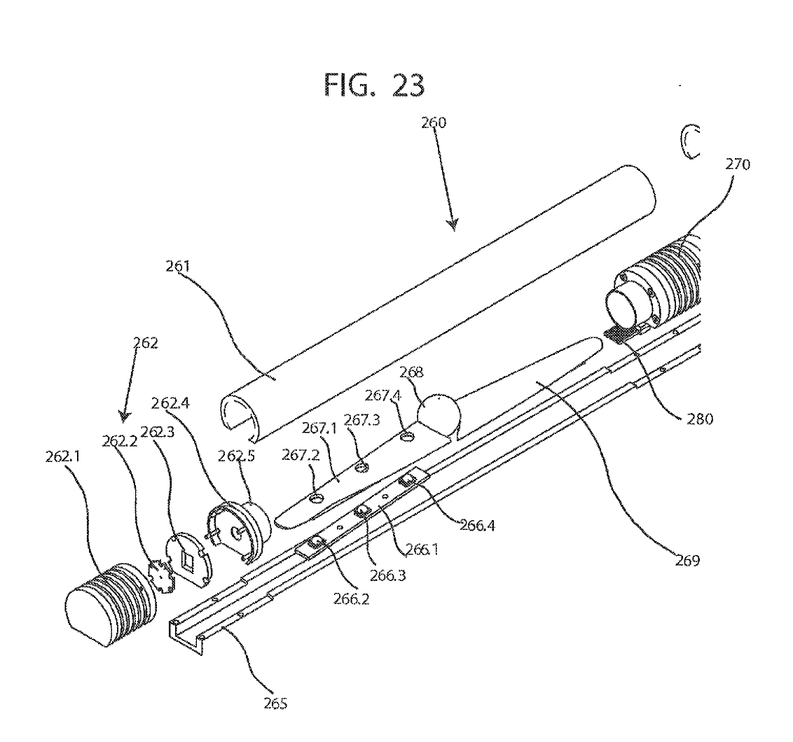

FIG. 23 shows a perspective view of another embodiment of a light system 260 which shows end piece 262 which is in the form of a cylindrical heat sink 262.1, having a plurality of fins, there is also an LED circuit board 262.2 a lens plate 262.3 and a cover base 262.4 and a cylindrical tube 262.5. There is also a cylindrical cover 261 which covers lover lights 266.2, 266.3, 266.4 which are in a light array 266.1 and which are housed underneath reflective housing 267.1 having holes 267.2, 267.3, 267.4 which are configured to receive the lights. There is also a spherical reflector 268 and oppositely spaced reflector 269. A backing 265 is also coupled to this light array. Reflector 267.1 forms a first reflective section while reflector 268 forms a second reflective section. The first reflective section 267.1 has a shape taken from the group comprising or consisting of: substantially conical, sectional conical, frusto-conical, or rounded, or at least has a portion that is, or is at least substantially conical, sectional conical, frusto-conical, or rounded. The second reflective section 268 has a shape taken from the group comprising or consisting of: rounded, spherical, semi-spherical, dome shaped, or a shape having at least one portion that is, or is at least substantially rounded, dome shaped or spherical shaped.

This light system shown in FIG. 23 can be incorporated into an endless light system which includes both light system 260 along with additional light systems 270, 280 which are similar to light system 260 and which are coupled to end pieces 263, 271, and 271.

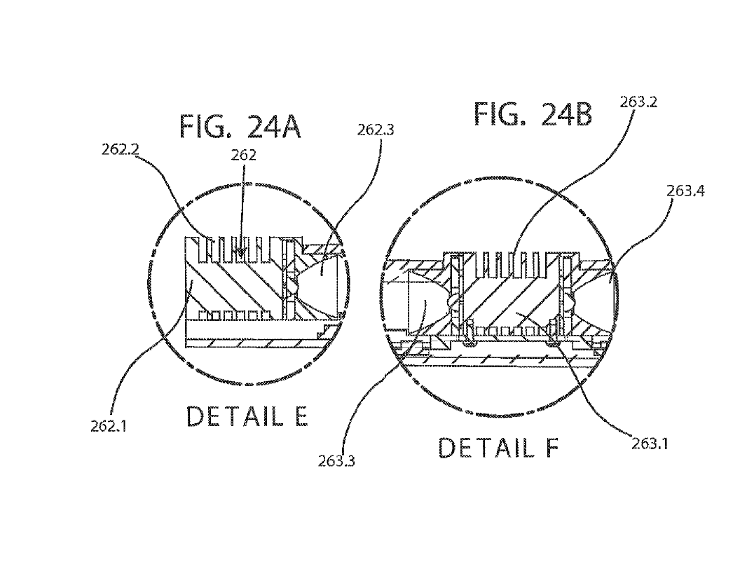

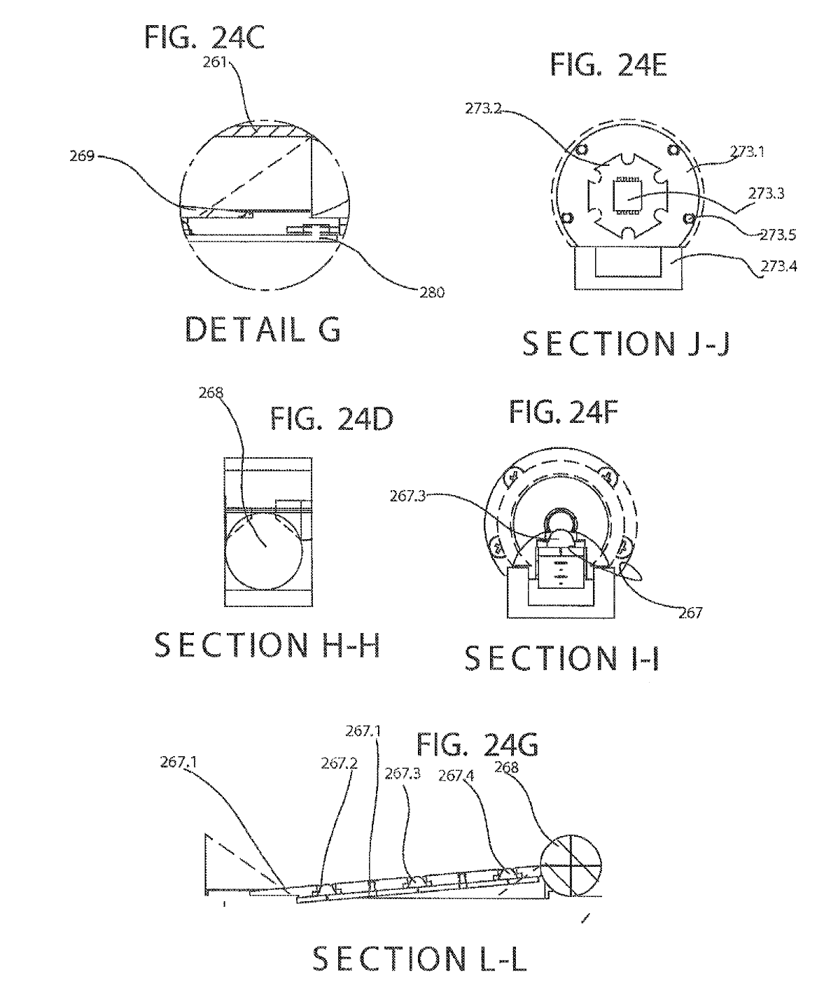

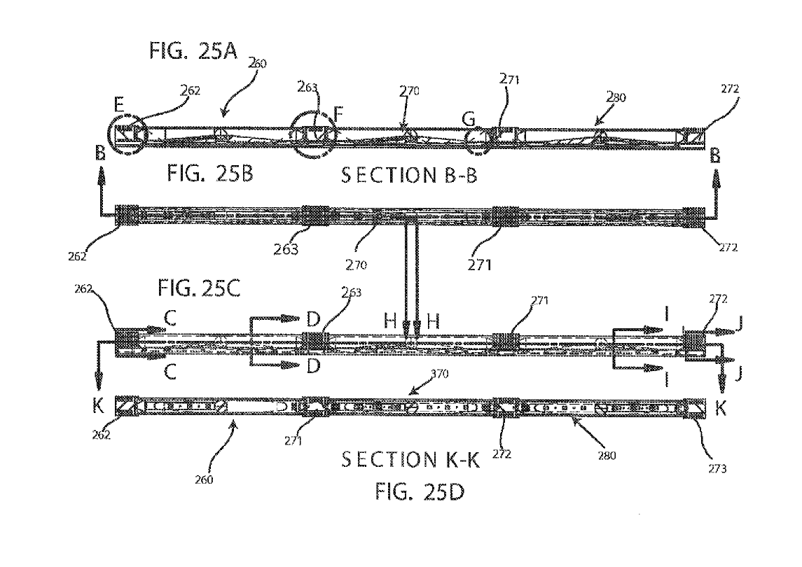

FIG. 24A shows a view of detail E from FIG. 25A-D which shows end light 262, having a heat sink 261.1, a plurality of fins 262.12 and a lens 262.3. In addition, there is also shown FIG. 24B which shows detail F which shows a double sided light 263, which shows a base heat sink 263.1, a plurality of fins 263.2, and lenses 263.3, and 263.4.

FIG. 24C shows detail G which shows cover 261, along with tongue 269 formed above a groove 269.1 wherein this groove is configured to receive electrical connector 280 therein. This connection end therefore allows for the physical and electrical connection of end lights such as light 262, or light 263 to the body of the light system 260. FIG. 24D shows a side cross-sectional view taken along the line H-H showing spherical reflector 268.

FIG. 24E shows an end view of a heat sink such as heat sink 273 having a first body section 273.1, a second body section 273.2 a central connection section 273.3, a base 273.4. FIG. 24E is as side view of the backing plate 273.1 and the setting plate 273.2 wherein this setting plate 273.2 is designed to support LED lights. There is also a base 273.4 wherein this back plate is secured by coupling holes 273.5 which are configured to receive a lens body. FIG. 24F shows an end view which shows a spherical ball reflector 267.3 positioned along a line, and in line with light.

FIG. 24G shows a side cross-sectional view through the section L-L which shows reflective surface 267.1, lights 267.2, 267.3, and 267.4 which are coupled to reflective surface 267.1. These lights can be in the form of LED lights or any other type of available lights as well.

FIG. 25A is a side cross-sectional view of a light system 260 taken along the line B-B which includes light systems 260, 270 and 280. Light system 260 includes end lights 262, and 263. Light systems 270 includes lights from double ended light 263 and 271. Light system 380 includes double ended light 271 and end light 272. FIG. 25B shows a top view of this light system. FIG. 25C shows another side view, while FIG. 25D shows a top cross-sectional view through line K-K.

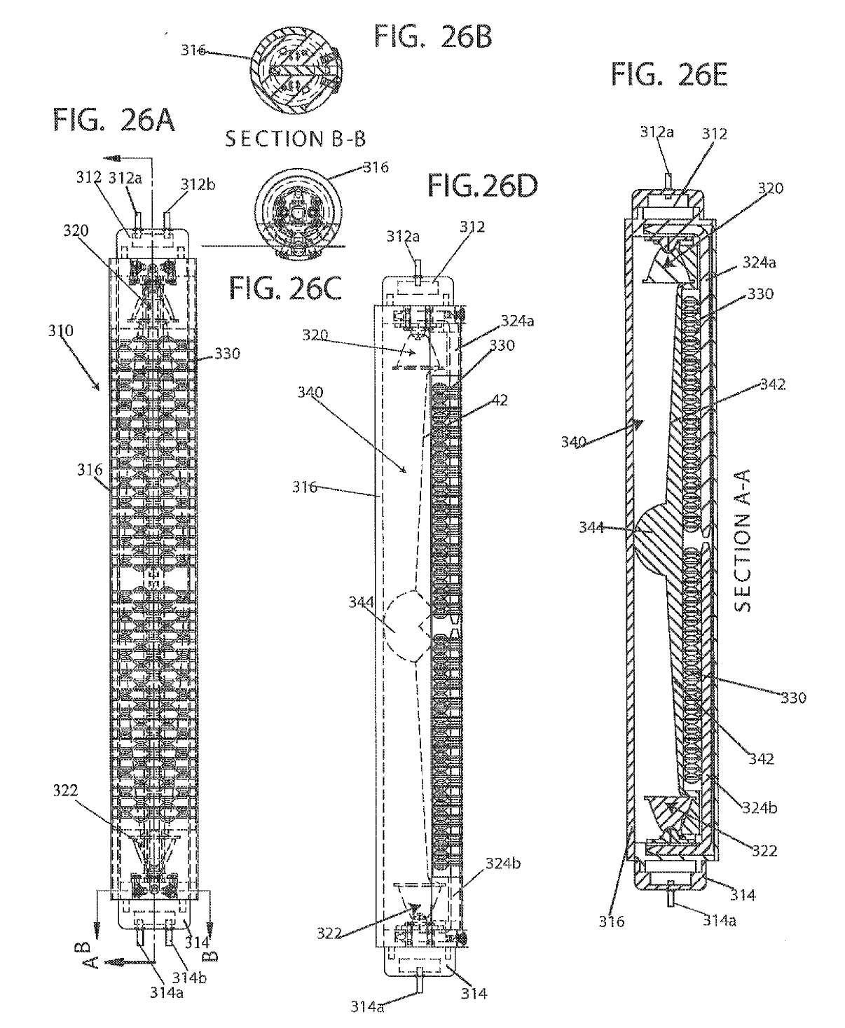

FIG. 26A shows a bottom view of a light system 310 which includes an end 312 and an opposite end 314. End 312 includes prongs 312a and 312b which are configured to connect to a power source. End 314 includes prongs 314a and 314b. In addition, there is a cover 316, which is made from a translucent material which allows light to shine therethrough.

There are also two lights 320 and 322 which are disposed opposite each other with light 320 being coupled to end 312, and light 322 being coupled to end 314.

FIG. 26B shows an end view taken through the line B-B shown in FIG. 26A. This view shows the cover 316 as well. FIG. 26C shows an end view of this light system which shows cover 316 as well.

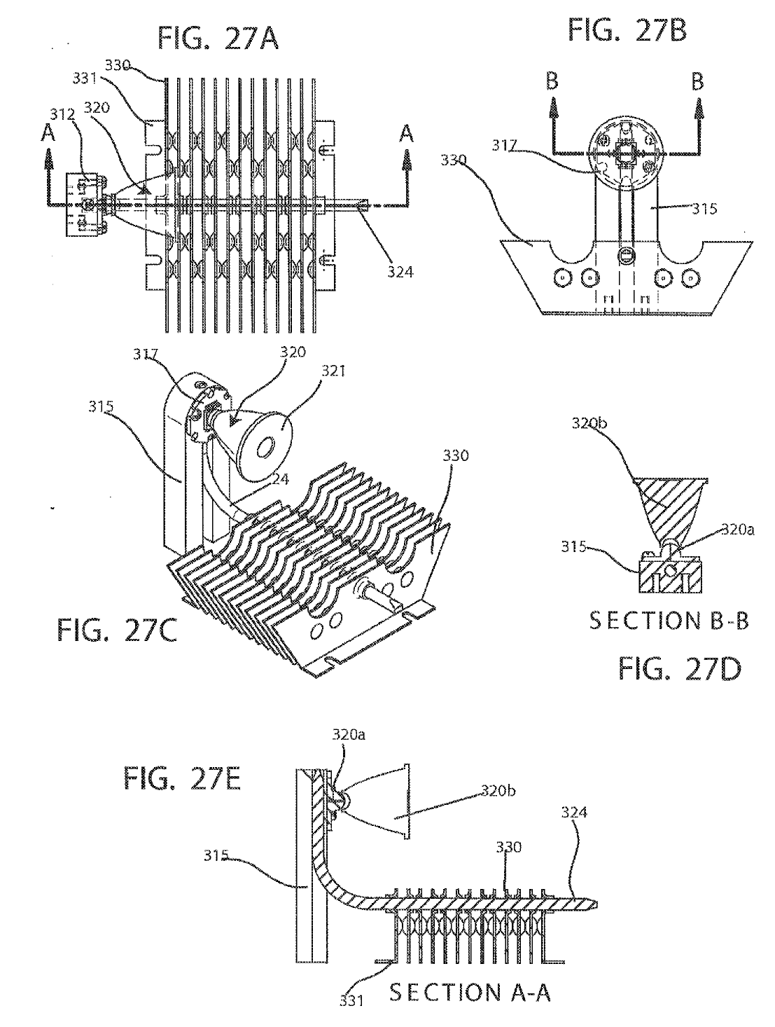

FIG. 26D shows a side view of the light system which shows ends 312 and 314 including prongs 312a and 314a, along with lights 320 and 322 disposed opposite each other. Lights 320 and 322 are configured as LED lights which have acrylic lenses coupled to each of these lights. Each of these lights 320 and 322 has a heat pipe 324 coupled to these lights. Heat pipe 324a and 324b are configured as L-shaped heat pipes which are configured to funnel heat from the light down to a heat sink In this case, heat pipe 324 is configured to pass this heat to a heat sink 330. Heat sink 330 is disclosed in greater detail in FIGS. 27 A-27D and comprises a plurality of fins coupled to the heat pipe. Heat sink 330 including the fins can be made from any suitable material but in at least one embodiment is made from aluminum. Heat pipe 324 (See FIG. 27C) can be made from any suitable material but in at least one embodiment comprises copper or a copper alloy.

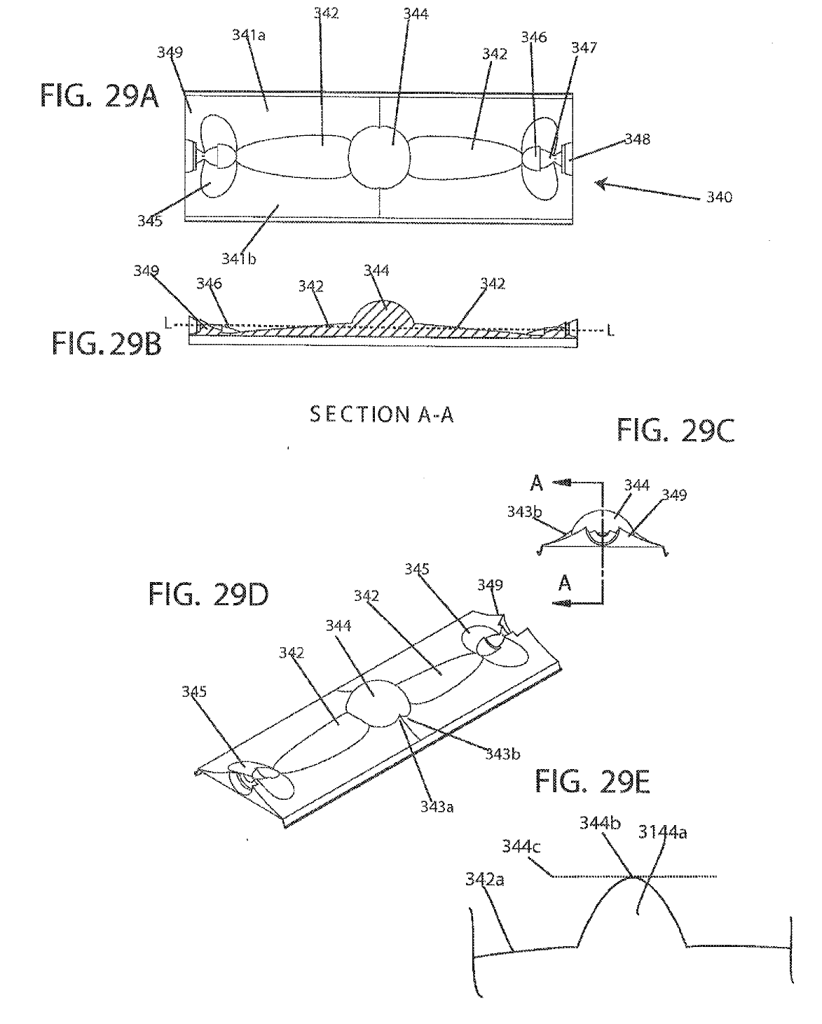

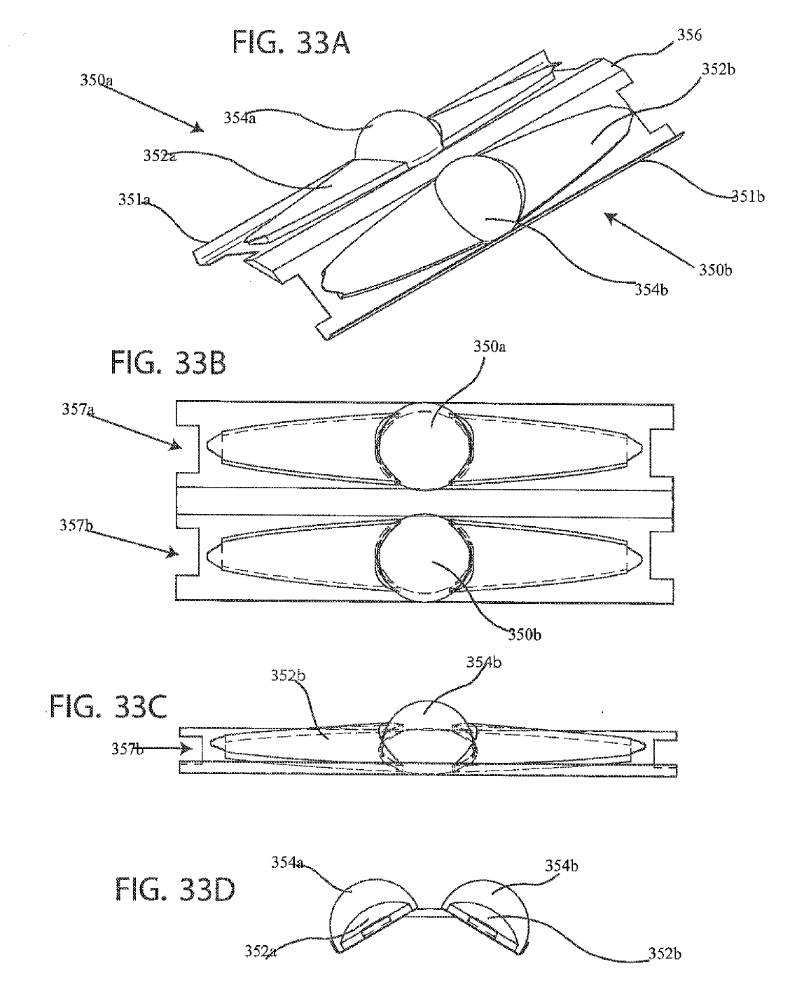

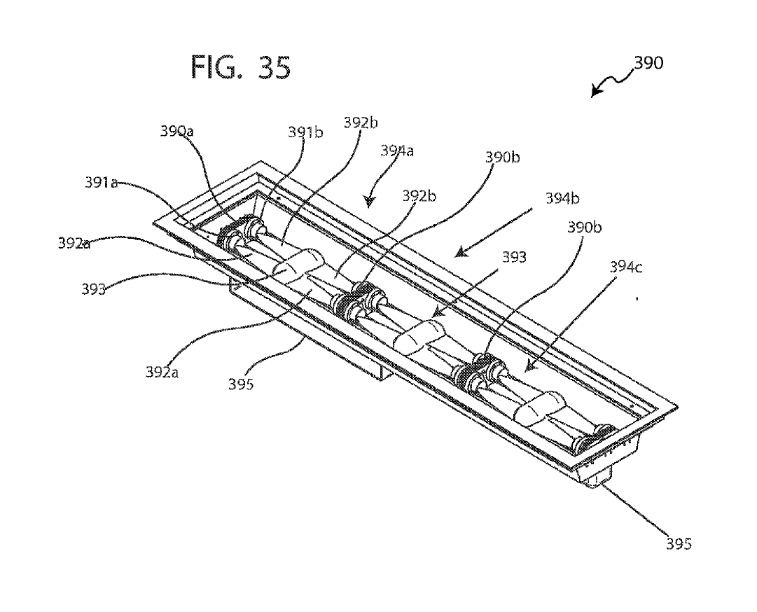

Reflector 340 is configured as an intermediate reflector and which can be configured as a substantially conical or oval shaped reflector which extends into a substantially dome shaped or spherical reflector 342. A first style reflector is explained in greater detail in FIGS. 29A-29E while at least a second style reflector is explained in greater detail in FIGS. 33A-33D, and a third style reflector is explained in greater detail in FIG. 35.

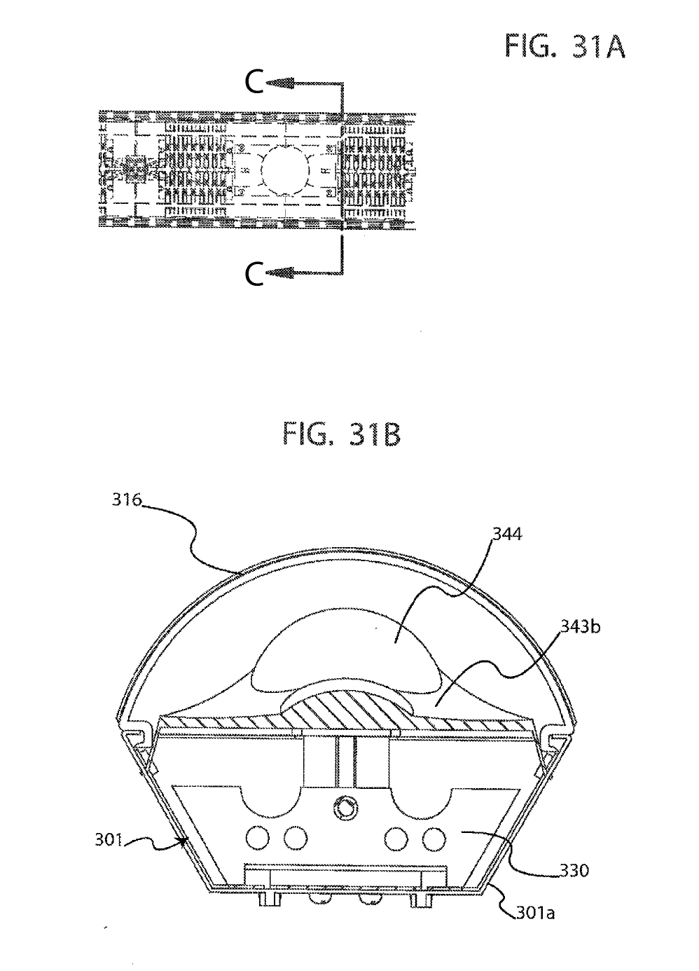

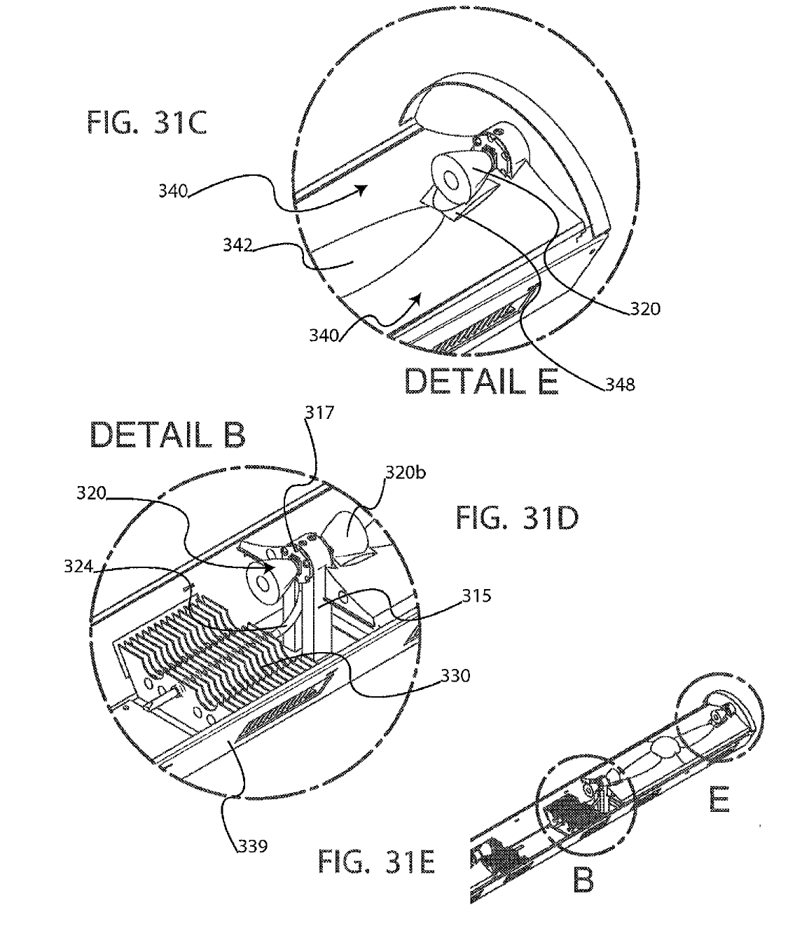

FIG. 26E shows a side cross-sectional view of the light system 310 which includes lights 320 and 322, as well as ends 312 and 314 along with heat pipes 324 extending below reflectors 340 and 342. With this design, the heat sink 330 is disposed between reflector sections 342 and 344 and housing section 301a which is configured to be mountable on structure, such as a wall, or ceiling, a beam or pipe. (See FIG. 31B). This design provides a system where heat is dissipated at a distance away from the LED light, allowing a highly efficient cooling system which is disposed at a distance spaced away from the light. This design allows for not just radial heat transfer through a block or heat sink but also transfer through a heat pipe such as heat pipe 324 as well.

FIG. 27A is a top plan view of the heat sink system, which shows end 312 coupled to light 320. As shown in FIG. 27B which shows an end view, this end 312 includes a light stand 315, coupled to a light holder 317. Light stand 315 can be made of any suitable material but in this case is made from aluminum. In addition light holder 317, is also configured as a circuit board coupled to light stand 315.

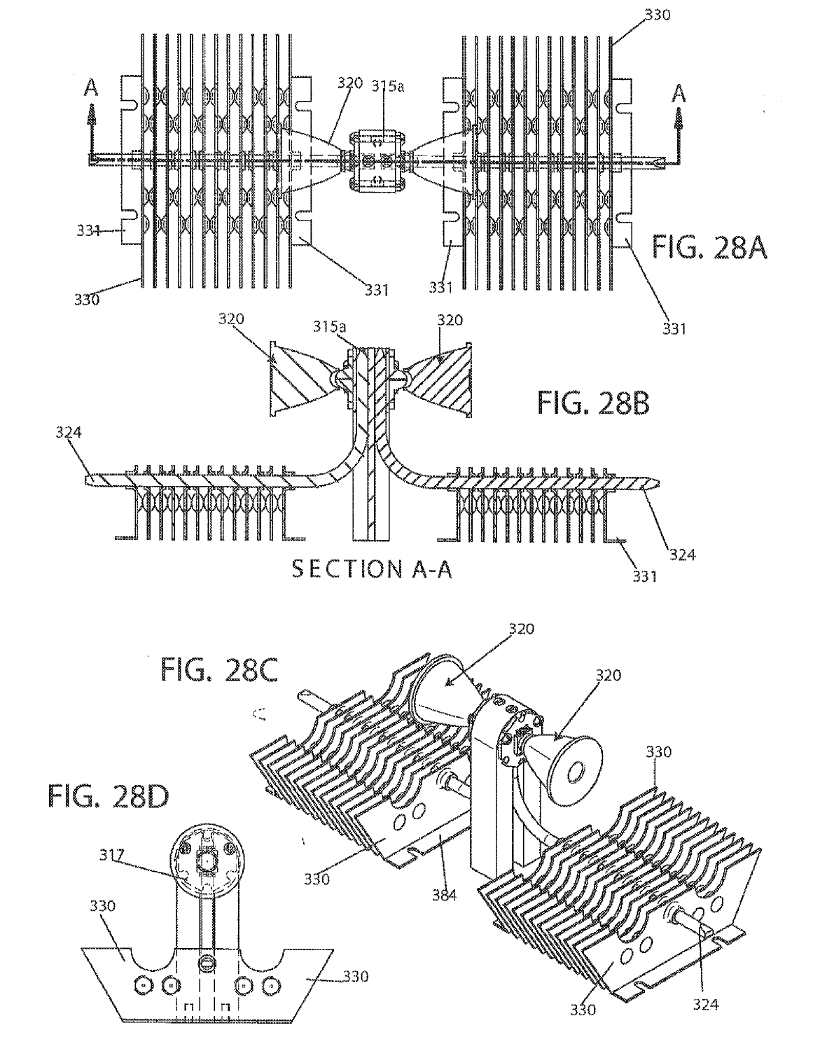

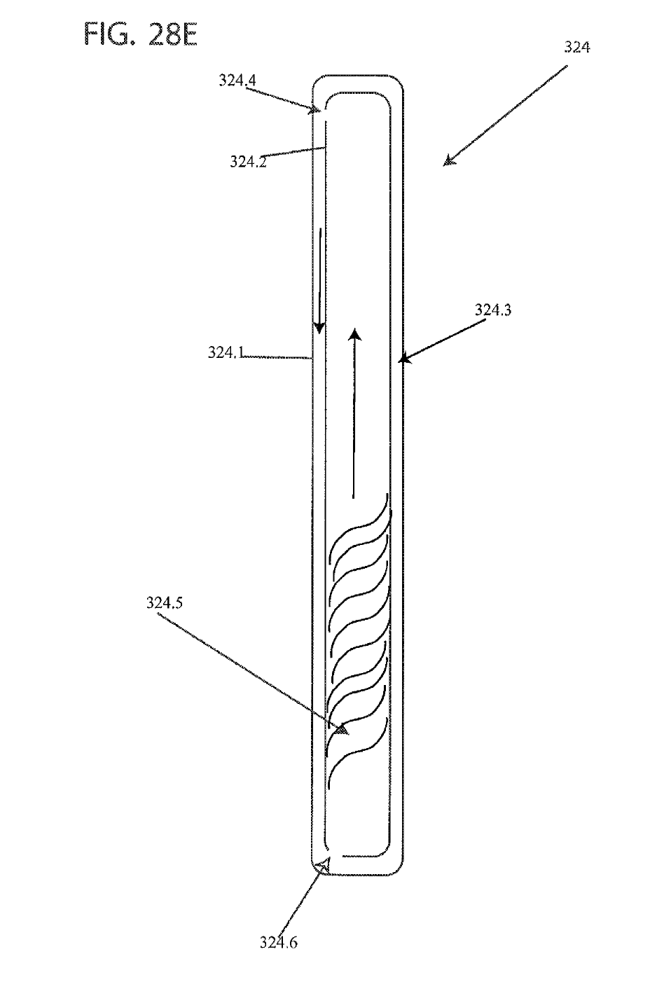

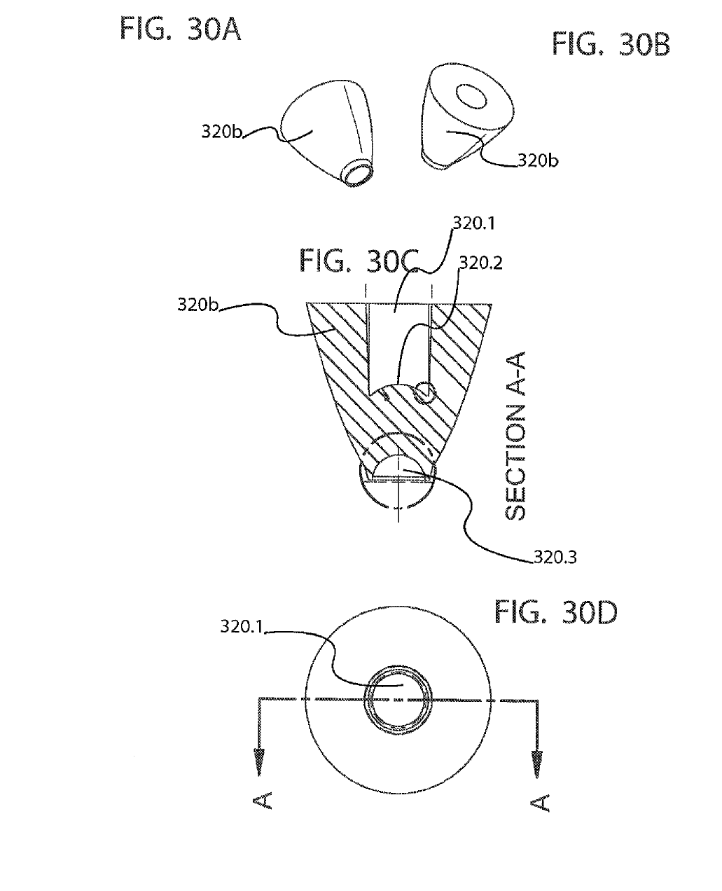

As described above, light 320 includes a LED light 320a (See FIG. 2E) which is coupled to an acrylic lens body 320b. LED light is coupled to circuit board 317 and sends light into lens body 320b which in at least one embodiment is a solid acrylic body (See also FIGS. 30A-30D). Lens 320b includes a lens cap 321 which is configured as a locating ring. In at least one embodiment, this lens encases the entire LED, such that this encasement will eliminate light leakage to the sides. FIG. 27C shows a perspective view of the heat sink system which shows fins 330 coupled to heat pipe 324 with the heat pipe 324 (324a, 324b) extending through these fins, such that heat pipe 324 is configured to dissipate heat into fins 330. FIG. 27E shows this as well. Fins 330 also can include stands 331 which are ends of fins 330 bent in a substantially perpendicular manner. As shown in FIG. 28A, there is a double ended heat sink system which includes two sets of fins 330 with at least some of these fins 330 having stands 331. Light stand 315 is shown coupled to lights 320a and lenses 320b. This double ended view is also shown in FIGS. 28B and 28C. FIG. 28D shows an end view of this type system.

FIG. 28E is another view of the heat pipe, which shows an outer tubing 324.1, an inner tubing 324.2, a channel 324.3, and a first hole or feed 324.4 which allows a fluid 324.5 to cycle through or circulate within heat pipe 324 and a second hole 324.6 which allows the fluid to flow back into the cooling chamber once it has condensed. The end with hole 324.6 is adjacent to the light while the end with the hole 324.4 is opposite the end with the light. The fluid that can circulate within heat pipe 324 can be for example, ammonia, water or any other suitable fluid. The fluid is configured to be heated into a steam or gas at the heated end adjacent to the light, while the fluid is configured to condensate and feed back to the heated side at the opposite cooling side. The changing states of the fluid from liquid into gas, at the heated end and from gas back to liquid at the cooling end allows for rapid heat transfer away from the light.

With this design, the heat sink is disposed in a position offset from the location of the light 320a.

FIG. 29A shows as top plan view of a reflector 340 comprising a plurality of different sections. For example, there is a first section comprising sides 341a and 341b forming a first skirt, a central substantially conical or elongated oval shaped reflector 342 which extends into a substantially spherical region 344. The reflector 340 is made from a light reflecting material such as a substantially light or white polymer.

There is also a secondary skirt section 345, along with a light clearance section comprising first clearance section 346 and a second clearance section 347. Skirt 341a, and 341b is part of a first reflective portion or section comprising reflective section 341a, 341b, and 342 along with reflective portion 345 and 349. These skirts extend in an upward sloping manner towards each end. For example, at the end near spherical reflector 344, the skirt slopes up into a ridge in sections 343a and 343b. In addition, at the terminal ends 349 adjacent to the lights, the reflector skirt slopes up as well as shown in cross-sectional view 29B which is taken along section A-A in FIG. 29C. These features are also shown in FIG. 29D as well. This first section has a shape taken from the group comprising or consisting of: substantially conical, sectional conical, frusto-conical, or rounded, or at least has a portion that is, or is at least substantially conical, sectional conical, frusto-conical, or rounded.

Reflector section 344 forms a second reflector section spaced apart from a light by first reflective section. This second reflective section has a greater slope than the first reflective section relative to a longitudinal axis L-L extending parallel to a light path of a light and a center direction of the light path. This second section has a shape taken from the group comprising or consisting of: rounded, spherical, semi-spherical, dome shaped, or a shape having at least one portion that is, or is at least substantially rounded, dome shaped or spherical shaped.

FIG. 29E shows a side cross-sectional view of another type reflector 344a which substitutes for reflector 344. In this view, reflector 344a is angled up to a ridge 344b which keeps reflector 344a from forming a top substantially flat dead zone in terms of light reflection. This design is substantially similar to a spherical or dome design, with a center section or slice taken out of it, and with each reflective end then pressed together. An example of this slice is shown by dashed lines in reflector 344 in FIG. 29C. This reflector has a first section 342a and a second section 344a. First section 342a has a shape taken from the group comprising or consisting of: substantially conical, sectional conical, frusto-conical, or rounded, or at least has a portion that is, or is at least substantially conical, sectional conical, frusto-conical, or rounded. Second section 344a has a shape taken from the group comprising or consisting of: rounded, spherical, semi-spherical, dome shaped, or a shape having at least one portion that is, or is at least substantially rounded, dome shaped or spherical shaped.

FIG. 30A is a first perspective view of a lens 320b, while FIG. 30B is a second perspective view of this lens. FIG. 30C is a side cross-sectional view of the lens 320b taken along the line A-A shown in FIG. 30D. In this view, the different sections of lens 320b are shown, wherein there is a body section 320b, which has a inner bore or hole 320.1, and a convex inner face 320.2. There is also a recess 320.3 for receiving a bulb of a LED light. FIG. 30D also shows this bore 320.1

FIG. 31A is a top cross sectional view of the light system shown in FIG. 29A. FIG. 31B is an end view of this light system taken along the line C-C. In this view, there is shown cover 316, reflector 344, which can be spherical, substantially spherical or simply rounded. In addition there is also shown intermediate reflector 343b. Heat sink 330 is also shown underneath this reflector.

FIG. 31C shows a cut away detail E while FIG. 31D shows a cut-away detail B taken from FIG. 31E. Cutaway detail E shows light 320 resting on reflective surface 340 having a rounded resting surface 348 supporting light 320. Cutaway detail B shows light 320 coupled to base 315 which is coupled to heat sink 330 via the heat pipe. This device is then disposed inside of a vented housing 339. Vented housing can be made from any suitable material but in this case the material is made from metal.

FIG. 31D shows the structure, of the LED light/lens 320 which is coupled to base/body or support 315. Body or support 315 acts as a heat sink to draw away heat from LED 320, 320a and circuit board or base 317 (See FIG. 27C). In addition, spaced apart from this base or body 315 is a heat sink 330 which acts as a second heat sink This second heat sink is not directly connected to the LED 320a, or to the circuit board 317. Instead a heat pipe 324 is used to transfer heat from base or body 315 to heat sink 330. Thus, with this cooling means there is a transfer of heat through a heat pipe from a first position adjacent to light 320a, and/or circuit board 317 to a second position spaced apart from this first position but connected by the heat pipe. In this design as well, there is at least one heat sink 330 disposed in a path of a light beam or light emission of light 320. However, disposed along this path is at least one reflector 340 covering this heat sink 330.

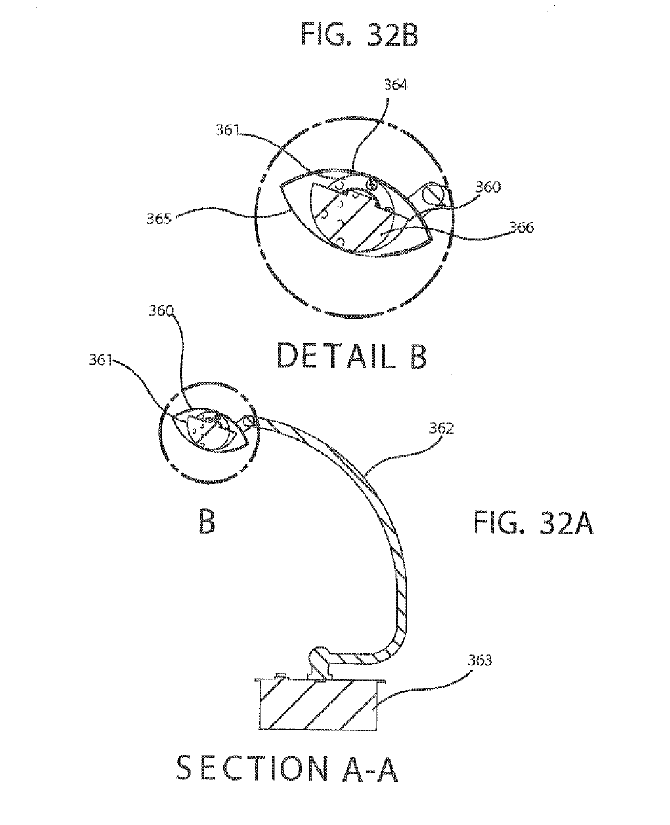

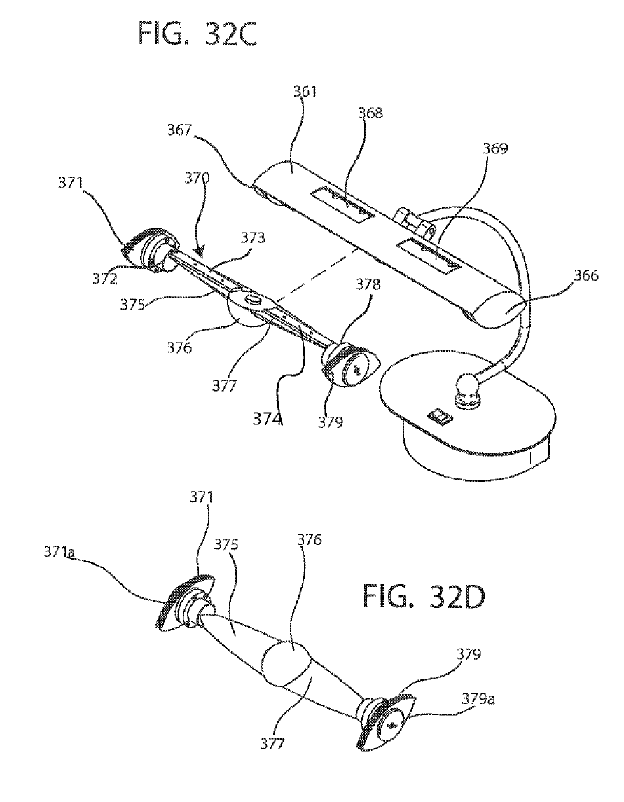

FIGS. 32A and 32B show a light which can be configured to house a light such as that shown in FIG. 19. In this case, light 360 includes a body section 361, a neck 362 and a base 363. Body section 361 includes a backing 364, a lens 365 and side clips 366 and 367 shown in FIG. 32A and 32C. FIG. 32C shows another view which shows body section 361 having openings or vents 368 and 369 as well. In addition, there is shown a light 370, which has two end heat sinks, 371 or 379. Coupled to these heat sinks 370 and 379 are lights 372 and 378.

In addition, back body sections 373 are coupled to lights 372 and 379 respectively. In addition, reflectors 375 and 377 are coupled to back body sections 373 and 374 respectively. Furthermore, there is a central reflector 376 disposed between reflectors 375 and 377. Reflectors 375 and 377 are substantially mirror images of each other are which are partially conically shaped. These two reflectors extend into a substantially spherically-shaped reflector 376, which forms substantially dome-shaped reflector. On the ends of heat sinks 379 and 371 are electrical contacts 379a and 371a (See FIG. 32D) which are used to connect electrically to end pieces 367 and 366. FIGS. 32C and 32D show a lamp light configuration including reflectors 375 and 377 along with spherical reflector 376. Lights 372 and 378 are also included. This design is included in a light housing 361 having electrical contact ends 367, and 366 along with top lights 368 and 369. When the light is inserted into the housing, ends 367 and 366 are coupled to light electrical ends 371a, and 379a of ends 371 and 379.

FIG. 33A shows a side perspective view of another type of reflector system 350 which includes two sets of reflectors 350a and 350b. First reflector set 350a includes a skirt section 351a with a substantially conical shaped reflector 352a extending from the light end, and expanding towards a substantially spherical shaped, or dome shaped reflector 354a. In addition, there is a central connector 356 which connects first reflector set 350a with a second reflector set 350b. Reflector set 350b is substantially identical to reflector set 350a. Therefore, this reflector set 350b includes a skirt 351b, a conical shaped reflector 352b, a dome shaped or spherical shaped reflector 354b coupled to the conical shaped reflector 352b, with these sections coupled to central connector 356. Reflector 352a forms a first reflective section while reflector 354a forms a second reflective section. This second reflective section 354a has across a portion of the shape a greater slope than the first reflective section based upon a longitudinal axis, which extends along a light beam of an associated light. This first reflective section 352a has shape taken from the group comprising or consisting of: substantially conical, sectional conical, frusto-conical, or rounded, or at least has a portion that is, or is at least substantially conical, sectional conical, frusto-conical, or rounded. The second reflective section has a shape taken from the group comprising or consisting of: rounded, spherical, semi-spherical, dome shaped, or a shape having at least one portion that is, or is at least substantially rounded, dome shaped or spherical shaped. As shown in FIGS. 33B and 33C, lights can then be inserted into positions 357a and 357b adjacent to these reflectors 350a and 350b. FIG. 33D shows that each of these reflectors 350a and 350b can be angled offset from each other at a predetermined angle such as at a 30 degree angle offset from each other, an approximately 45 degree angle offset from each other or any other angle necessary to reflect light into a room.

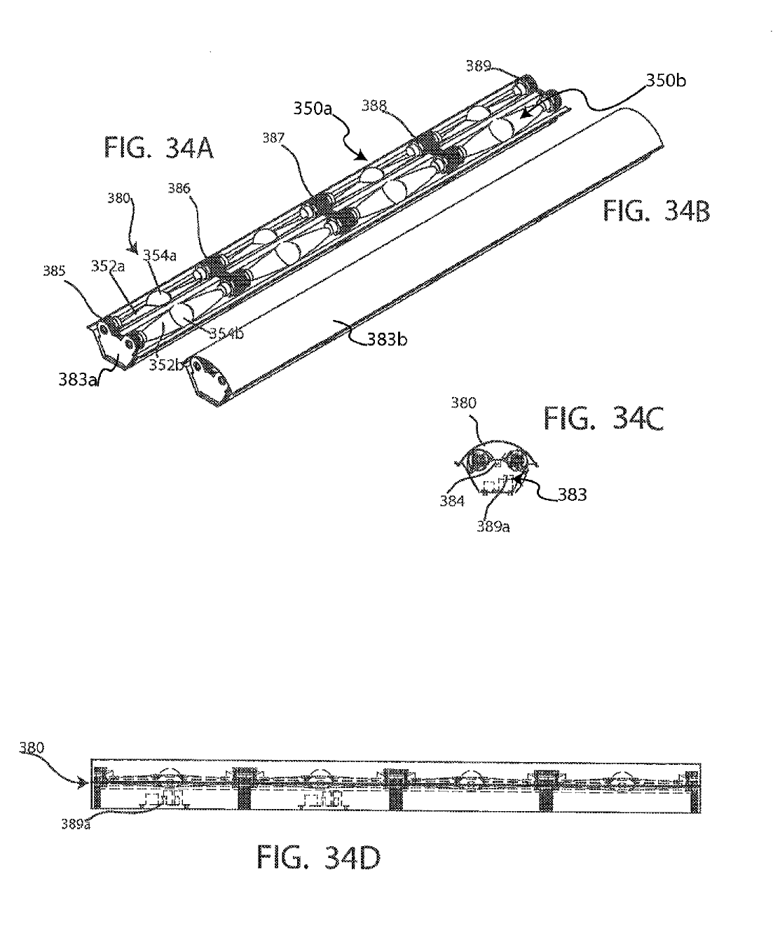

FIG. 34A shows these reflectors 350a and 350b inserted into a housing showing these lights angled offset from each other to produce a uniform light which is extended into a room.

These reflectors can then be covered by a light cover 383b as well.

For example, FIGS. 34A-34D show another embodiment of a light in the form of a substantially cylindrical light 380 having angled sets of reflectors shown in FIGS. 33A-33D. These angled reflectors include a first reflecting section 352a and 352b which is rounded and which has a first section disposed adjacent to a light such as an LED light. There is a second section 354a, and 354b which is also reflective and which is coupled to the first section and which is disposed at a distal end from the first end where the first section is adjacent to the LED light. Second end section is in at least one embodiment a rounded section. In at least one embodiment this section is shaped spherical, semi-spherical, or substantially spherical, with at least a portion of the section having a rounded, dome like, or spherical section. The first section 352a and 352b includes at least one section that is also rounded or substantially rounded and which in at least one embodiment has a shape taken from the group consisting of or comprising: conical, substantially conical, sectional conical, frusto-conical, or rounded. These reflectors are held in place by a body section 383a as shown in FIG. 34C. These reflectors and lights are covered by a translucent or transparent cover 383b. In addition as shown in FIG. 34D, there are electronics 389a disposed beneath reflectors 350a, and 350b as well as contained by body section 383a. These electronics 389a are designed to control whether the light turns on or off and also there are also optional electronics configured to shut the light off if the heat becomes too intense.

FIG. 35 discloses another embodiment 390 which can be in the form of an overhead lamp including a housing 390. This additional embodiment includes a lamp set which includes ends 390a, and 390b. These light sets include reflector sets which each include reflectors 392a, 392b, and 393 forming in at least one embodiment a single reflector having multiple sections. For example, there is a first section which has a first end disposed adjacent to the lights 391a, and 391b, and which has at least one shape taken from the group comprising or consisting of: conical, substantially conical, sectional conical, frusto-conical, or rounded or at least a portion that is or is substantially conical, sectional conical, frusto-conical or rounded. Disposed at an end distal from the first end is a second section which has a shape taken from the group comprising or consisting of: rounded, spherical, semi-spherical, dome shaped, or a shape having at least one portion that is rounded, dome shaped or spherical shaped or at least substantially, rounded, dome shaped or spherical shaped. While this design can be a singular design, in at least one embodiment, this design is repeated in sets 394a, 394b, and 394c and disposed inside of a housing such as housing 395.

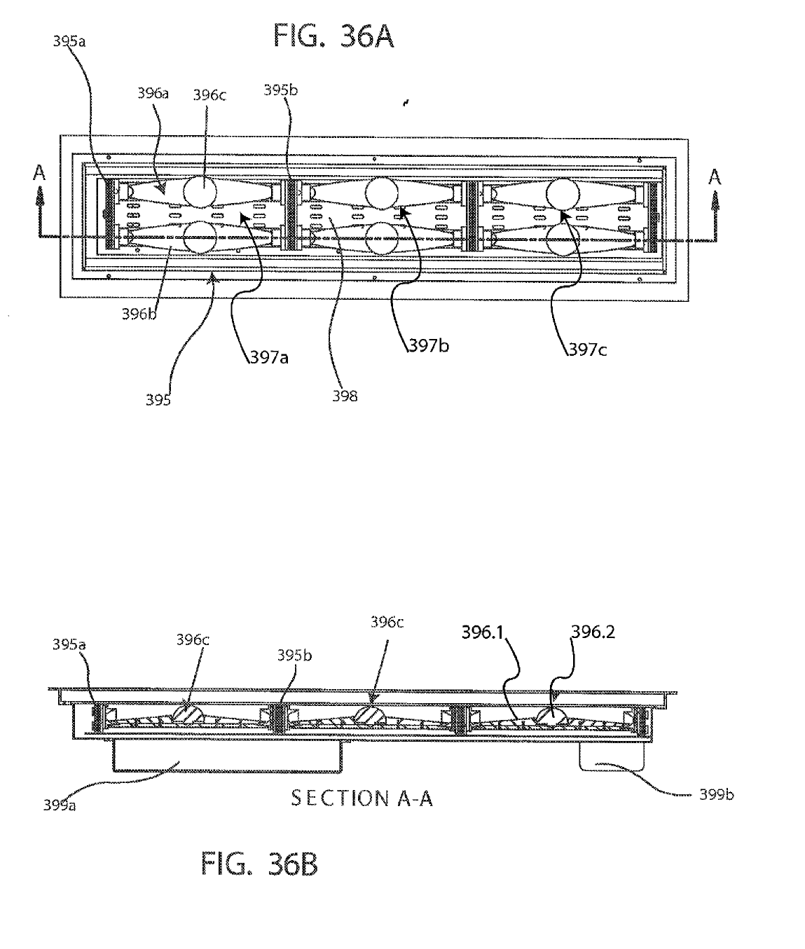

FIG. 36A discloses a top view of another embodiment which is similar to the embodiment shown in FIG. 35. In this view, there is shown another embodiment 395, which includes a first heat sink design 395a, and a second double ended heat sink design 395b. First heat sink design 395a has at least two LED lights and can include a design similar to that shown in FIGS. 22A-22E, 24A, 24B, 27A-27D, and 28A and 28D. With this exemplified embodiment, there are two different reflector sets 396a, and 396b are repeated in different reflector groups 397a, 397b and 397c. Each reflector set such as reflector set 396a, includes a first section 396.1 which has a first end disposed adjacent to the heat sink or light 395a, or 395b and a second end disposed at a distal end and coupled to or adjacent to a second reflector or reflector section 396.2 First reflector section has a shape taken from the group comprising or consisting of, substantially conical, sectional conical, frusto-conical, or rounded, or at least has a portion that is or is at least substantially conical, sectional conical, frusto-conical, or rounded. The second section has a shape taken from the group comprising or consisting of: rounded, spherical, semi-spherical, dome shaped, or a shape having at least one portion that is, or is at least substantially rounded, dome shaped or spherical shaped.

FIG. 36B shows a side cross-sectional view of this design. In this case, this design includes housings 399a, and 399b and houses the above identified reflector sets 341a-343b. FIG. 28C shows the corresponding cross-sectional view. In this view, the spherical reflectors as well as the conical shaped reflectors are spaced separate from each other in a substantially parallel spacing. FIGS. 27 A and 27B however show that the spherical reflector 323 is essentially a combination of two spherical shaped reflectors placed together, with each of the conical shaped reflectors 323, and 322 converging on the combined spherical reflector.

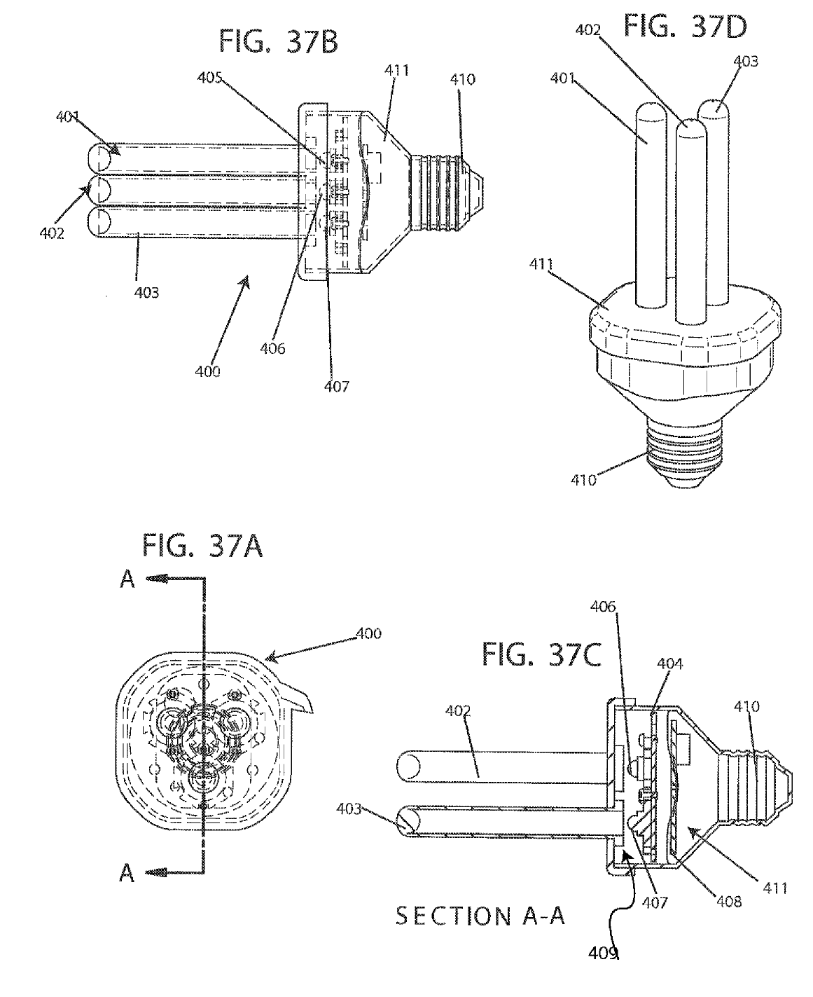

FIG. 37A shows a top view of a light system 400 including three light tubes each associated with a LED light. Each of these light tubes 401, 402, 403 can comprise translucent material which can be in the form of a plastic material or glass or any other type of transparent, semi-transparent or translucent material. Transparent material, allows viewing through the material, translucent allows light through the material while partially or substantially limiting visibility.

An array of lights are positioned on a board 404 as shown in FIG. 37C, this array comprises lights 405, 406, and 407, wherein these lights are orientated so that the corresponding light tubes 401, 402, 403 are positioned with their extending cylinders concentrical with an associated light. For example, tube 401 is concentrical with light 405 while tube 402 is concentrical with light 406 and tube 403 is concentrical with light 407. Board 404 is essentially a circuit board wherein this board is coupled to a power board 408 and stored inside of housing 409 which housed inside of housing 411 and which is associated with connector 410. Connector 410 essentially comprises an electrically conductive connector that functions as a screw on connector. These different features are also shown in FIGS. 37B, 37C and 37D.

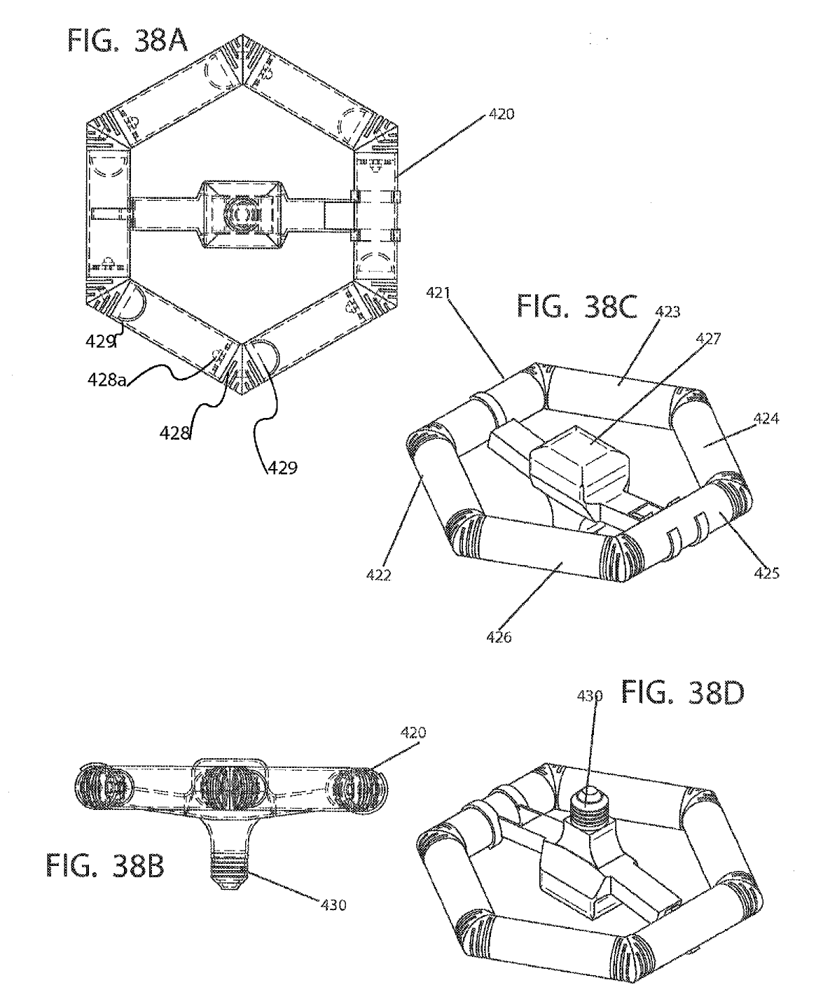

FIG. 38 A shows a top view of another embodiment 420 which comprises a six sided shaped light component comprising sections 421, 422, 423, 424, 425, and 426. There is also a central light 427 which contains an array of lights therein as well. In addition, there is a connector 430 which is essentially a screw-on connector for connecting the light to a lamp. The different views of this embodiment 420 shown in FIGS. 38B, 38C and 38D show a lighting device having a heat sink 428 having a light 428a and an opposite reflector for each section

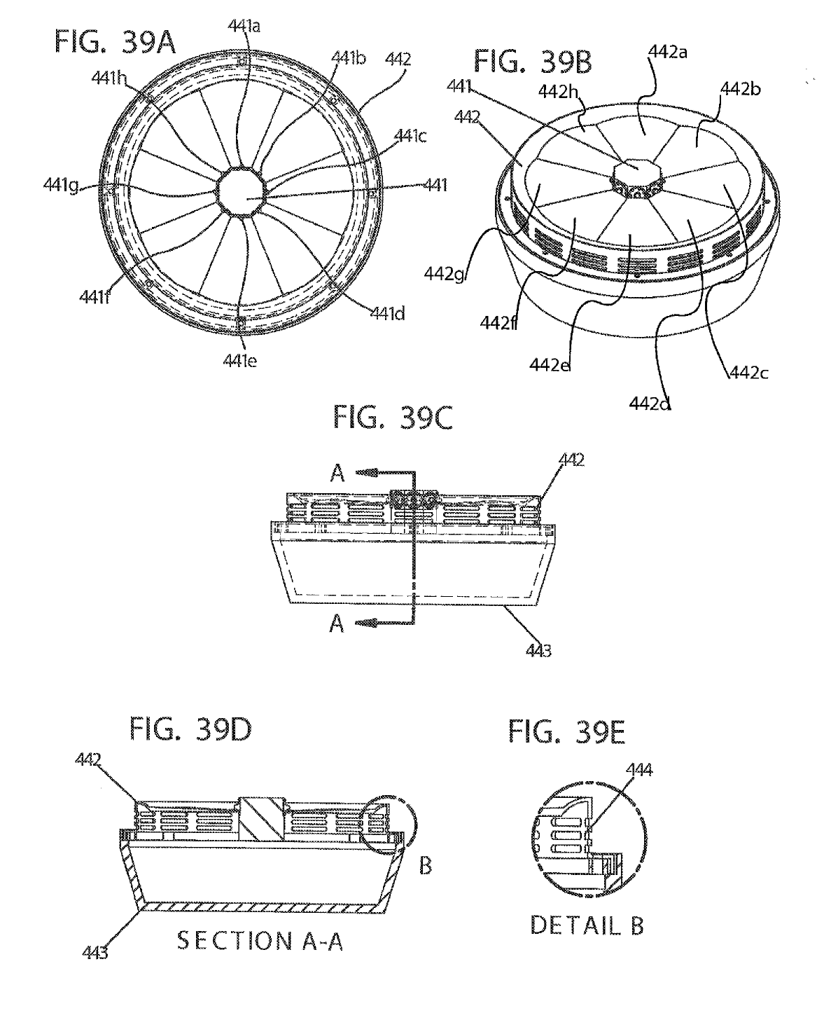

FIG. 39A is a top view of another embodiment which shows a substantially round design comprising an outer cover 442, including a central light fixture 441, comprising an array of lights including lights 441a, 441b, 441c, 441d, 441e, 441f, 441g, and 441h. There is also a frusto-conical shaped cover 443 (See FIG. 39C) which essentially comprises a translucent material such as clear or frosted plastic, or glass. In addition, cover 442 having associated reflective surfaces adjacent to each light such as reflective surfaces 442a, 442b, 442c, 442d, 442e, 442f, 442g, and 442h (See FIG. 39B), is coupled to back cover 443, wherein this cover comprises a plurality of openings 444 (See FIG. 39E), which allows air to vent in and out of the cover.

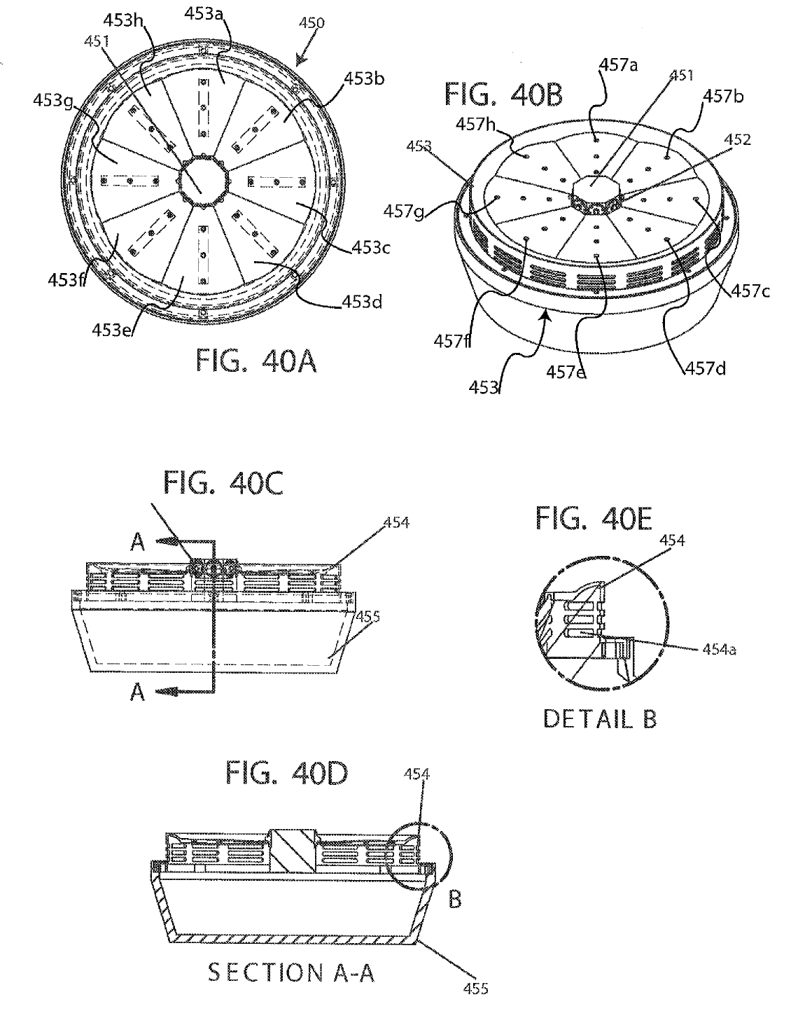

FIGS. 40A and 40B discloses a top view which shows a substantially circular shaped device which includes a central light fixture, comprising a plurality of lights 452 wherein this lights 452 are coupled to a heat sink 451 and housed inside a housing 453. This housing 453, includes a heat sink 454, and a cover 455. Heat sink 454 includes vents 454a shown in detail B. (See FIG. 40E). FIGS. 40B, 40C and 40D show different views of this type of embodiment. In this embodiment, there are also different reflective arrays 453a, 453b, 453c, 453d, 453e, 453f, 453g, and 453h, each having its own separate light array 457a, 457b, 457c, 457d, 457e, 457f, 457g, 457h, wherein this light array comprises LED lights which shine through corresponding holes in the cover.

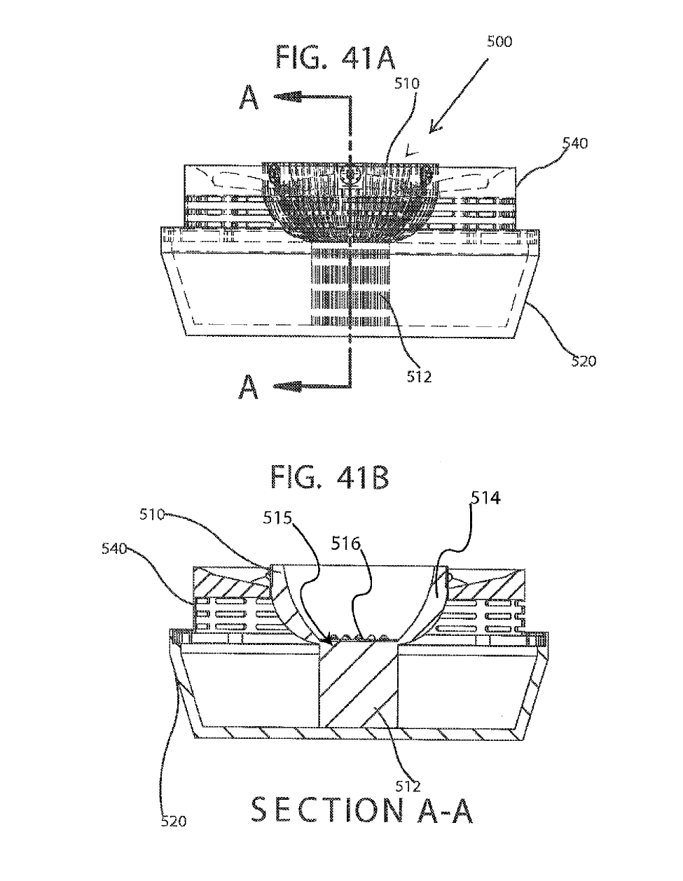

FIG. 41A discloses another embodiment which includes a substantially circular light design 500 comprising a heat sink 510 having a base section 512, an extended section, and a cover 520. The second heat sink forms a stem or base, while the first heat sink 510 is in the form of a bowl. The light fixture is essentially in the form of a bulb which comprises a base section 512, an extended section 514, an array section 515, comprising a plurality of lights 516. FIG. 41B shows a side cross-sectional view of this device as well. This view shows cover 540 having vents as well as cover 520 and

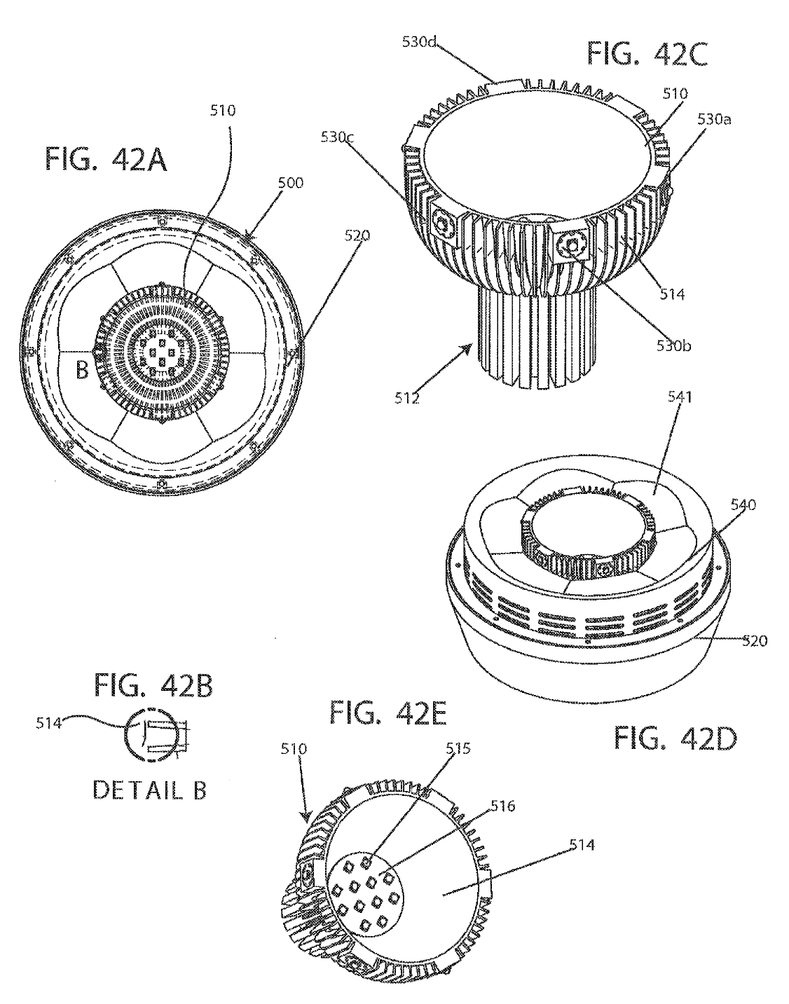

FIGS. 42A-42D show this embodiment in greater detail which shows another light embodiment 500 which includes a light central housing 510 and an outer housing 540. As shown in FIG. 42D, this central housing 510 includes a base section 512 and a body section having a plurality of fins 514 shown in FIG. 39B which is a top view of detail B of FIG. 42A. As shown in FIG. 42C are a plurality of lights, 530a, 530b, 530c, and 530d coupled to this body section 510. These lights can be in the form of LED lights.

FIG. 42D shows an encasement 540 including a flower petal style section comprising a plurality of reflective petal style reflectors 541. FIG. 42E shows a top perspective view of the light central housing 510, which includes a board 515 which can be in the form of a circuit board, and which receives a plurality of lights 516 such as LED lights. There is also an inner reflector 514 positioned on an inner portion of housing 510, which is configured to reflect the light created from lights 516.

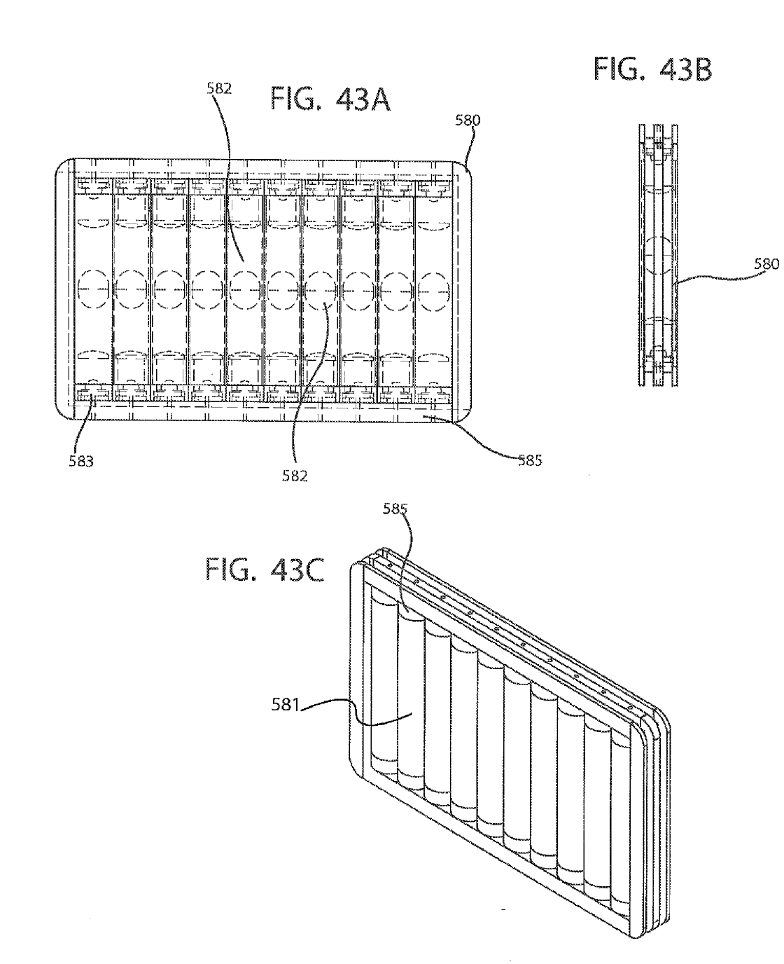

FIG. 43A shows a side view of another embodiment which shows a series or a plurality of different light tubes 581 each comprising a translucent/transparent tube which can be made from any suitable material such as glass or plastic. This light tube can either be clear or frosted and contain therein a plurality of substantially conical shaped reflectors as well, such as those shown in wherein these spherical reflectors are configured to reflect light which is sent internally in the tube from each end. The spherical reflectors can be used along with conical shaped reflectors wherein these reflectors are coupled to the spherical shaped reflectors as shown previously. This embodiment is also shown in a side view in FIG. 43B and a perspective view in FIG. 43C.

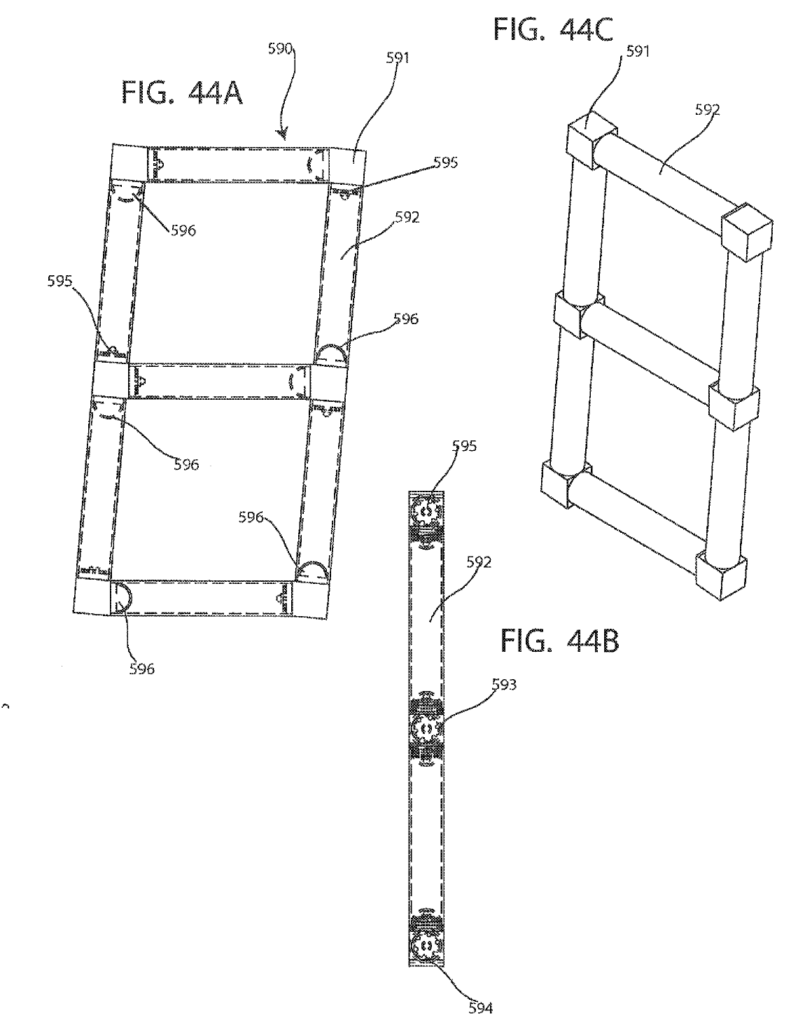

FIG. 44A shows another embodiment which discloses a trapezoidal shaped design 590 having a plurality of end pieces 591 and a plurality of tubes 592 coupled to these end pieces. These end pieces 591 function as elbows wherein these end pieces are configured to send light in two directions. In addition FIG. 44B shows a side view which shows an end piece 591 as well as a tube 592 and another intermediate piece 593, as well as another end piece 594. FIG. 44C shows a side perspective view which shows an end piece 591 as well as a central tube 592. The end piece can either be coupled to a light 595 or to a reflector 596.

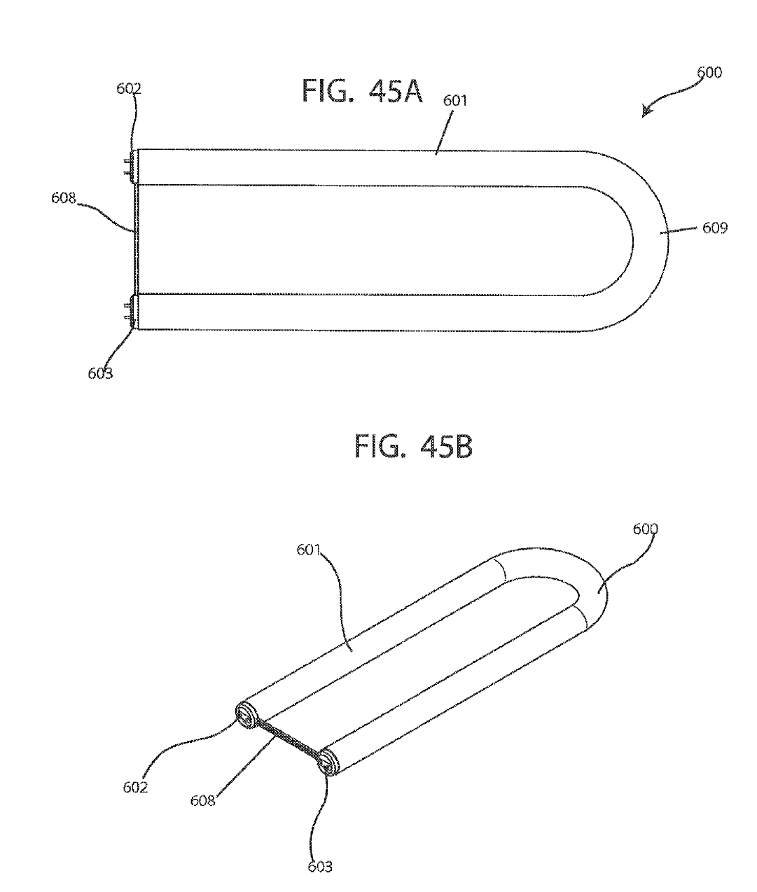

FIG. 45A shows a side view of another embodiment 600 comprising a curved light comprising a straight section 601, an end piece 602, another end piece 603 and a central tie section 608. There is also a curved section 609 which is in the form of a reflective bend for reflecting the light presented from ends 602 and 603. Ends 602 and 603 are configured to house lights such as lights 362 such as those shown in FIG. 23. In addition FIG. 45B shows a perspective view of this type of light. Any other type of light, lens, reflector, and heat sink combination can be used as well such as that shown in FIG. 26A.

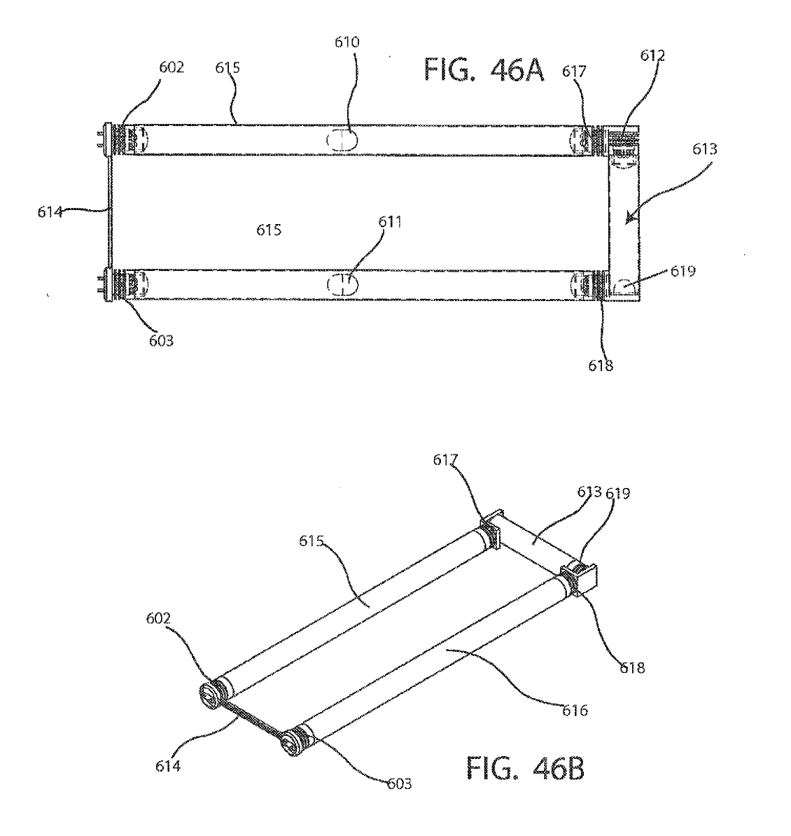

Furthermore, FIG. 46A shows a side cross-sectional view of a substantially rectangular light device 610 comprising end pieces 602, and 603 which include lights as described above. This light device also includes, central reflectors 610 and 611, end lights 617 and 618, as well as an end light section 613 which comprises a light 612 a light tube and a light reflector 619. Light tube or section 613 is substantially shorter than light tubes 615 and 616. Light reflector 619 comprises a substantially or partially spherical reflector which is mounted on a back wall and which is configured to reflect light. The perspective view of this light is shown in FIG. 45 which shows light tube 616 as well. A perspective view is also shown in FIG. 46B.

With this design, individual or multiple LED lights can be used in combination with a substantially or entirely spherical reflector 610, and 611 to provide light throughout the tube. The tube can be coated with any light refracting or altering material to provide a tint to the light as well. Each of the tubes or covers shown above can also be coated with light altering material to alter the perceptible view of the light created either within the tube or from the tube.

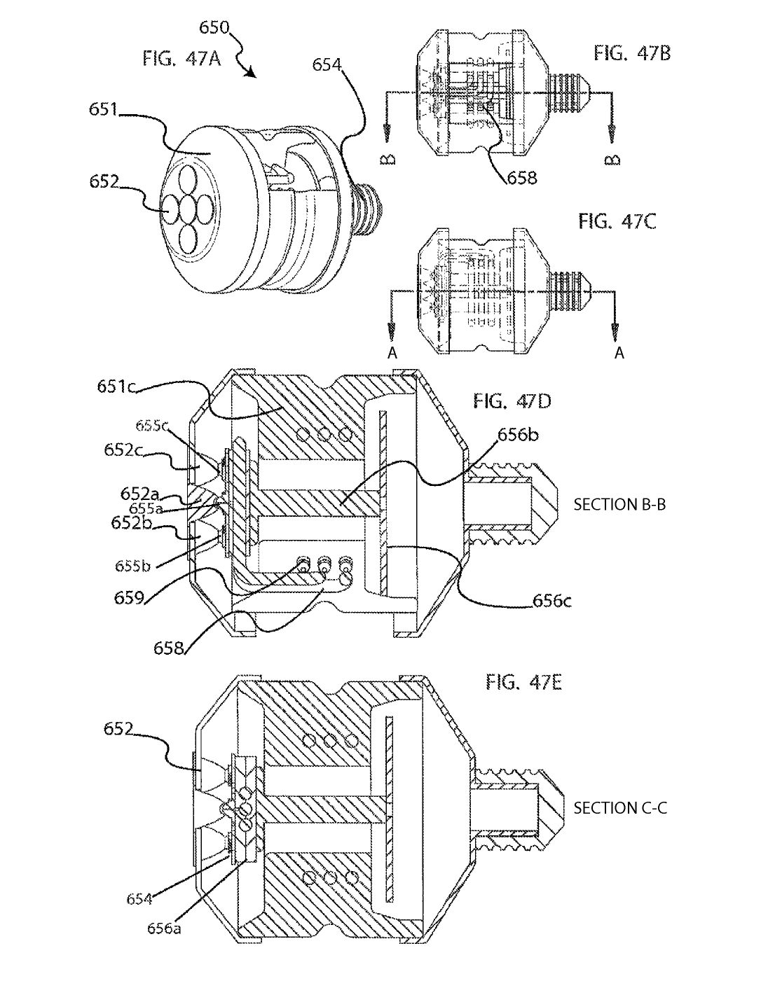

FIG. 47 A shows a perspective view of another design 650 which includes a screw in light bulb type design which includes a series of lights 652 disposed inside of a housing 651. There is a base stem 654 which is configured to screw into a light socket. FIG. 47B shows a cross-sectional view which shows light pipes 658 which feed into a cooling body 653 shown in FIG. 47D. FIG. 47D is a cross-sectional view taken along the line A-A shown in FIG. 47C. In FIG. 47D there is shown a cooling body 653 forming a portion of the housing wherein this view shows lenses 652a which are the same or substantially similar to lenses 320b, wherein each lens is associated with a light such as a LED light 655a, 655b, and 655c. These lights 655a, 655b, and 655c are mounted on a circuit board 656, which is cooled by heat pipes 658. These heat pipes are shaped differently but are otherwise essentially designed similar or the same as heat pipe 324 shown in FIGS. 27 A, 28B, and 28E. This design creates a screw in LED based light which has sufficient cooling in the form of a heat sink body disposed in a region disposed offset from the position of the LED light. This design allows for greater cooling which allows for lights to be powered in a more intense manner creating a more efficient lighting system.

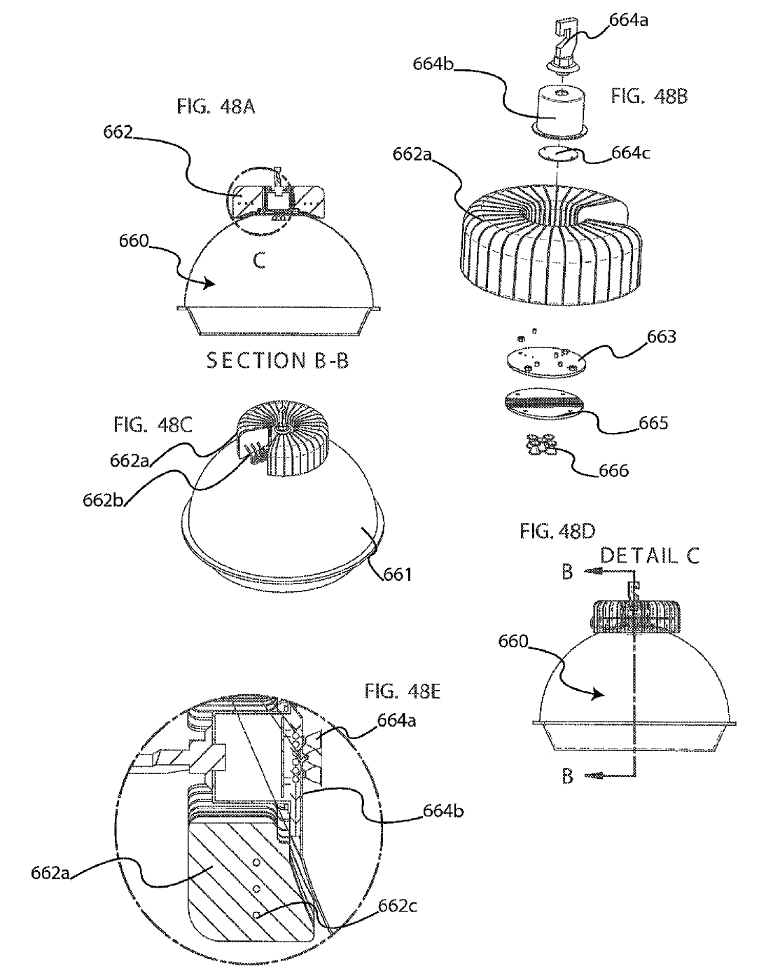

FIGS. 48A-48E show different views of another embodiment of a dome shaped light 660. In this view, this embodiment 660 includes a body section 661; a cylindrical shaped heat sink 662 coupled to the body section 661. There is also a heat sink base 663 which is coupled to heat sink 662 (See FIG. 48B). As shown in FIG. 48C there are a plurality of fins 662a, and a plurality of heat pipes 662b extending or snaking through a body section of fins 662a or holes 662c in fins 662a. The fins 662a extend in a radial pattern along a backside face of this dome shaped housing 661. There is also a coupler 664, include a first hook section 664a, a second body section 664b, and a coupling block 664c. This coupler 664 is attached to dome housing 661 in any known manner, and inside of radially extending heat fins 662a. Heat sink body section 663 is coupled to a circuit board 665 which supports at least one or at least an array of lights and lenses 666. These lights and lenses can be in the form of a light/lens design similar to that of light/lens design 320a, and 320b of FIG. 27D.

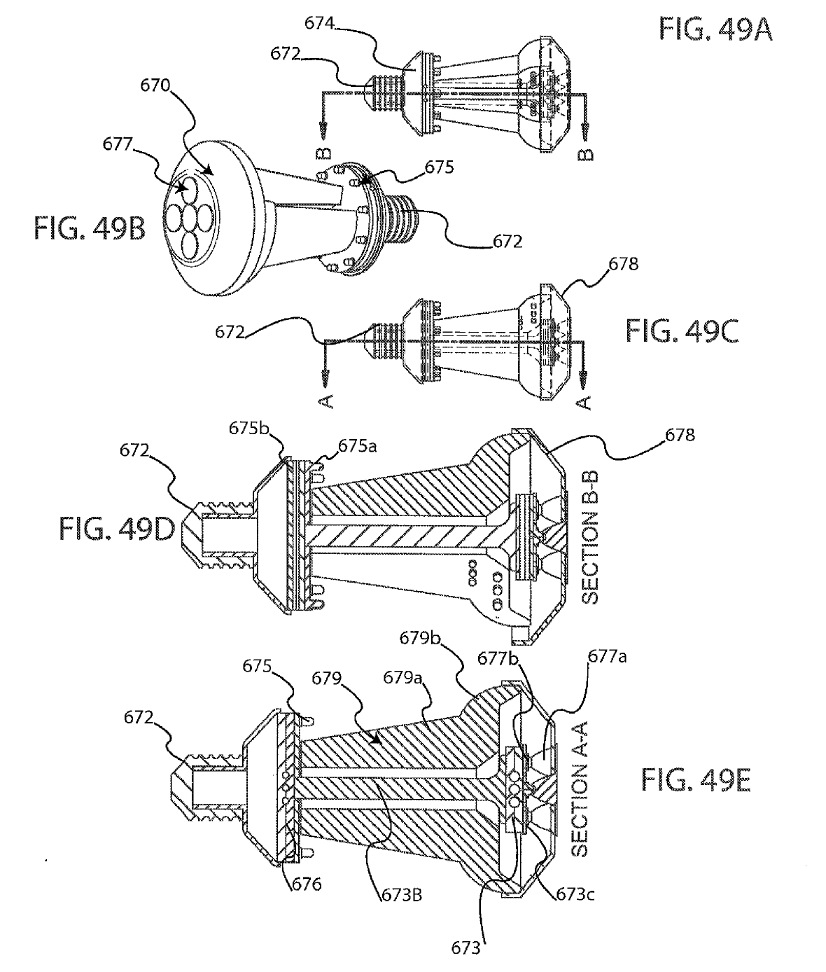

FIG. 49A-49E shows another embodiment. In this embodiment 670, as shown in FIG. 49B there is at least one or a plurality of lights 677 and another set of at least one or a plurality of lights 675. First set of lights 677 includes a lens 677a, and an associated LED 677b similar to the light/lens design 320a and 320b shown in FIG. 27D. This design is coupled to a circuit board 677c which is coupled to a heat sink 673 which includes heat sink body 673a and light pipes 673b. This heat sink also extends to heat sink body 673c. Second set of at least one light/lights 675 is coupled to a circuit board/heat sink sandwich 676 which is similar or the same as shown with heat sink 673/circuit board sandwich 673c. Heat sink body 673c is coupled to this second heat sink 673b as well. In this case, heat sink 673b bridges between heat sink sandwich 676 and 673. Each of these heat sinks has venting holes which can be configured to receive heat pipes. There is also a translucent cover 678 shown in FIGS. 48C, 48D and 48E, as well as an elongated reflective surface 679 which has a first reflective section having a first end disposed adjacent to a LED light such as LED light 675, and a second distal end. There is also a second reflective section which is coupled to the second end. The first reflective section 679a shape taken from the group comprising or consisting of, a substantially conical, sectional conical, frusto-conical, or rounded, or at least has a portion that is substantially conical, sectional conical, frusto-conical, or rounded.

The second reflective section 679b a shape taken from the group comprising or consisting of: rounded, spherical, semi-spherical, dome shaped, or a shape having at least one portion that is rounded, dome shaped or spherical shaped.

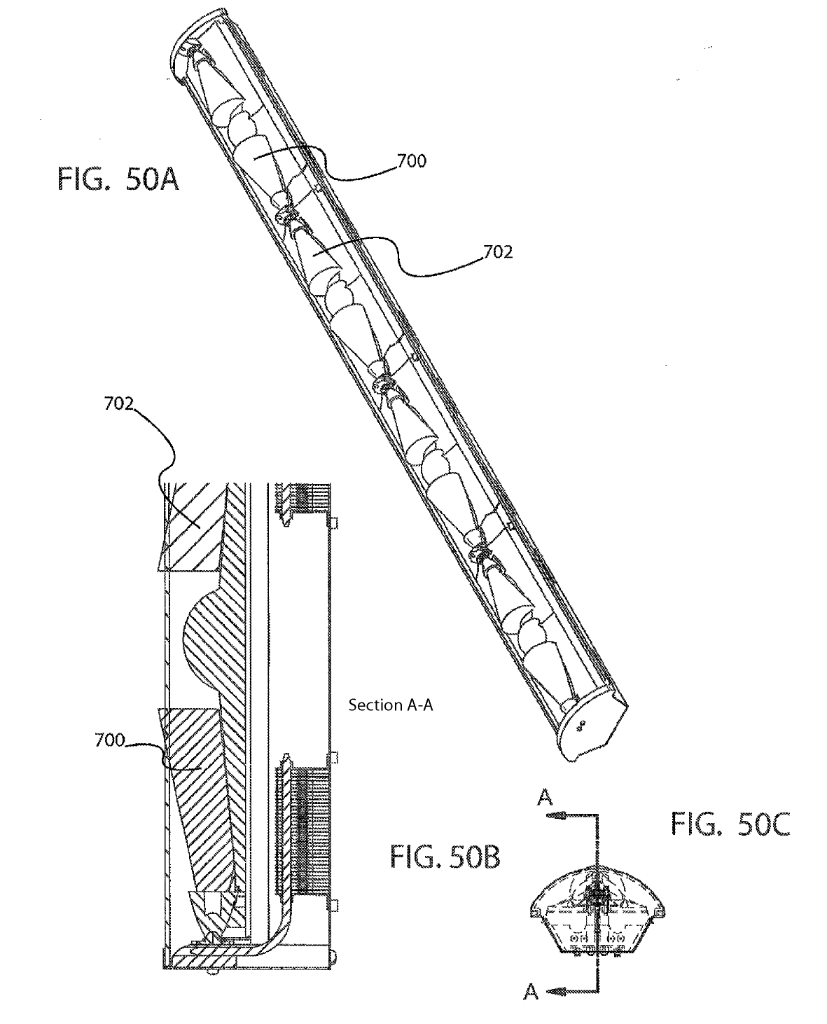

FIG. 50A shows a perspective view of a light array such as that shown in FIGS. 26A-26E. This view shows a first reflective pattern formed on this type of lens/reflector system, wherein there is shown emitted light band 700 which is emitted from a lens such as lens 320b. In addition there is another light band or light pattern 702 which is shown being emitted from lens 320b as well. FIG. 50B shows this light pattern in a cross sectional view taken along the line A-A shown in FIG. 50C.

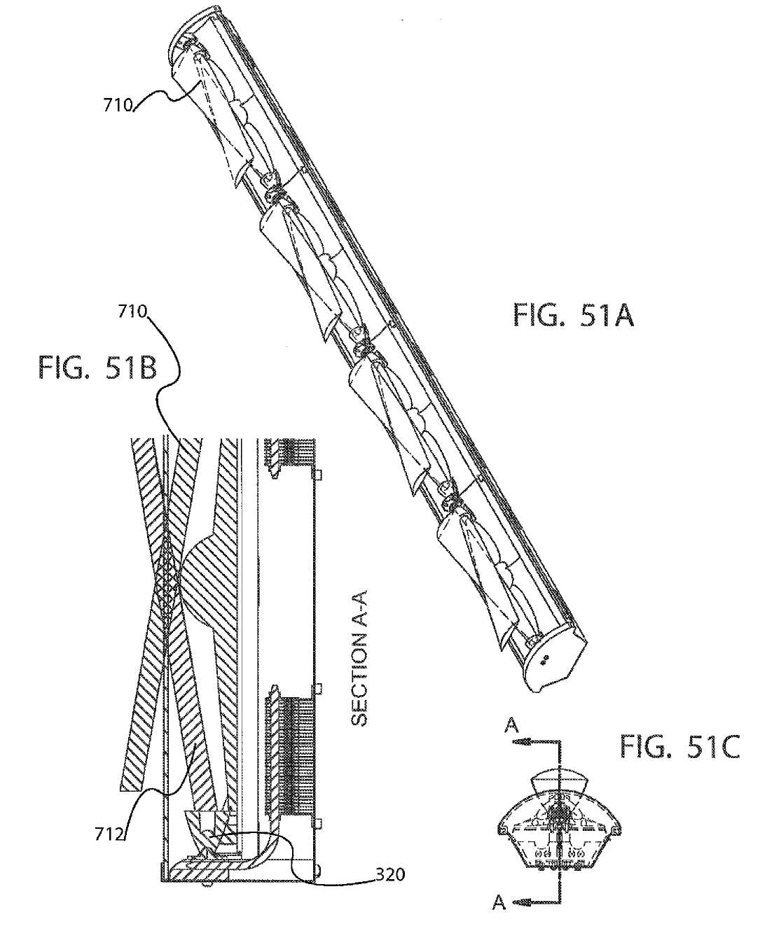

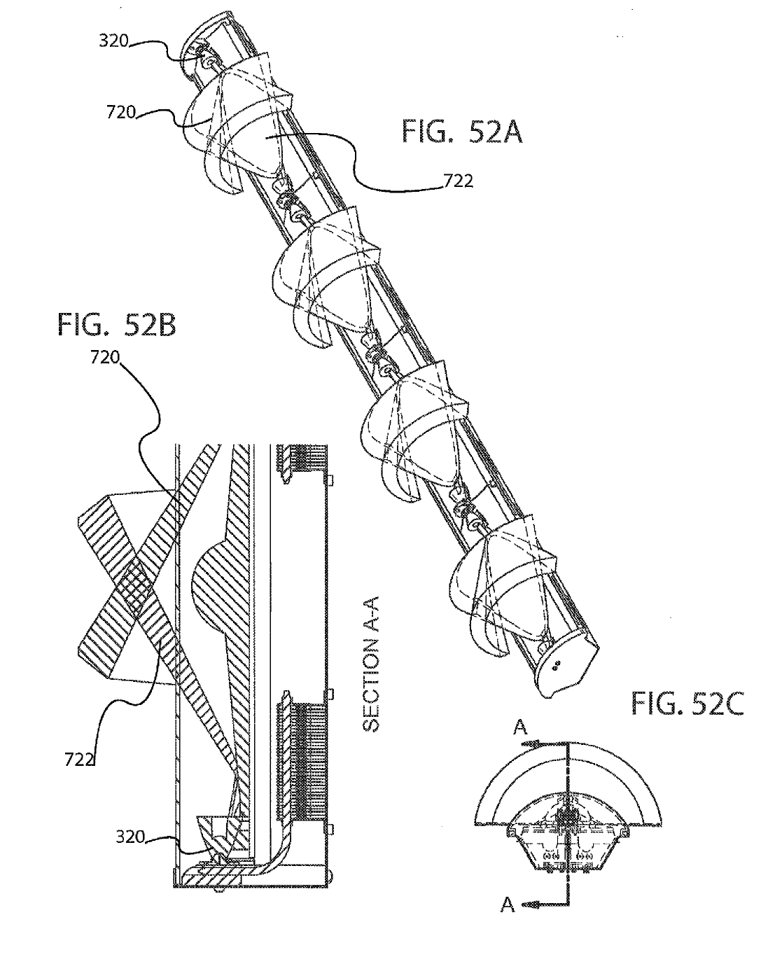

FIG. 51A-51C shows another view of another light pattern formed from the design shown in FIG. 50A. This light pattern shows an emitted light band 710 which is emitted from a lens such as lens 320b. Another light pattern, or light band is also shown 712 which is substantially similar to light band or pattern 710 and which crosses over this light pattern at a region adjacent to the second reflector section or portion such as second reflector portion 344 shown in FIG. 26E. FIG. 52A-52C shows another view of another light pattern formed from the design shown in FIG. 50 A. This light pattern shows an emitted light pattern 720 which is reflected off of a first reflective portion or section such as portion or section 342 shown in FIG. 29D, or reflective portion or section 352a shown in FIG. 33A. Another section could be first section 210 shown in FIG. 19.

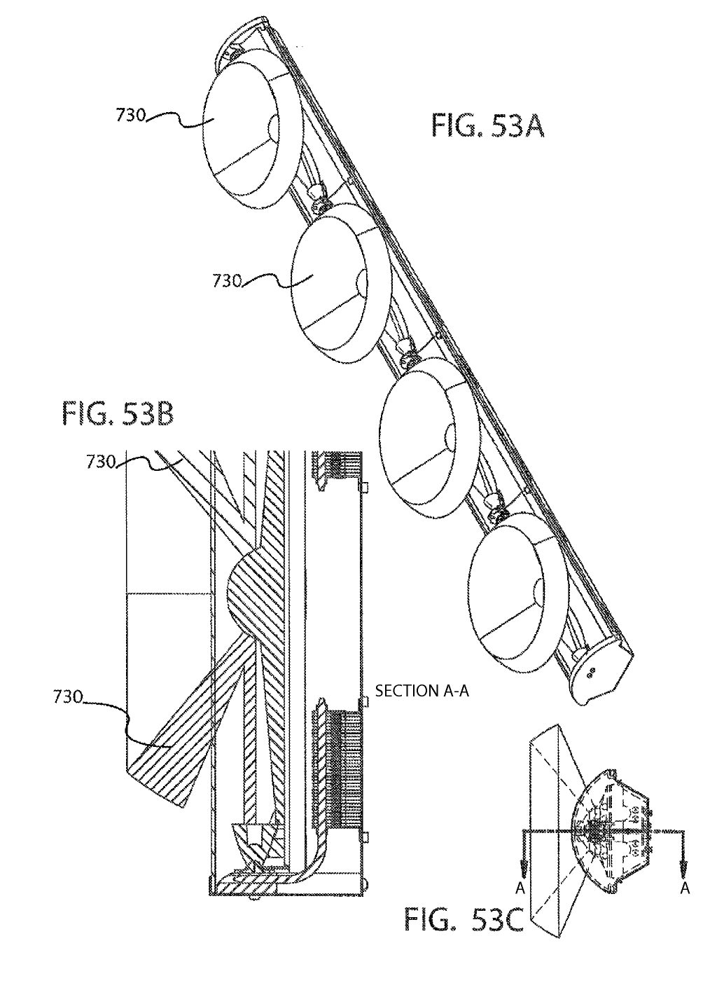

FIG. 53A-53C shows another reflective band such as reflective band 730 which is emitted from a lens such as lens 320b and which is reflected off of a second reflective section such as reflective section 211, 368, 344, 344a, 354b, 396b etc.

Unless otherwise specified, the heat sink/light combinations along with the lens designs, and the reflector designs can be used interchangeably.

For example, the heat sink/light combinations can be used with any other different type of reflector combination specified above. For example, any one of the LED light/heat sink combination shown in FIG. 1 A, 2B, 3C, 5B, 5C, 6A, 6B, 7C, 8A 9A, 9D, 10A, 11 A, 12A-12D, 13A,13B, 14A, 18A, 19, 21A-21D, 22A-22E, 23, 24A, 24B, 25A-25D, 26A-26E, 27A-27E, 28A-28E; 32A-32D; 34A-34D; 35, 36A-36B, 37A-37D; 38A-38D; 39A-39E; 40A-40E; 41A-41B; 42A-42E; 43A-43C; 44A-44C; 45A-45B; 46A-46B; 47A-47E; 48A-48E; 49A-49E can be used with the other reflector or lens embodiments disclosed above.

In addition, the different types of lenses can be used with any other different types of heat/sink combinations/reflector combinations specified above such as that shown in FIG. 1A, 5B,9D, 12C, 12D; 13B; 14A; FIG. 19; FIG. 23; 24A-24B; 26A-26E; 27A-27E; 28A-28D; 30A-30D; 37A-37D; 47A-47E; 48A-48E; 49A-49E can are interchangeable with the other heat sink light designs, or reflector designs.

In addition the different types of reflectors such as the reflectors shown in FIGS. 1C, 2B, 3A; 6B; 7B; 8B, 8C; 9A-9C; 9D; 10A; 11A; 12D; 13B; 18C; 19; 20A-20D; 23; 29A-29E; 31B; 32D; 33A-33D; 35; 36A; 38A-38D; 39A-39E; 40A-40D; 41A-41B; 43A-43C; 44A-44C; 45A-45B; 46A-46B; 47A-47E; 48A-48E; 49A-49E; are interchangeable with the other heat sink light designs, or lens designs disclosed above.

In all, the above designs are configured to reduce the number of LED lights required while providing a space saving cooling structure, which utilizes reflectors to create an omnidirectional, substantially omnidirectional or uniform, or substantially uniform pattern of light. One benefit, is to provide an efficient means or design to create a substantially even or even viewable light pattern, with no, or minimal dead reflective spots.

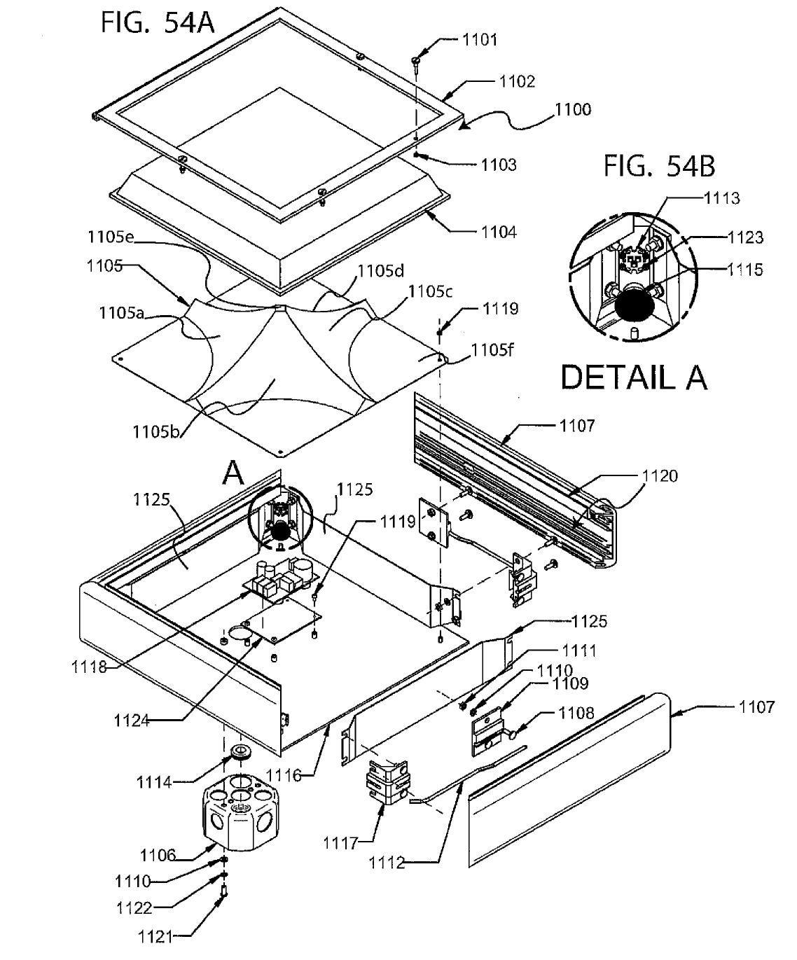

FIG. 54A is a front perspective exploded view of another embodiment of the invention, wherein in this view, there is shown a new embodiment 1100 which includes a light having a clamping screw 1101, a plate 1102 which is screwed or otherwise coupled to a body 1107 which comprises a heat sink The body can comprise a metal or other type of conductive material which serves as a body to house the lights and heat sinks. A diffuser 1104 forms a cover which covers over one face of this body. This diffuser is clamped by plate 1102 to body 1107. Plate 1102 is held in place on body 1107 via a screw 1101 and a retaining washer 1103. A reflector 1105 is positioned inside body 1107 wherein this reflector is formed as a substantially pyramid shaped reflector which includes four sides 1105a, 1105b, 1105c, and 1105d as well as a point or peak 1105e. Each of these sides could be of any suitable shape but in this case has a parabolic reflective surface that gradually increases in slope towards center point 1105e. Each of these sides could be characterized as [¼] parabolic shaped section because each side is parabolic and concave, forming a substantially pyramid shaped reflector. In addition, four different secondary reflectors 1125, are mounted in front of each housing wall 1107. There is also a base plate reflector 1105f which is also made from reflective material. A junction box 1106 is coupled to a back end of the device via a grommet 1114 as well as a screw 1121, a lock washer 1122, flat washer 1110, wherein this junction box is configured to connect to electrical wiring to receive power from a power distribution line. The housing 1107 includes tracks 1120 which are configured to receive the transfer heat from a heat pipe 1112, and expels the received heat transfer into the atmosphere. Therefore, there are fixation components including a bolt 1108, a plate 1109, a locking washer 1110 and a nut 1111 which are configured to fix the device including the heat pipe 1112 to the heat sink or body 1107.

A circuit board 1113 (See detail A) is coupled to each corner of housing 1107. This circuit board is coupled to an associated heat sink 1117 which is coupled to heat pipe 1112. Heat from LED circuit board 1113 is sent to heat sink 1117 and then drawn from heat sink 1117 to heat pipe 1112 and then dissipated into housing 1107. LED Circuit board 1113 includes LED lights, and is coupled to a lens 1115 via a screw 1123. An electrical LED driver (with dimming capabilities and other features) board 1118 is coupled to heat sink housing 1107 via a plurality of screws 1119 and a plate 1124. This design creates a uniform light distribution pattern with four separate LED circuit boards 1113 positioned at each corner of a rectangular or substantially square housing.

FIG. 54B is a sectional view of the embodiment shown in FIG. 54A;

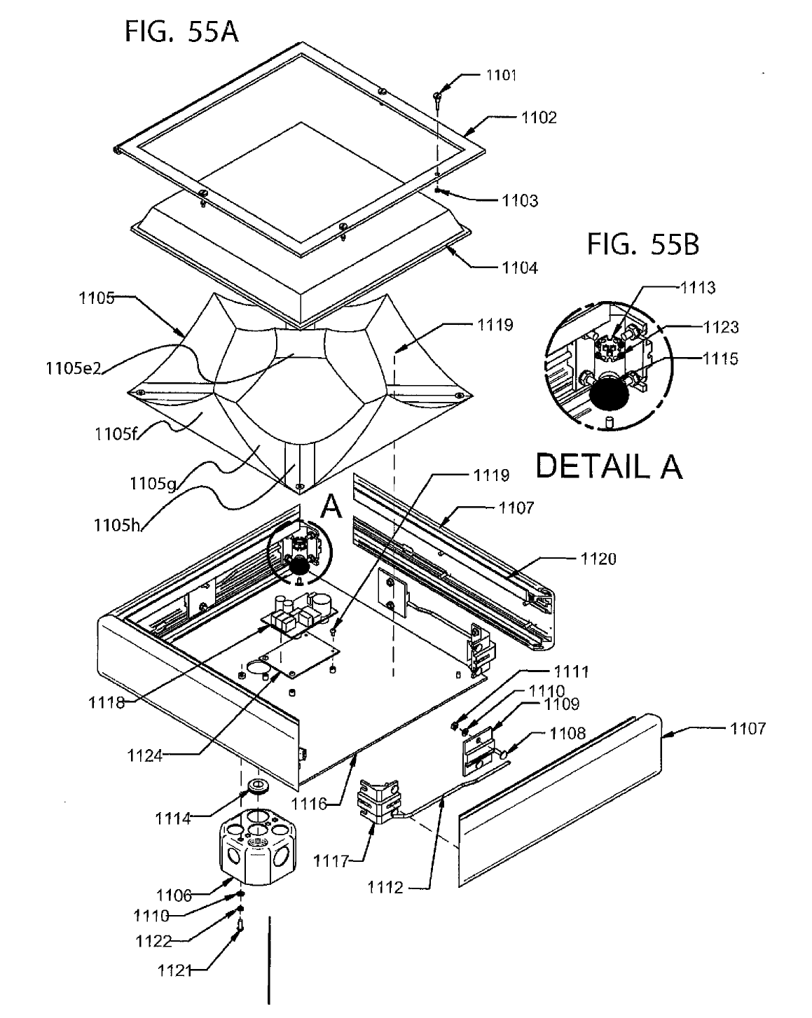

FIG. 55A is a front perspective exploded view of another embodiment which is similar to the embodiment of FIG. 54A, however, this design shows a different shape for reflector 1105 which includes a flatter top 1105e2. FIG. 55B is a sectional view of the embodiment shown in FIG. 55 A. In addition, the reflector also includes additional raised section 1105f as well as additional reflective portions 1105g and 1105h. Reflective portion 1105g is sloped up to create another parabolic shaped reflective surface to channel the light from the LED circuit board to the reflective surface.

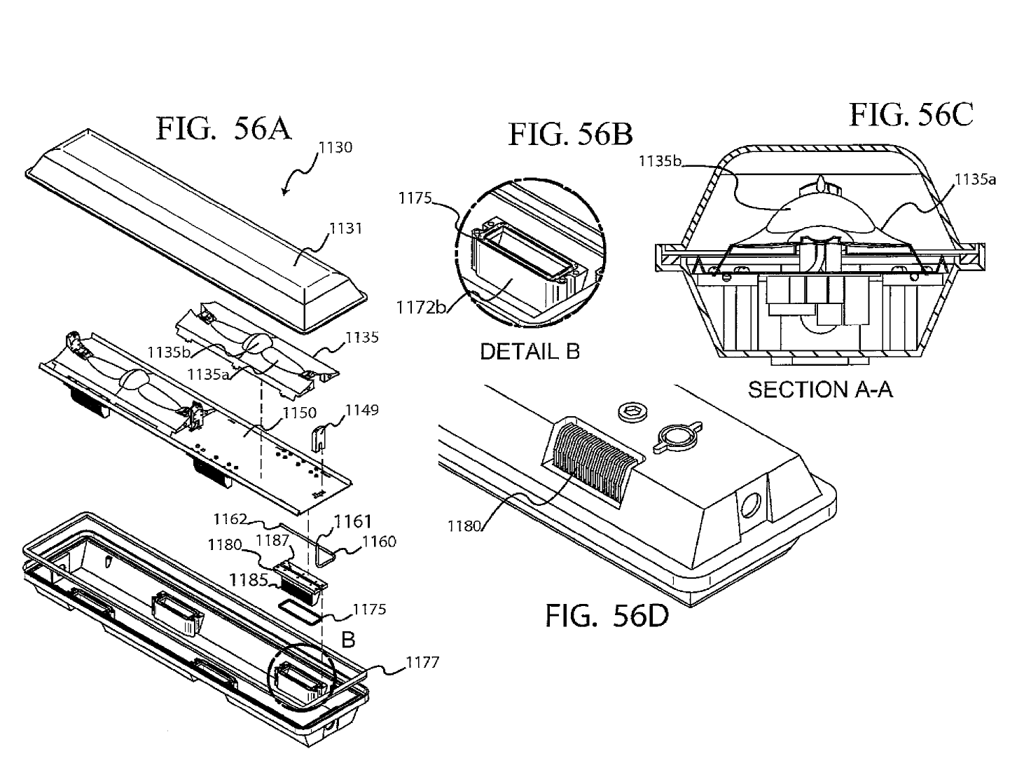

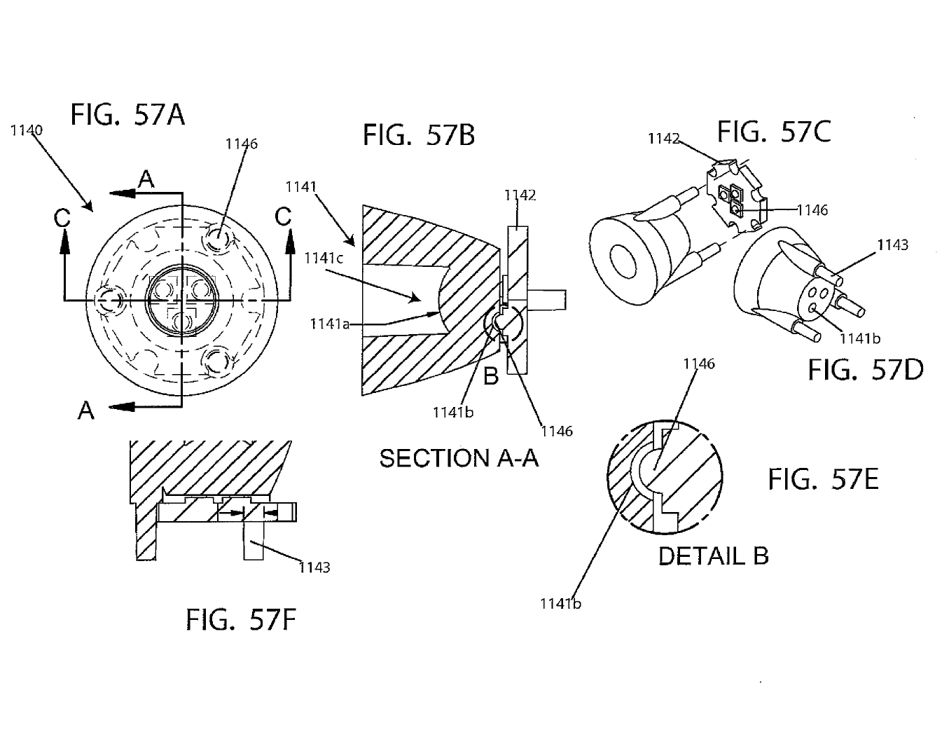

FIG. 56A is a perspective, exploded view of another embodiment, which is an outdoor lighting component 1130 which includes a cover or diffuser 1131, an inside reflector 1135, a LED configuration 1140 (See FIG. 57A), a heat sink stand 1149 coupled to a base or gear tray 1150, a heat pipe 1160, a base tray 1170, and a heat sink 1180. Heat pipe 1160 is coupled to both heat sink stand 1149 and to heat sink 1180. FIG. 54B is a sectional view taken from section B which shows housing 1172b which is disposed in base tray 1170. Disposed inside of this housing is a gasket 1175 which can be made from a flexible material such as a rubber or polymer type material. FIG. 56C is a side cross-sectional view of this embodiment showing reflector 1135 having a first reflective section 1135a and a second reflective section 1135b. First reflective section 1135a has a lower slope relative to second reflective section 1135b. In addition, there are two different gaskets, a first gasket 1175 for sealing housing 1172 with heat sink 1180, as well as a second gasket 1177 for sealing housing 1170 with diffuser 1131. FIG. 56C is a side view perspective sectional view of a portion of the device shown in FIG. 56A which shows reflector 1135 having a first section 1135a and a second section which has a different shape 1135b. First section 1135a is frusto-conically shaped, while second section 1135b is substantially spherically shaped and has a more steep slope than the first section. FIG. 56D is another view of the device in an assembled condition, which includes a back view showing heat sink 1180 coupled to housing 1131.

FIG. 57A is a front view of a lens 1141 used in any one of the above embodiments and which is part of the heat sink and LED configuration 1140. This configuration is similar to or the same as the configuration of LED circuit board 1113 and lens 1115. Lens 1141 is frusto-conically shaped and includes an inner rounded section 1141a, (FIG. 57B) disposed in a substantially central region, and also includes a hollowed out substantially central section 1141c as well as at least one indented interface 1141b for receiving a LED light 1146. A circuit board 1142 includes three LED lights 1146 and is configured to attach to lens 1141 via attachment arms 1143. FIG. 57B is a side cross-sectional view of the lens of FIG. 57A taken along section A-A; while FIG. 57C is an exploded perspective view of the lens with an associated circuit board; FIG. 57D is a back view of the lens showing indents 1141b and legs 1143, while FIG. 57E is a side cross-sectional, sectional view of the lens, LED interface taken in section B; FIG. 57F is a side cross-sectional view of the device taken along section C-C.

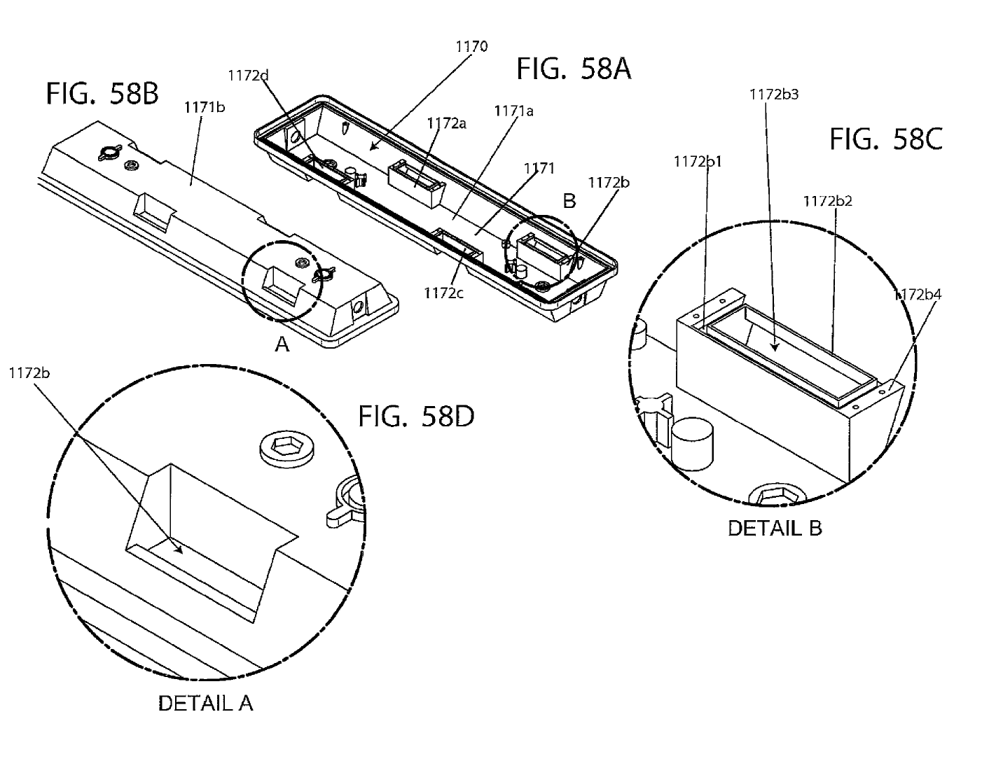

FIG. 58 A is a back perspective view of the housing shown in FIG. 56A. In this view there is a housing 1170 having a back plate 1171 including a front face 1171a, a back face 1171b (FIG. 58B). There are also a plurality of heat sink openings or housings 1172a, 1172b, 1172c and 1172d. These heat sink openings include a gasket opening 1172b1 (FIG. 58B), for receiving a gasket 1175 which is used to seal the heat sink therein to keep the unit substantially water tight. There is also a gasket rim 1172b2 as well as an opening 1172b3 for allowing the heat sink to extend therethrough (See FIG. 58D). This housing 1172b also includes housing walls 1172b4 which surround the heat sink These components shown in FIG. 58C are also present in the other housings 1172a, 1172c, and 1172d.

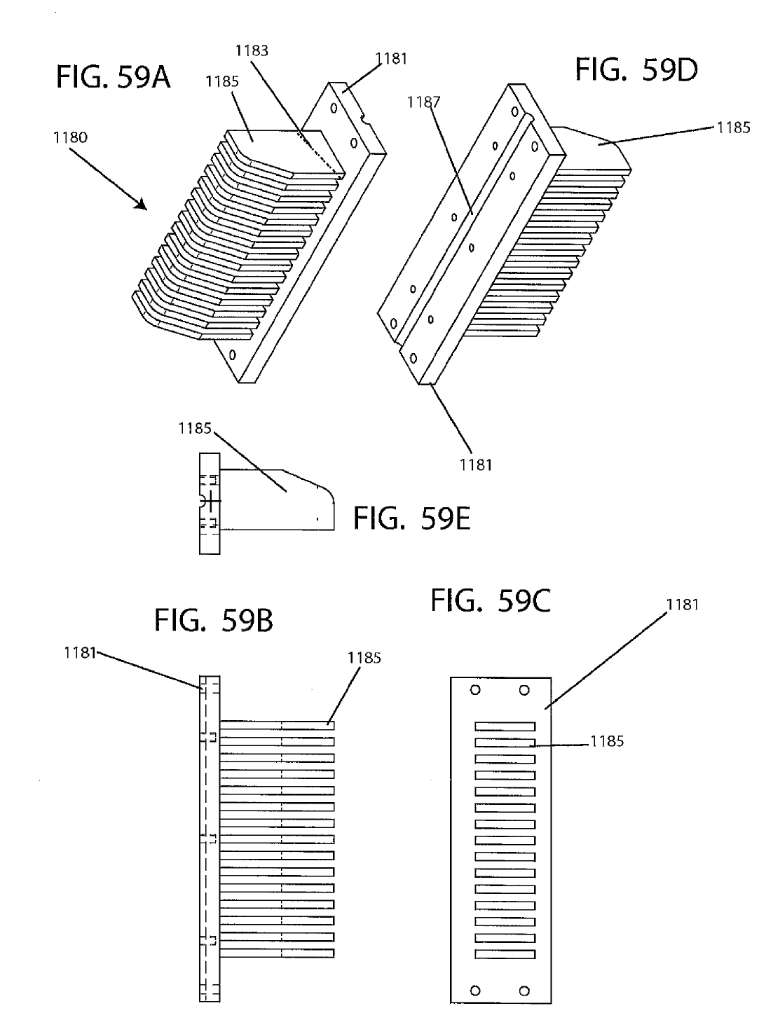

FIG. 59A is a perspective view of a heat sink 1180 which includes a base plate 1181, fins 1185, and an inner sloped surface 1183 (dash dotted line) allowing water to run off when the heat sink is installed into opening 1172b3. FIG. 59B shows a side view of this device, FIG. 59C shows a top view of this device, while FIG. 59D shows a back view of this device. These fins 1185 are trapezoidal in shape and extend out from base plate 1181 in a substantially parallel manner, in a substantially perpendicular orientation to base plate 1181. In addition, base plate 1181 includes a channel 1187 for receiving a heat pipe such as heat pipe 1160.

As described above, a heat sink stand 1149 (See FIG. 56A) is coupled to gear tray 1150, and also a circuit board 1142, wherein this circuit board 1142 is coupled to electrical wiring to receive power from this electrical wiring. The heat generated by powering these LED lights such as lights 1146 is then passed from circuit board 1142 to heat sink stand 1149. This heat from heat sink stand 1149 is then passed to heat pipe 1160. Heat pipe 1160, includes a wick or similar heat dispersion mechanism and assisting the liquid material to travel within the walls of the heat pipe 1160, wherein this wick is a passage way for the condensed gas (or liquid), to return it from the cold side of the heat pipe 1160 to the hot end of the pipe. At the end distal from heat sink stand 1149, heat pipe 1160 transfers heat into another heat sink body such as housing 1170, or housing 1107, or any other type of heat sinking device. The heat sinking device then transfers the heat into the atmosphere.

For example, as shown in FIG. 56A a first position of heat pipe 1160 at position 1161 is at a position lower than a second distal position 1162. Therefore, when the gas turns back to liquid at position 1162, it is drawn back to position 1161 to thereby further cool stand 1149.

This design ultimately allows for rapid heat dissipation from an associated LED light thereby allowing the LED light to avoid any thermal overload. The use of reflectors also results in an omnidirectional or 360 degree dissipation of light in a substantially even manner thereby creating an efficient and substantially even illumination effect.

The use of the terms “a” and “an” and “the” and similar references in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The recitation of ranges of values herein are merely intended to serve as a shorthand method of referring individually to each separate value falling within the range, unless otherwise indicated herein, and each separate value is incorporated into the specification as if it were individually recited herein.

Any methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed. No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

Accordingly, while at least one embodiment of the present invention have been shown and described, it is to be understood that many changes and modifications may be made thereunto without departing from the spirit and scope of the invention as defined in the appended claims.

What is claimed is:

1. A light comprising:
a) a housing;
b) at least one LED light coupled inside said housing;
c) a heat sink disposed in said housing, wherein said at least one LED light is coupled to said heat sink;
d) a reflector including a first intermediate reflector and a. second rounded reflector wherein said reflector is coupled to said housing wherein said reflector is for reflecting light from said at least one LED light out of said housing.

2. The device as in claim 1, wherein said housing is substantially tubular and includes at least one translucent section which allows light to flow therefrom.

3. The device as in claim 2, wherein said reflector has a surface that is substantially light reflecting and wherein light from said LED array is reflected off of said surface.

4. The device as in claim 3, wherein said LED array is coupled to a first end of said housing and a second LED array is coupled to a second end of said housing.

5. The device as in claim 2, wherein said housing has a first section that is substantially reflecting and a second section that is substantially translucent.

6. The device as in claim 2, further comprising a film made from prismatic lenses for reflecting and amplifying light emitted from said LED lights.

7. The device as in claim 1, wherein said housing is substantially bowl shaped.

8. The device as in claim 1, wherein said heat sink is in the form of a flange extending radially out from said light housing.

9. The device as in claim 8, wherein said light housing is adapted to receive a plurality of LED arrays each coupled into said housing with each of said LED arrays being set so that said LED lights shine at different angles.

10. The device as in claim 1, wherein said reflector is shaped as an elongated rounded element.

11. The device as in claim 2, wherein said LED lights in said LED array are aligned to direct light along a longitudinal axis of said housing.

12. The device as in claim 2, wherein at least one of said LED lights in said LED array are formed at an angle in relation to a longitudinal axis of said housing.

13. A light comprising:
a) a housing;
b) a plurality of LED lights; and
c) at least one collimating lens for collimating light sent from said LED light array;
d) at least one endcap housing coupled to said housing, said endcap housing in the form of a heatsink wherein said plurality of LED lights and said at least one collimating lens are coupled into said endcap housing;
e) at least one reflector comprising a first reflector and a second reflector, said first reflector and said second reflector having a different slope, and being disposed in said housing and configured to reflect light sent from said at least one collimating lens out of said housing.

14. The device as in claim 13, wherein said at least one heatsink is in the form of a flange extending radially out from said at least one endcap housing.

15. The device as in claim 13, wherein said endcap housing is adapted to receive a plurality of LED arrays with LED lights from at least a first set of LED arrays being set at an angle that is different than an angle of a set of lights in a second LED array.

16. A light comprising:
a) a housing, wherein said housing is substantially tubular and includes at least one translucent section which allows light to flow therefrom;
b) a plurality of LED lights coupled in an array inside said housing;
c) a heat sink comprising a stand;
d) a reflector, having a first section and a second section, wherein said first section has a lower slope relative to said second section and wherein said reflector is coupled to said housing wherein said reflector is for reflecting light from said plurality of LED lights out of said housing.

17. A light comprising:
a) an elongated housing;
b) a plurality of LED lights disposed in said housing;
c) a reflector disposed in said housing;
d) at least one heat sink comprising at least one heat sink stand and at least one heat pipe, wherein said at least one heat pipe is covered by said reflector,

18. A light system comprising:
a) an elongated housing;
b) at least one LED light disposed inside of said housing;
c) at least one lens disposed adjacent to said LED light;
d) at least one reflector disposed in said housing, said at least one reflector having a first reflector section disposed adjacent to said LED light and a second reflector section coupled to said first section, and disposed at a distal end opposite said LED light said first reflector section being substantially round in shape, and said second reflector section being substantially round in shape.

19. The light system as in claim 18, wherein said second reflector section is substantially spherical in shape.

20. The light system as in claim 19, further comprising at least one heat sink, said heat sink being disposed inside of said at least one housing, and wherein at least a portion of said heat sink is disposed between said at least one reflector and said housing.

21. The light system as in claim 20, wherein said housing includes a base section configured to be mounted on a structure, and a translucent section, wherein at least a portion of said heat sink is disposed between said first reflector section and said base section.

22. The light system as in claim 21, further comprising at least one heat pipe, wherein said heat pipe is coupled to said at least one heat sink.

23. The light system as in claim 18 wherein said first reflective section has a shape taken from the group consisting of, substantially conical, sectional conical, frusto-conical, or rounded, or a shape that has at least has a portion that is substantially conical, sectional conical, frusto-conical, or rounded.

24. The light system as in claim 18 wherein said second reflective section has a shape taken from the group consisting of: rounded, spherical, semi-spherical, dome shaped, or a shape having at least one portion that is substantially or entirely rounded, dome shaped or spherical shaped.
